(19) United States
(12) Patent Application Publication
(10) Pub. No.: US 2025/0377524 A1
(43) Pub. Date: Dec. 11, 2025

(54) NOVEL ILLUMINATION AND BACKGROUND REJECTION FOR ENHANCED RESOLUTION IMAGING

(71) Applicant: Ultima Genomics, Inc., Fremont, CA (US)

(72) Inventors: Osip SCHWARTZ, Lafayette, CA (US); Rongwen LU, Fremont, CA (US); Gene POLOVY, Redwood City, CA (US); Michael FRIEDMANN, Mountain View, CA (US); Atcha TOTACHAWATTANA, San Jose, CA (US)

(73) Assignee: Ultima Genomics, Inc., Fremont, CA (US)

(21) Appl. No.: 19/232,376

(22) Filed: Jun. 9, 2025

Related U.S. Application Data
(60) Provisional application No. 63/657,698, filed on Jun. 7, 2024.
(60) Provisional application No. 63/659,287, filed on Jun. 12, 2024.

(51) Int. Cl. G02B 21/00; B01L 3/00

(52) U.S. Cl. CPC G02B 21/0032; B01L 3/502715; G02B 21/0072; B01L 2200/0647; B01L 2300/0654; B01L 2300/168

(57) ABSTRACT

Optical systems, apparatus, and methods disclosed herein employ illumination and/or background rejection configured for enhanced resolution imaging. In some embodiments an optical path of illumination light to emitters on a surface does not pass through an objective lens positioned and configured to receive emission from the emitters in response to the illumination. In addition, or alternatively (e.g., in a case of illumination of the emitters through the objective), in some embodiments the emission from the emitters is collected by the objective lens and directed to one or more sensors through one or more pinholes.

### CROSS REFERENCE TO RELATED APPLICATIONS

This application claims benefit of priority to U.S. Provisional Patent Application 63/657,698 filed Jun. 7, 2024 and to U.S. Provisional Patent Application 63/659,287 filed Jun. 12, 2024, each of which is incorporated herein by reference in its entirety.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. To the extent publications and patents or patent applications incorporated by reference contradict the disclosure contained in the specification, the specification is intended to supersede and/or take precedence over any such contradictory material. In the event of a conflict between a term herein and a term in an incorporated reference, the term herein controls.

### FIELD OF THE INVENTION

The present disclosure relates generally to methods and systems for enhanced resolution imaging and to methods and systems for providing illumination light in enhanced resolution imaging, such as methods and systems for provision of light in enhanced resolution imaging and/or performing background rejection in enhanced resolution imaging for bioassay applications, e.g., nucleic acid detection and sequencing applications.

### BACKGROUND

Biological sample processing has various applications in the fields of molecular biology and medicine (e.g., diagnosis). For example, nucleic acid (e.g., genome) sequencing may provide information that may be used to diagnose a certain condition in a subject and in some cases to determine a subject-specific treatment plan. Sequencing is widely used for molecular biology applications, including nucleic acid vector designs, gene therapy, vaccine design, industrial strain design, and diagnostic verification. Biological sample processing may involve a fluidics system and/or a detection system.

High performance detection and imaging systems used for optical inspection are designed to maximize imaging throughput, signal-to-noise ratio (SNR), image resolution, and image contrast, key figures of merit for many imaging applications. In genome sequencing, for example, high resolution imaging enables the use of higher packing densities of nucleic acids (e.g., clonally amplified nucleic acid molecules) on a surface, which in turn may enable higher throughput sequencing in terms of the number of bases called per sequencing reaction cycle.

In general, attempting to increase imaging throughput while simultaneously trying to improve the ability to resolve small image features at higher magnification reduces the number of photons available for imaging (e.g., by decreasing the practicable field of view). In fluorescence imaging-based sequencing, for example, where fluorophores are used to label nucleic acid molecules tethered to a surface, high resolution imaging may in effect reduce the total number of fluorophores present in the region of the surface being imaged and thus result in the generation of fewer photons. Although this problem may be addressed, for example, by integrating detection over longer periods of time to acquire an acceptable image (e.g., to acquire an image that has a sufficient signal-to-noise ratio to resolve the features of interest), this approach may have an adverse effect on image data acquisition rates and imaging throughput.

### SUMMARY

There is thus recognized a need for imaging methods that can combine high throughput processing (e.g., high density arrays of samples, high-speed imaging, etc.) and high resolution, especially for use in sequencing methods.

Optical systems, apparatus, and methods disclosed herein employ novel illumination and/or background rejection for enhanced resolution imaging. As summarized and further described below, in some embodiments an optical path of illumination light to emitters on a surface does not pass through an objective lens positioned and configured to receive emission from the emitters in response to the illumination. In addition, or alternatively (e.g., in the case of illumination of the emitters through the objective), in some embodiments the emission from the emitters is collected by the objective lens and directed to one or more sensors through one or more pinholes.

Provided herein are systems and methods that provide illumination light in enhanced imaging applications. Beneficially, these illumination systems and methods result in improved resolution, improved image contrast, and improved signal-to-noise ratio over conventional methods. The systems and methods provided herein, in some embodiments, are standalone systems or are incorporated into pre-existing imaging systems. In some embodiments, the imaging systems are useful for imaging, for example, biological analytes, non-biological analytes, synthetic analytes, cells, tissue samples, or any combination thereof.

In some embodiments, an optical system includes an illumination module, an optical component, an objective lens, and one or more sensors. The illumination module is configured to provide illumination light. The optical component is configured to direct the illumination light toward a portion of a first surface of a substrate. The objective lens is (i) positioned adjacent to the first surface of the substrate, (ii) configured to receive emission light output from the portion of the first surface of the substrate, and (iii) configured to direct the emission light toward the one or more sensors. The one or more sensors are configured for time delay integration imaging. The optical path of the illumination light does not pass through the objective lens. At least a surface of the optical component that is adjacent to the substrate is immersed in a fluid having an index of refraction that is substantially similar to the index of refraction of the substrate.

In some embodiments, a method is performed at an optical system that includes an illumination module, an objective lens, an optical component, and a sensor configured for time delay integration imaging. The method includes translating a substrate relative to the sensor. The substrate includes a surface. The method further includes, while translating the substrate relative to the sensor: (i) outputting illumination light from the illumination module and (ii) directing, by the optical component, the illumination light toward a portion of the first surface of the substrate so that the optical path of the illumination light does not pass through the objective lens. The method further includes, while translating the substrate relative to the sensor: (iii) outputting emission light from the portion of the first surface of the substrate in response to receiving the illumination light at the portion of the first surface of the substrate and (iv) receiving the emission light at the objective lens. The objective lens is positioned adjacent to the first surface of the substrate. The method further includes, while translating the substrate relative to the sensor: (v) directing the emission light toward the sensor by the objective lens, (vi) receiving the emission light at the sensor, and (vii) generating a scanned image of the portion of the first surface of the substrate based on the emission light received at the sensor.

In some embodiments, an optical system includes an illumination module, a first objective lens, a second objective lens, and one or more sensors. The illumination module is configured to provide illumination light. The first objective lens is configured to direct the illumination light toward a portion of a first surface of a substrate. The substrate also includes a second surface that is substantially parallel to the first surface of the substrate. The second objective lens is configured to receive emission light output from the portion of the first surface of the substrate. The one or more sensors are configured for time delay integration imaging. The first objective lens is positioned adjacent to the second surface of the substrate. At least a portion of the first objective lens and at least a portion of the second surface of the substrate are immersed in a fluid having an index of refraction that is greater than the index of refraction of the substrate The second objective lens is (i) positioned adjacent to the first surface of the substrate and (ii) configured to direct the emission light toward the one or more sensors.

In some embodiments, a method is performed at an optical system that includes an illumination module, a first objective lens, a second objective lens, and a sensor configured for time delay integration imaging. The method includes translating a substrate relative to the sensor. The substrate includes a first surface and a second surface that is substantially parallel to the first surface. The method further includes, while translating the substrate relative to the sensor: (i) outputting illumination light from the illumination module and (ii) directing, by the first objective lens, the illumination light toward a portion of the first surface of the substrate. The first objective lens is positioned adjacent to the second surface of the substrate. The method further includes, while translating the substrate relative to the sensor, (iii) transmitting the illumination light through the second surface of the substrate and toward a portion of the first surface of the substrate. The method further includes, while translating the substrate relative to the sensor: (iv) outputting emission light from the portion of the first surface of the substrate in response to receiving the illumination light at the portion of the first surface of the substrate and (v) receiving the emission light at the second objective lens. The second objective lens is positioned adjacent to the first surface of the substrate. The method further includes, while translating the substrate relative to the sensor: (vi) receiving the emission light at the sensor, and (vii) generating a scanned image of the portion of the first surface of the substrate based on the emission light received at the sensor.

In some embodiments, a substrate includes a surface. The substrate also includes one or more emitters disposed on the surface, and a grating. The grating is configured to receive light and transmit the light toward a portion of the surface. The one or more emitters are configured to output emission light in response to being illuminated by the light received at the portion of the surface.

In some embodiments, an optical system includes an illumination module, a substrate, an objective lens, and one or more sensors. The illumination module is configured to provide illumination light. The substrate has a surface and a grating. The grating is configured to receive the illumination light from the illumination module and transmit at least a portion of the illumination light through the grating and toward a portion of the surface of the substrate. The objective lens is configured to (i) receive emission light output from the portion of the surface of the substrate that is illuminated by the illumination light and (ii) direct the emission light toward the one or more sensors. The one or more sensors are configured for time delay integration imaging.

In some embodiments, a method is performed at an optical system that includes an illumination module, an objective lens, and a sensor configured for time delay integration imaging. The method includes translating a substrate relative to the sensor. The substrate includes a surface and a grating. The method further includes, while translating the substrate relative to the sensor: (i) outputting illumination light from the illumination module and (ii) receiving the illumination light at the grating. The method further includes, while translating the substrate relative to the sensor, (iii) transmitting, by the grating, the illumination light toward a portion of the surface of the substrate. The method further includes, while translating the substrate relative to the sensor: (iv) outputting emission light from the portion of the surface of the substrate in response to receiving the illumination light at the portion of the first surface of the substrate and (v) directing, by the objective lens, the emission light toward the sensor. The method further includes, while translating the substrate relative to the sensor: (vi) receiving the emission light at the sensor, and (vii) generating a scanned image of the portion of the first surface of the substrate based on the emission light received at the sensor.

In some embodiments, a substrate includes a substantially planar surface, one or more emitters disposed on the surface of the substrate, a waveguide layer that includes one or more waveguides, and a cladding layer positioned between the waveguide layer and the surface. The one or more waveguides are configured to (i) receive light, (ii) transmit light to at least a portion of the surface, and (iii) illuminate at least one of the one or more emitters.

In some embodiments, an optical system includes an illumination module, a substrate, an objective lens, and one or more sensors. The illumination module is configured to provide illumination light. The substrate has a substantially planar surface and a waveguide layer that includes one or more waveguides. The one or more waveguides are configured to receive the illumination light and to transmit the illumination light to at least a portion of the surface of the substrate. The objective lens is (i) positioned adjacent to the surface of the substrate, (ii) configured to receive emission light output from the portion of the surface of the substrate that is illuminated by the illumination light and (iii) transmit the emission light toward the one or more sensors. The one or more sensors are configured for time delay integration imaging.

In some embodiments, a method is performed at an optical system that includes an illumination module, an objective lens, and a sensor configured for time delay integration imaging. The method includes translating a substrate relative to the sensor. The substrate includes a substantially planar surface and a layer that includes one or more waveguides. The method further includes, while translating the substrate relative to the sensor: (i) outputting illumination light from the illumination module and (ii) receiving the illumination light at the one or more waveguides in the substrate. The method further includes, while translating the substrate relative to the sensor, (iii) transmitting, by the one or more waveguides in the substrate, the illumination light toward a portion of the surface of the substrate. The method further includes, while translating the substrate relative to the sensor: (iv) outputting emission light from the portion of the surface of the substrate in response to receiving the illumination light at the portion of the first surface of the substrate and (v) directing, by the objective lens, the emission light toward the sensor. The method further includes, while translating the substrate relative to the sensor: (vi) receiving the emission light at the sensor, and (vii) generating a scanned image of the portion of the first surface of the substrate based on the emission light received at the sensor.

In some embodiments, a system comprises one or more computer processors and computer memory coupled thereto. The computer memory comprises machine executable code that, upon execution by the one or more computer processors, implements any of the methods above or elsewhere herein. In some embodiments, a non-transitory computer readable medium comprises machine executable code that, upon execution by one or more computer processors, implements any of the methods above or elsewhere herein.

Also provided herein are systems and methods that improve background rejection in enhanced imaging applications. Some implementations comprise optical sectioning. Such systems and methods may optionally be used in combination with the illumination systems and methods summarized above.

Beneficially, these systems and methods for background rejection result in improved resolution, improved image contrast, and improved signal-to-noise ratio over conventional methods. The systems and methods provided herein, in some embodiments, may be standalone systems or may be incorporated into pre-existing imaging systems and/or sequencing systems. In some embodiments the imaging systems may be useful for imaging, for example, biological analytes, non-biological analytes, synthetic analytes, cells, tissue samples, or any combination thereof.

In an aspect, provided is an optical imaging system that includes a transformation device, a pinhole array, and a sensor. The transformation device is configured to receive emitted light that is output from a plurality of emitters. The sensor is configured to receive a portion of the emitted light for generation of a scanned image of the plurality of emitters. The transformation device is configured to transmit the portion of the emitted light toward the pinhole array. The pinhole array is configured to receive the portion of the emitted light from the transformation device and transmit the portion of the emitted light toward the sensor.

In an aspect, provided is a method of generating a scanned image of a plurality of emitters. The plurality of emitters is positioned on a substrate (e.g., the substrate includes the plurality of emitters). The method is performed at an optical imaging system that includes a transformation device, a pinhole array, and a sensor. The method includes translating the substrate relative to the sensor. The method also includes, while translating the substrate relative to the sensor: i) receiving emitted light output from the plurality of emitters at the transformation device, ii) a portion of the emitted light through the transformation device and towards the pinhole array, iii) receiving the portion of the emitted light at the pinhole array, iv) transmitting the portion of the emitted light through the pinhole array and towards the sensor, v) receiving the portion of the emitted light at the sensor, and vi) generating a scanned image of the plurality of emitters based on the portion of the emitted light received at the sensor.

In an aspect, provided is an imaging system that includes a substantially planar substrate, a projection unit, and objective lens, and one or more sensors. The projection unit is configured to direct illumination light onto a region of the substrate in an illumination pattern. The objective lens is configured to direct emission light from the substrate to one or more sensors via an optical transformation device and a pinhole array. At least some of the illumination light is not directed through an objective lens. The one or more sensors are configured for time delay and integration imaging. The imaging system also includes one or more processors that are individually or collectively configured to generate a scanned image of the region of the substrate.

In an aspect, provided is a method of generating a scanned image of a region of a substrate. The method includes providing a substantially planar substrate and illuminating the region of the substrate with one or more illumination beams. The one or more illumination beams are not directed through an objective lens. The method also includes directing emission light from the region of the substrate to a detector through the objective lens, thereby generating the scanned image of the region of the substrate. The emission light is directed through an optical transformation device and a pinhole array prior to being received by the detector.

Thus, the disclosed embodiments provide imaging systems and methods that can provide enhanced resolution images with a reduced background, thereby improving signal-to-noise ratio and/or imaging contrast.

Additional aspects and advantages of the present disclosure will become readily apparent to those skilled in this art from the following detailed description, where only illustrative instances of the present disclosure are shown and described. As will be realized, the present disclosure is capable of other and different instances, and the details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 provides a flowchart illustrating an example method of imaging an object, in accordance with some implementations described herein.

FIGS. 2A and 2B illustrate an example illumination system, in a front view and a top schematic representation. As depicted, at least a portion of the input illumination bypasses the objective system.

FIG. 2C illustrates an example of oblique illumination at a substrate.

FIGS. 3A and 3B illustrate an example system for back illumination, in a front view and a top schematic representation. As depicted, at least a portion of the input illumination bypasses the objective system.

FIGS. 4A and 4B illustrate an example system for back illumination, in a front view and a top schematic representation. As depicted, at least a portion of the input illumination bypasses the objective system.

FIG. 4C illustrates an example of back illumination at a substrate.

FIGS. 5A and 5B illustrate examples of illumination bypassing an objective lens.

FIGS. 5C and 5D illustrate examples of illumination using a toroidal optical component.

FIGS. 5E, 5F, and 5G illustrate examples of optical imaging systems with a bottom illumination scheme.

FIG. 6 illustrates an exemplary optical imaging system for imaging a sample that comprises index-matched beads.

FIG. 7 illustrates an exemplary optical imaging system with a bottom illumination scheme that is provided through an objective lens.

FIG. 8 illustrates an exemplary optical imaging system with a bottom illumination scheme for illuminating a sample using a grating.

FIG. 9A illustrates an exemplary optical imaging system for illuminating a sample using one or more waveguides.

FIGS. 9B, 9C, 9D, and 9E and 10A, 10B, 10C, and 10D illustrate details regarding the sample and the one or more waveguides described in FIG. 9A.

FIGS. 10E and 10F illustrate examples of recycling light back into the one or more waveguides of a substrate described in FIGS. 9A, 9B, 9C, 9D, and 9E and 10A, 10B, 10C, and 10D.

FIGS. 11A and 11B illustrate a method of providing illumination in an optical imaging system.

FIG. 12 illustrates a method of providing back illumination in an optical imaging system.

FIG. 13 illustrates a method of providing illumination in an optical imaging system using a substrate that includes a grating.

FIG. 14 illustrates a method of providing illumination in an optical imaging system using a substrate that includes one or more waveguides.

FIG. 15A illustrates a detection path for an optical imaging system with improved background rejection.

FIGS. 15B and 15C illustrate examples of a detection module used in the optical imaging system shown in FIG. 15A.

FIG. 15D illustrates a detection path for an optical imaging system with improved background rejection.

FIGS. 16A-16B illustrate a method for improved background rejection in an optical imaging system.

FIGS. 17A-17B illustrate a method for improved background rejection in an optical imaging system.

FIGS. 18A and 18B illustrate multiplexed stations in a sequencing system.

FIG. 19 provides a non-limiting schematic illustration of a computing device in accordance with one or more examples of the disclosure.

FIG. 20 provides an example of the resolution improvement provided by optical transform TDI imaging systems, in accordance with some implementations described herein.

FIGS. 21A and 21B provide non-limiting examples of resolution improvements (e.g., as indicated by FWHM) from CoSI and external CoSI (xCoSI). FIG. 21A illustrates a comparison between widefield, CoSI, and xCoSI resolution in a case where excitation and emission wavelengths and a photon reassignment coefficient are held constant. FIG. 21B illustrates the impact of photon reassignment coefficient on resolution (e.g., FWHM) in an xCoSI system.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Definitions: Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range irrespective of whether a specific numerical value or specific sub-range is expressly stated. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Where the stated range includes upper or lower limits, ranges excluding either of those included limits are also included in the present disclosure.

Ranges may be expressed herein as from “about” one particular value, and/or to “about” another particular value. The terms “about” and “approximately” shall generally mean an acceptable degree of error or variation for a given value or range of values, such as, for example, a degree of error or variation that is within 20 percent (%), within 15%, within 10%, or within 5% of a given value or range of values.

As used in the specification and claims, the singular forms “a”, “an” and “the” include plural references unless the context clearly dictates otherwise. For example, the term “a sample” includes a plurality of samples, including mixtures thereof.

The term “analyte,” as used herein, generally refers to an object that is directly or indirectly analyzed during a process (e.g., a chemical process, an imaging process, etc.). An analyte may originate (and/or be derived) from a sample (e.g., a biological sample). For example, an analyte may be or comprise a molecule, a macromolecule (e.g., nucleic acid, carbohydrate, protein, lipid), a cell, a tissue or tissue sample, or any combination thereof. In addition, an analyte may be or comprise a synthetic version or variant of any of the above. Processing an analyte may comprise conducting a chemical reaction, biochemical reaction, enzymatic reaction, hybridization reaction, polymerization reaction, etc. (or a combination thereof) in the presence of or on the analyte. Processing an analyte may comprise physical and/or chemical manipulation of the analyte and detection thereof. An analyte may be indirectly or directly coupled to a substrate.

In a specific example, an analyte may comprise a nucleic acid, where the nucleic acid is derived or obtained from a biological sample (e.g., a cell, a tissue sample, etc.) and where the nucleic acid is immobilized to a substrate. Processing such an analyte may comprise performing a sequencing reaction of the analyte and detecting the results of such a reaction (e.g., detecting the incorporation or lack thereof of one or more nucleic acids into a growing primer molecule that is hybridized to a template analyte). Such detection may comprise determining the presence of, amount of, change in, or absence of fluorescence (e.g., a fluorescent label, a Forster resonance energy transfer (FRET) interaction, etc.) or charge (e.g., a chemical charge).

As used herein, a “detector” refers to device capable of detecting or measuring a signal (e.g., a signal derived from analyte processing). A detector may be an electronic device that is configured to detect electromagnetic radiation (e.g., radiation incident upon one or more components of the detector). A detector may comprise a single sensor or a plurality of sensors. A detector may detect one or more signals. Detection may comprise continuous area scanning. A continuous area scanning detector may comprise a time delay and integration (TDI) charge-coupled device (CCD), Hybrid TDI, or complementary metal oxide semiconductor (CMOS), or pseudo TDI device.

The term “continuous area scanning,” as used herein, generally refers to area scanning in linear or non-linear paths such as rings, spirals, or arcs on a moving (e.g., rotating and/or translation) substrate using an optical imaging system and a detector. Continuous area scanning may comprise the use of an imaging array sensor capable of continuous integration over a scanning area in which the scanning is synchronized (e.g., electronically synchronized) to the image of an object in relative motion. For example, relative motion between the detector units and the substrate may refer to motion by the detector units, motion of the substrate, or both.

Continuous area scanning detectors may scan at the same rate for all image positions and therefore may not be able to operate at the correct scan rate for all imaged points in a curved (or arcuate or non-linear) scan. Therefore, the scan may be corrupted by velocity blur for imaged field points on an object moving at a velocity different than the scan velocity. Continuous rotational area scanning may comprise an optical detection system or method that makes algorithmic, optical, and/or electronic corrections to substantially compensate for this tangential velocity blur, thereby reducing this scanning aberration. In some cases, different sensors of the detector may be separately configured to compensate for differential velocity blur of separate segments of the substrate being scanned. For example, the compensation is accomplished algorithmically by using an image processing algorithm that deconvolves differential velocity blur at various image positions corresponding to different radii on a rotating substrate to compensate for differential velocity blur. In some cases, the camera or scanner may apply or use a blur to compensate for differential velocity blur.

As used herein, the term “scanning” refers to detection of signals (i.e., capturing images) during relative motion of the detector and the object. As used herein, the term “imaging” refers to processing (e.g., analyzing) or using images collected from scanning.

The term “open substrate”, as used herein, generally refers to a substantially planar substrate in which a single active surface is physically accessible at any point from a direction normal to the substrate. Substantially planar may refer to planarity at a micrometer level or nanometer level. Alternatively, substantially planar may refer to planarity at less than a nanometer level or greater than a micrometer level (e.g., millimeter level). An open substrate may have a patterned or unpatterned surface. One or more analytes may be coupled to an open substrate (e.g., preparatory for processing the one or more analytes). Different processing operations on substrates (e.g., open substrates), scanning mechanisms, and optical detection systems are described in e.g., U.S. Pat. Nos. 10,273,528B1, 11,512,350B2, and 11,155,868B2, each of which is incorporated herein by reference in its entirety.

The term “field-of-view” (FOV), as used herein, generally refers to the area on the sample or substrate that is optically mapped (or is mappable) to an active area of the detector (e.g., one or more active sensors of the detector). A FOV may be segmented into two or more regions, each of which can be electronically controlled to scan at a different rate. These scanning rates may be adjusted to the mean projected object velocity within each region. The regions may be optically defined using one or more beam splitters or one or more mirrors. The two or more regions may be directed to two or more detectors. The regions may be defined as segments of a single detector or as distinct sensors of a single detector.

As used herein, the term “focal plane” refers to any plane perpendicular to an optical axis of an optical device described herein, specifically to such a perpendicular plane comprising a focal point (e.g., a plane upon where illumination and/or emission light is focused). As used herein, the terms “object plane” or “sample plane” refer to a focal plane in or on the object being imaged. As used herein, the term “image plane” refers to a focal plane incident upon a detector. Generally, an image plane is a magnification of the sample plane. As used herein, the term “pupil plane” generally refers to a focal plane located inside the objective of an optical device described herein. In particular, a pupil plane represents a fast Fourier transform (FFT) of the sample plane or image plane.

As used herein, the term “optical transformation device” refers to an optical device used to apply an optical transformation to a beam of light (e.g., to affect a change in intensity, phase, wavelength, band-pass, polarization, ellipticity, spatial distribution, etc., or any combination thereof). An optical transformation may be or include for example a lens, microlens, array of microlenses, diffraction grating, phase mask, amplitude mask, digital micromirror device, spatial light monitor, pinhole, array of pinholes, or any combination thereof.

### Open Substrate Processing Systems

Described herein are devices, systems, and methods that use open substrates or open flow cell geometries to process a sample. The term “open substrate,” as used herein, generally refers to a substrate in which any point on an active surface of the substrate is physically accessible from a direction normal to the substrate. A sample processing system may comprise a substrate, and devices and systems that perform one or more operations with or on the substrate. The sample processing system may permit highly efficient dispensing of analytes and reagents onto the substrate. The sample processing system may permit highly efficient imaging of one or more analytes, or signals corresponding thereto, on the substrate. Substrates, detectors, and sample processing hardware that can be used in the sample processing system are described in further detail in U.S. patent Ser. Nos. 11/499,962 11/118,223, and 12/239,980 and U.S. Pat. Pub. No. 2023/0279487A1, each of which is entirely incorporated herein by reference.

### Substrates

An open substrate may be a solid substrate. The substrate may entirely or partially comprise one or more materials (e.g., rubber, glass, silicon, metal, ceramic, plastic, etc.). The substrate may be entirely or partially coated with one or more layers of a metal, an oxide, a photoresist, a surface coating such as an aminosilane or hydrogel, polyacrylic acid, polyacrylamide dextran, polyethylene glycol (PEG), or any combination of any of the preceding materials, or any other appropriate coating. The substrate may comprise multiple layers of the same or different type of material. The substrate may be fully or partially opaque to visible light. A surface of the substrate may be modified to comprise active chemical groups, such as amines, esters, hydroxyls, epoxides, and the like, or a combination thereof, or these may be added as an additional layer or coating to the substrate. The substrate may have the general form of a cylinder, a cylindrical shell or disk, a rectangular prism, or any other geometric form.

The substrate may comprise a planar or substantially planar surface. The surface may be textured or patterned, where the texture or pattern may be regular or irregular. For example, the substrate may comprise grooves, troughs, hills, pillars, wells, cavities (e.g., micro-scale cavities or nano-scale cavities), and/or channels. The substrate may have regular or irregular geometric structures (e.g., wedges, cuboids, cylinders, spheroids, hemispheres, etc.) above or below a reference level of the surface. In some instances, the textures and/or patterns of the substrate may define at least part of an individually addressable location on the substrate.

The substrate may comprise a plurality of individually addressable locations. The locations on one or more surfaces of the substrate are physically accessible for processing (e.g., placement, extraction, reagent dispensing, seeding, heating, cooling, or agitation). The locations may be digitally accessible (e.g., locations may be located, identified, and/or accessed electronically or digitally for indexing, mapping, sensing, associating with a device (e.g., detector, processor, dispenser, etc.)). In some cases, the locations may be defined by physical features of the substrate (e.g., on a modified surface) to distinguish from each other and from non-individually addressable locations. In some cases, the locations may be defined digitally (e.g., by indexing) and/or via the analytes and/or reagents that are loaded on the substrate (e.g., the locations at which analytes are immobilized on the substrate). Each of the plurality of individually addressable locations, or each of a subset of the locations, may be capable of immobilizing thereto an analyte (e.g., a nucleic acid, a protein, a carbohydrate, etc. from a biological sample) or a reagent (e.g., a nucleic acid, a probe molecule, a barcode molecule, an antibody molecule, a primer molecule, a bead, etc.) directly or indirectly (e.g., via a support, such as a bead).

The substrate may have any number of individually addressable locations, for example, on the order of 1, 101, 102, 103, 104, 105, 106, 107, 108, 109, 1010, 1011, 1012, 1013 or more locations. A location may have any size. In some cases, a location may have an area of at least and/or at most about 0.05, 0.1, 0.2, 0.25, 0.3, 0.4, 0.5, 0.6, 0.7, 0.8, 0.9, 1, 1.1, 1.2, 1.25, 1.3, 1.4, 1.5, 1.6, 1.7, 1.75, 1.8, 1.9, 2, 2.25, 2.5, 2.75, 3, 3.25, 3.5, 3.75, 4, 4.25, 4.5, 4.75, 5, 5.5, 6, 7, 8, 9, 10 square microns (μm²), or more. A substrate may comprise more than one type of individually addressable location arranged as an array, randomly, or according to any pattern, on the substrate. In some cases, different types of individually addressable locations may have different chemical, physical, and/or biological properties (e.g., hydrophobicity, charge, color, topography, size, dimensions, geometry, etc.). For example, a first location type may comprise a first surface chemistry, and a second location type may lack the first surface chemistry.

Individually addressable locations may be distributed on the substrate with a pitch determined by the distance between the center of a first location and the center of the closest or neighboring individually addressable location(s). Locations may be spaced with a pitch of at least and/or at most about 0.05, 0.1, 0.2, 0.25, 0.3, 0.4, 0.5, 0.6, 0.7, 0.8, 0.9, 1, 1.1, 1.2, 1.25, 1.3, 1.4, 1.5, 1.6, 1.7, 1.75, 1.8, 1.9, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, or 10 microns (μm). In some cases, the pitch between two locations may be determined as a function of a size of a loading object (e.g., bead). For example, where a bead has a maximum diameter, the pitch may be at least about that maximum diameter.

In some cases, the individually addressable locations may be segregated or indexed, e.g., spatially. Data (e.g., optical signals) corresponding to an indexed location, collected over multiple periods of time, may be linked to the same indexed location. In some cases, sequencing signal data collected from an indexed location, during iterations of sequencing-by-synthesis flows, are linked to the indexed location to generate a sequencing read for an analyte immobilized at the indexed location. In some cases, the individually addressable locations are indexed by physically demarcating part of the surface, depositing a topographical mark, depositing a sample (e.g., a control nucleic acid sample), depositing a reference object (e.g., reference bead that always emits a detectable signal during detection), and the locations may be indexed with reference to such demarcations.

The substrate may be rotatable about an axis, referred to herein as a rotational axis. The rotational axis may or may not be an axis through the center of the substrate. The systems, devices, and apparatus described herein may further comprise an automated or manual rotational unit configured to rotate the substrate. The rotational unit may comprise a motor and/or a rotor. For instance, the substrate may be affixed to a chuck (such as a vacuum chuck). The substrate may be rotated at a rotational speed of at least about 1 revolution per minute (rpm), at least 2 rpm, at least 5 rpm, at least 10 rpm, at least 20 rpm, at least 50 rpm, at least 100 rpm, at least 200 rpm, at least 500 rpm, at least 1,000 rpm, at least 2,000 rpm, at least 5,000 rpm, at least 10,000 rpm, or greater. The substrate may be configured to rotate with different rotational velocities during different operations described herein, for example with higher velocities during reagent dispense and with lower velocities during analyte loading and imaging operations. The substrate may be configured to rotate with a rotational velocity that varies according to a time-dependent function, such as a ramp, sinusoid, pulse, or other function, or combination thereof.

In some cases, the substrate may be movable in any vector or direction. For example, such motion may be non-linear (e.g., in rotation about an axis), linear (e.g., on a rail track), or a hybrid of linear and non-linear motion. In some instances, the systems, devices, and apparatus described herein may further comprise a motion unit configured to move the substrate. The motion unit may comprise any mechanical component, such as a motor, rotor, actuator, linear stage, drum, roller, pulleys, etc., to move the substrate. Analytes or reagents may be immobilized to the substrate during any such motion. Analytes or reagents may be dispensed onto the substrate prior to, during, or subsequent to motion of the substrate.

### Open Substrate Detection Systems

An optical system comprising a detector may be configured to detect one or more signals from a detection area on the substrate prior to, during, or subsequent to the dispensing of reagents to generate an output. Signals from multiple individually addressable locations may be detected during a single detection event. Signals from the same individually addressable location may be detected in multiple instances.

### Systems and Methods for Sequencing

The optical systems and methods described herein may be used as part of the process of sequencing nucleic acid molecules (e.g., via sequencing by synthesis) on an open substrate. It will be appreciated that these optical systems and methods may be used as part of other types of sequencing systems, and further there will be other applications beyond sequencing that may make use of these optical systems and methods (e.g., high-resolution and/or high-speed imaging).

An example sequencing workflow that may be performed in accordance with aspects of the present disclosure is described. Supports and/or template nucleic acids may be prepared and/or provided to be compatible with downstream processing (e.g., sequencing operations). A support (e.g., bead) may be used to help facilitate sequencing of a template nucleic acid on a substrate. The support may help immobilize a template nucleic acid to a substrate, such as when the template nucleic acid is coupled to the support, and the support is in turn immobilized to the substrate. The support may further function as a binding entity to retain molecules of a colony of the template nucleic acid (e.g., copies comprising identical or substantially identical sequences as the template nucleic acid) together for any downstream processing. This may be particularly useful in distinguishing a colony of copies of the template nucleic acid from other colonies (e.g., on other supports) and generating sequencing signals for a plurality of template nucleic acid sequences simultaneously.

A template nucleic acid may include an insert sequence sourced from a biological sample. The template nucleic acid may further comprise an adapter sequence (e.g., for capturing by a support oligonucleotide), a primer sequence, or any other functional sequence useful for a downstream operation. Optionally, the supports and/or template nucleic acids may be pre-enriched. Subsequent to preparation of the supports and template nucleic acids, the two may be attached. A template nucleic acid may be coupled to a support via any method(s) that results in a stable association between the template nucleic acid and the support. Once attached, a plurality of support-template complexes may be generated. Optionally, support-template complexes may be pre-enriched, wherein a support-template complex is isolated from a mixture comprising support(s) and/or template nucleic acid(s) not attached to each other.

Subsequent to attachment of the template nucleic acid molecule to the support, the template nucleic acids may be subjected to amplification reactions to generate a plurality of amplification products immobilized to the support. For example, such amplification reactions may comprise performing polymerase chain reaction (PCR), including but not limited to emulsion PCR (ePCR or emPCR), isothermal amplification (e.g., recombinase polymerase amplification (RPA)), bridge amplification, template walking, etc. Emulsion PCR methods are described in further detail in U.S. Pat. No. 11,891,658 B21 and U.S. Pat. Pub. Nos. 2022/0042072A1 and 2023/0332226A1, each of which is incorporated by reference herein in its entirety.

Subsequent to amplification, the supports (e.g., comprising the template nucleic acids) may be subjected to post-amplification processing to enrich for positive supports (e.g., those comprising a template nucleic acid molecule). Example methods of enrichment of amplified supports are described in U.S. Pat. Nos. 10,900,078 and 11,118,223 and U.S. Pat. Pub. Nos. 2021/0079464A1 and 2023/0332226A1, each of which is incorporated by reference herein in its entirety.

Subsequent to post-amplification processing, the template nucleic acids may be subject to sequencing. The template nucleic acid(s) may be sequenced while attached to the support. Alternatively, the template nucleic acid molecules may be free of the support when sequenced and/or analyzed. In some instances, the template nucleic acids may be sequenced while attached to the support which is immobilized to a substrate. Examples of substrate-based sample processing systems are described elsewhere herein. Labeled nucleotides may comprise a dye, fluorophore, or quantum dot.

It will be appreciated that the combinations of termination states on the nucleotides, label types (e.g., types of dye or other detectable moiety), fraction of labeled nucleotides within a flow, type of nucleotide bases in each flow, type of nucleotide bases in each flow cycle, and/or the order of flows in a flow cycle and/or flow order, can be varied for different sequencing methods. In cases where unterminated nucleotides are used, multiple nucleotides may be incorporated on a template in a single sequencing flow. In cases where terminated or reversibly terminated nucleotides are used, typically a single nucleotide may be incorporated on a template in a single sequencing flow. Different types of nucleotide bases may be flowed in any order and/or in any mixture of base types that is useful for sequencing. Various flow-based sequencing systems and methods are described in e.g., U.S. patent Ser. No. 11/459,609 and U.S. Pat. No. 11,763,915B2, each of which is incorporated by reference herein in its entirety.

Subsequent to sequencing, the sequencing signals collected and/or generated may be subjected to data analysis. The sequencing signals may be processed to generate base calls and/or sequencing reads. In some cases, the sequencing reads may be processed to generate diagnostics data of the biological sample, or the subject from which it was derived.

While a sequencing workflow has been described with respect to the use of supports to bind template molecules, it will be appreciated that the different supports may be effectively replaced by using spatially distinct locations on one or more surfaces, which do not necessarily have to be the surfaces of individual supports (e.g., beads). For example, a first spatially distinct location on a surface may be capable of directly immobilizing a first colony of a first template nucleic acid and a second spatially distinct location on the same surface (or a different surface) may be capable of directly immobilizing a second colony of a second template nucleic acid to distinguish from the first colony. In some cases, the surface comprising the spatially distinct locations may be a surface of the substrate on which the sample is sequenced, thus streamlining the amplification-sequencing workflow.

### Enhanced Resolution or Super-Resolution Imaging

In recent years, many methods have been developed that overcome the diffraction limit by various physical mechanisms, such as stimulated emission depletion microscopy (STED), photo-activated localization microscopy (PALM), stochastic optical reconstruction microscopy (STORM), reversible saturable optical fluorescence transitions microscopy (RESOLFT), etc. However, these approaches generally have low throughput, precluding their use for high-speed imaging applications, and in many cases these methods require specialized fluorophores. A faster and more general framework allowing for a modest but significant increase in resolution is provided by methods utilizing patterned illumination, such as confocal microscopy, structured illumination microscopy (SIM), and image scanning microscopy (ISM).

Prior publications have described the combination of TDI with multi-focal confocal microscopy, where a large number of stationary illumination points are projected onto the specimen, and an array of pinholes is used to spatially filter the resulting image to create a confocal image in a single TDI pass. This approach enables high-throughput imaging with sub-diffraction limited resolution and requires no computational overhead. However, its significant drawback is the steep reduction of signal in view of the modest resolution increase that is an inherent limitation of confocal microscopy. This drawback is resolved in image scanning microscopy (ISM) and structured illumination microscopy (SIM), but these two approaches require the acquisition of multiple images with subsequent computational reconstruction of a resolution-enhanced image, which significantly increases the imaging system complexity and dramatically decreases throughput compared to conventional TDI imaging.

Another imaging modality based on the use of patterned illumination is a variant of ISM where the final image is generated directly on the image sensor without computational overhead. These techniques are known variously as re-scan confocal microscopy, optical photon (or pixel) reassignment microscopy (OPRA), or instant SIM. In these techniques, a resolution improvement is achieved by optical rerouting of light emanating from the sample to an appropriate location in the image plane, either by an arrangement of scanning mirrors or using a modified spinning disk. However, while some of these techniques provide enhanced-resolution images at relatively high frame rates, they are mainly applicable to imaging of a small field of view and are not readily compatible with scanning imaging modalities such as TDI. Therefore, as noted above, there remains an unmet need for systems, devices, and methods for imaging that can bring together the high throughput and SNR of TDI imaging with the resolution enhancement attainable using patterned illumination.

The trade-offs between imaging speed, signal-to-noise ratios (SNR), and image resolution are key considerations for many imaging applications (e.g., nucleic acid sequencing, small molecule or analyte detection, in-vitro cellular biological systems, synthetic and organic substrate analyses, etc.). In some cases, when optimizing an imaging system for a given attribute, others may be compromised. For example, current imaging systems and methods focused on improving imaging resolution beyond the diffraction limit (e.g., stimulated emission depletion microscopy (STED), photo-activated localization microscopy (PALM), stochastic optical reconstruction microscopy (STORM), reversible saturable optical fluorescence transitions microscopy (RESOLFT), etc.) are indeed capable of producing images that have image resolution that exceeds the diffraction limit, yet have low imaging throughputs (e.g., long image acquisition times and/or small fields-of-view) that limit their applicability in applications where high-speed imaging is required. The present disclosure presents systems and methods that can improve imaging speed, SNR, and image resolution simultaneously.

### Optical Transform Imaging Systems

Provided herein are imaging systems that combine optical photon reassignment microscopy (OPRA) with time delay and integration (TDI) imaging to enable high throughput, high signal to noise ratio (SNR) imaging while also providing enhanced image resolution by utilizing illumination light at an NA exceeding that of a traditional objective lens. The general combination of TDI and OPRA as used herein may be referred to as Confocal Structured Illumination (CoSI), systems and methods of which are provided, e.g., in US Pat. Pub. No. US20240255428, which is incorporated by reference herein in its entirety. Optical photon reassignment microscopy (OPRA) is an optical technique for achieving enhanced image resolution without the need for the computer-based methods often previously applied to methods such as image scanning microscopy (ISM) to computationally reassign the detected light intensity at any point in time to a corresponding most probable position of an emitter during a scan (Roth, et al. (2013), “Optical photon reassignment microscopy (OPRA)”, Optical Nanoscopy 2:5). OPRA is an improvement on ISM (discussed above). As with ISM, it is a method that does not reject light and is thus capable of generating high SNR images. However, OPRA does not require digital processing and only requires acquisition of a single image, which minimizes technical noise.

In TDI imaging, an image sensor (e.g., a time delay and integration (TDI) charge-coupled device (CCD)) is configured to capture images of moving objects without blurring by having multiple rows of photosensitive elements (pixels) which integrate and shift signals to an adjacent row of photosensitive elements synchronously with the motion of the image across the array of photosensitive elements. An image comprises a matrix of analog or digital signals corresponding to a numerical value of, e.g., photoelectric charge, accumulated in each image sensor pixel during exposure to light. During each clock cycle (typically from about 1 to 10 microseconds), the signal accumulated in each image sensor pixel is moved to an adjacent pixel (e.g., row by row in a “line shift” TDI sensor). The last row of pixels is connected to the readout electronics, and the rest of the image is shifted by one row. The motion of the object being imaged is synchronized with the clock cycle and image shifts so that each point in the object is imaged onto the same point in the image as it traverses the field of view (i.e., there is no motion blur). The image sensor (or TDI camera) is either continuously exposed, or line shifts may be alternated with exposure intervals. Each point in the image accumulates signal from N clock cycles, where N is the number of active pixel rows in the image sensor. The ability to integrate signals over the duration of a scan provides for high sensitivity imaging at low light levels.

The imaging systems described herein combine these techniques by using novel combinations of optical transformation devices (and other optical components) to create structured illumination patterns for imaging an object, to reroute and redistribute the light reflected, transmitted, scattered, or emitted by the object, and to project the rerouted and redistributed light onto one or more image sensors configured for TDI imaging. The combinations of OPRA and TDI disclosed herein allow the use of static optical transformation devices, which confers the advantages of: (i) being much simpler than exiting implementations of OPRA-like systems, and (ii) enabling a wide field-of-view and hence a very high imaging throughput (similar to or exceeding the throughput of conventional TDI systems). The disclosed imaging systems may be configured to perform fluorescence, reflection, transmission, dark field, phase contrast, differential interference contrast, two-photon, multi-photon, single molecule localization, or other types of imaging.

In some cases, the disclosed imaging systems may be standalone imaging systems. Alternatively, or in addition, in some instances the disclosed imaging systems, or component modules thereof, may be configured as an add-on to a pre-existing imaging system.

The disclosed imaging systems may be used to image any of a variety of objects or samples. For example, the object may be an organic or inorganic object, or combination thereof. An organic object may comprise cells, tissues, nucleic acids, nucleic acids conjugated onto beads, nucleic acids conjugated onto a surface, nucleic acids conjugated onto a support structure, proteins, small molecule analytes, a biological sample as described elsewhere herein, or any combination thereof. An object may comprise a substrate comprising one or more analytes (e.g., organic, inorganic) immobilized thereto. The object may comprise any substrate as described elsewhere herein, such as a planar or substantially planar substrate. The substrate may be a textured substrate, such as physically or chemically patterned substrate to distinguish at least one region from another region. The object may comprise a substrate comprising an array of individually addressable locations. An individually addressable location may correspond to a patterned or textured spot or region of the substrate. In some cases, an analyte or cluster of analytes (e.g., clonally amplified population of nucleic acid molecules, optionally immobilized to a bead) may be immobilized at an individually addressable location, such that the array of individually addressable locations comprises an array of analytes or clusters of analytes immobilized thereto. The imaging systems and methods described herein may be configured to spatially resolve optical signals, at high throughput, high SNR, and high resolution, between individual analytes or individual clusters of analytes within an array of analytes or clusters of analytes that are immobilized on a substrate. At any one point in time, when the object is illuminated not all of the individually addressable locations within the scanned FOV will emit optical (e.g., fluorescent) signals. That is, for a given time point, at least one individually addressable location on the object and within the illuminated FOV will not emit an optical signal (e.g., a fluorescent intensity).

In some instances, the disclosed imaging systems may be used with a nucleic acid sequencing platform, non-limiting examples of which are described in PCT International Patent Application Publication No. WO 2020/186243, which is incorporated by reference herein in its entirety. In some instances, the disclosed imaging systems may comprise components (especially multiple optical transformation elements), as described in U.S. Pat. Pub. Nos. US20240255428A1 and Intl. Pat. Pub. No. WO2024/076573, each of which is incorporated by reference herein in its entirety.

### Optical Transform Imaging System Configurations

The optical elements, and configuration thereof, of systems and methods described herein can be varied while still achieving high-throughput, high SNR, and enhanced resolution imaging. Variations of the optical system may share an optical path that, with or without additional optical elements (e.g., relay optics) at various stages, configures the light to travel from a radiation source (e.g., which is configured to output light) to a first optical transformation device to perform a first transformation to generate an illumination pattern, which illumination pattern is directed to an object, which object emits a reflected, transmitted, scattered, or emitted pattern of light (e.g., light output from the object or the object plane), which is then directed to a second optical transformation device to perform a second transformation to generate an image at one or more image sensors. Direction of illumination patterns to and from the object may be performed using any of a variety of configurations of the optical elements of the optical projection unit (e.g., a dichroic mirror and objective lens), as will be described below. In some instances, light is output from or by at least a portion of the object. Accordingly, an optical imaging system of the present disclosure may comprise at least a radiation source, a first optical transformation device, a second optical transformation device, and a detector.

Motion blur may be caused by different linear velocities across the imaging system FOV. In a case where the relative motion between the object and the imaging system comprises rotational motion centered about a rotational axis located outside the field-of-view of the imaging system, the main technical challenge is the fact that at radius r₁ (corresponding to the innermost side of the image sensor) and at radius r₂ (corresponding to the outermost side of the image sensor), the object to be imaged, e.g., a rotating wafer, moves by different distances (S₁ and S₂, respectively) during the image acquisition time. A TDI sensor can only move at a single speed and thus can match the velocity of a circular object's movement at only one location in the sensor. This is typically optimized so that the center of the sensor matches the object's movement (e.g., the center, r₁/2+r₂/2). In CoSI, at the sample plane (e.g., at the surface of the wafer), the optimal imaging system will increase the density of illumination peaks and also increase the illumination width in the y axis, thus reducing the peak intensity of illumination while maintaining the number of fluorescent photons received at the detector. Thus, the value of S₂ and S₁, and (S₂−S₁), can be increased.

One strategy to compensate for this relative motion is to separate the motion into linear (translational) and rotational motion components. An alternative strategy is to use wedged counter scanning where a magnification gradient can be created by, e.g., altering the working distance across the field-of-view of the image sensor (e.g., the camera). For example, a magnification gradient that is characterized by a magnification ratio (i.e., the ratio of magnification at the outer radius of the sensor to magnification at the inner radius of the sensor) given by magnification ratio=(S₂/S₁)=(r₂/r₁)=1+(FOV/r₁) where an FOV=r₂−r₁ could be used to compensate for the relative motion. As an example, if FOV is 2.6 mm and r₁=60 mm, then the magnification ratio between S₂ and S₁ is approximately 1.04.

Another strategy to compensate for this relative motion is to insert a tilted lens before a tilted image sensor, where D₁ is the distance between the tilted sensor and the tilted lens, D₂ is the distance between the tilted lens and the original image plane, and Δd is D₂−D₁. If the focal length of the lens is f, then the magnification across the tilted lens can be determined as: α′=D₁/D₂=f/(f+D₂), where α′ is similar to the concept of the photon reassignment coefficient, a.

If α′ is set to 1, then D₂ will be 0 (and hence Δd will be 0), meaning that the sensor and the lens would be superimposed. If D₂ is 0.04f, then α′ will be 1/1.04 and Δd will be 0.0015f. The relative change in magnification between one edge of the FOV and the other can be determined as: 1/α′=f/(f+D₂).

In some instances, the sensor and the lens are tilted at a same angle (and if so, there will be no variable magnification). In some instances, the sensor and the lens are tilted at different angles (e.g., β₁ and β₂, respectively). In some instances, β₁ may be at least about 0.1, 0.2, 0.3, 0.4, 0.5, 0.6, 0.7, 0.8, 0.9, 1, 2, 3, 4, 5, 6, 7, 8, 9, or 10 degrees. In some instances, β₂ may be at least about 1, 2, 3, 4, 5, 6, 7, 8, 9, 10, 15, or 20 degrees. For instance, β₁ and β₂ each may be of any value within their respective ranges, e.g., about 0.54 degrees and about 11 degrees.

Accordingly, in some instances, the disclosed imaging systems may be configured to redirect light transmitted, reflected, or emitted by the object to one or more optical sensors (e.g., image sensors) through the use of a tiltable objective lens configured to deliver the substantially motion-invariant optical signal to the one or more optical sensors (e.g., image sensors). The redirecting of light transmitted, reflected, or emitted by the object to the one or more optical sensors may further comprise the use of a tiltable tube lens and/or a tiltable image sensor. In some instances, tiltable objectives, tube lenses, and/or image sensors may be actuated using, e.g., piezoelectric actuators.

In some instances, in any of the imaging system configurations described herein, the position of a second optical transformation device (e.g., a second micro-lens array) may be varied. For example, in some instances, the second MLA may be positioned directly (e.g., mounted) on the image sensor. In some instances, the second MLA may be positioned on a translation stage or moveable mount so that its position relative to the image sensor (e.g., its separation distance from the sensor, or its lateral displacement relative to the sensor) may be adjusted. In some instances, the distance between the second MLA and the image sensor is less than 10 mm, 1 mm, 100 μm, 50 μm, 25 μm, 15 μm, 10 μm, 5 μm, or 1 μm or any value within a range therein. The location of the second MLA with respect to the sensor may be determined by the MLA's focal length (i.e., the second MLA may be positioned such the final photon reassignment coefficient is within a desired range). The photon reassignment coefficient is determined as the ratio of L1/L2, where L1 is the focal length of the second MLA and L2 is the effective distance of the second MLA2 to the sensor plane. For example, the focal length of the second MLA may be between 1 μm and 1000 μm, between 50 μm and 1000 μm, between 5 μm and 50 μm, or between 15 μm and 25 μm or any value within a range therein. For example, the second MLA may have a focal length of about 20 μm.

In some instances of any of the imaging system configurations described herein, the system may further comprise line-focusing optics for adjusting the width of a laser line used for illumination or excitation. For example, the line width of the focused laser may be made wider to reduce peak illumination intensity and avoid photodamage or heat damage of the object, while the line width of the focused laser line may be made narrower in order to reduce motion-induced blur). Photodamage is particularly problematic for objects comprising fluorophores (e.g., such as the fluorophores used in many sequencing applications).

In any of the imaging system configurations described herein, the detection unit may comprise one or more image sensors. In some instances, the one or more image sensors may comprise a time delay and integration (TDI) camera, charge-coupled device (CCD) camera, complementary metal-oxide semiconductor (CMOS) camera, a single-photon avalanche diode (SPAD) array, or any combination thereof. In some instances, the detection unit may comprise one or more image sensors configured to detect photons in the visible, near-infrared, infrared or any combination thereof. In some instances, each of two or more image sensors may be configured to detect photons in the same wavelength range. In some cases, each of two or more image sensors may be configured to detect photons in a different wavelength range.

In any of the imaging system configurations described herein, the one or more image sensors may each comprise from about 256 pixels to about 65,000 pixels. In some instances, an image sensor may comprise at least 256 pixels, 512 pixels, 1,024 pixels, 2,048 pixels, 4,096 pixels, 8,192 pixels, 12,254 pixels, 32,768 pixels, or 65,536 pixels. In some instances, an image sensor may comprise at most 256 pixels, 512 pixels, 1,024 pixels, 2,048 pixels, 4,096 pixels, 8,192 pixels, 12,254 pixels, 32,768 pixels, or 65,536 pixels. For instance, an image sensor may have any number of pixels within this range, e.g., 2,048 pixels.

In any of the imaging system configuration described herein, the one or more image sensors may have a pixel size of about 1 micrometer (μm) to about 7 μm. In some cases, the sensor may have a pixel size of at least about 1 μm, 2 μm, 3 μm, 4 μm, 5 μm, 6 μm, or 7 μm. In some instances, the sensor may have a pixel size of at most about 1 μm, 2 μm, 3 μm, 4 μm, 5 μm, 6 μm, or 7 μm. For instance, the objective lens may have any pixel size within this range, e.g., about 1.4 μm.

In any of the imaging system configurations described herein, the one or more image sensors may operate on a TDI clock cycle (or integration time) ranging from about 1 nanosecond (ns) to about 1 millisecond (ms). In some instances, the TDI clock cycle may be at least 1 ns, 10 ns, 100 ns, 1 microsecond (μs), 10 μs, 100 μs, 1 ms, 10 ms, 100 ms, or 1 s. For instance, the TDI clock cycle may have any value within this range, e.g., about 12 ms. In any of the imaging system configurations described herein, the one or more sensors may comprise TDI sensors that include a number of stages used to integrate charge during image acquisition. For example, in some instances, the one or more TDI sensors may comprise at least 64 stages, at least 128 stages, at least 256 stages. In some instances, the one or more TDI sensors may be split into two or more (e.g., 2, 3, 4, or more than 4) parallel sub-sensors that can be triggered sequentially to reduce motion-induced blurring of the image, where the time delay between sequential triggering is proportional to the relative rate of motion between the sample to be imaged and the one or more TDI sensors.

In any of the imaging system configurations described herein, the system may be configured to acquire one or more images with a scan time ranging from about 0.1 millisecond (ms) to about 100 sec. In some instances, the image acquisition time (or scan time) may be at least 0.1 ms, 1 ms, 10 ms, 100 ms, 1 microsecond (μs), 10 μs, 100 μs, 1 s, 10 s, or 100 s. In some instances, the image acquisition time (or scan time) may have any value within the range of values described in this paragraph, e.g., 2.4 s.

### Methods of Imaging

Disclosed herein, in some examples, are methods of imaging an object with the imaging systems described herein. In some instances, imaging an object with the imaging systems described herein may provide high-throughput, high SNR imaging while maintaining an enhanced imaging resolution. In some cases, the method of imaging an object may comprise: (a) illuminating a first optical transformation device by a radiation source; (b) transforming light from the radiation source to generate an illumination pattern; (c) projecting the illumination pattern to a projection optical assembly configured to receive and direct the illumination pattern from the first optical transformation device to the object; (d) receiving a reflection of the illumination pattern from the object by a second optical transformation device; (e) transforming the illumination pattern by the second optical transformation device to generate a transformed illumination pattern; (f) detecting the transformed illumination pattern with one or more image sensors, wherein the image sensors are configured for time delay and integration (TDI) imaging, and wherein the illumination pattern is moved relative to the object and/or the object is moved relative to the illumination pattern. The illumination pattern and/or the object may be moved via one or more actuators, e.g., the actuator may be a linear stage with the object attached thereto. Alternatively, the actuator may be rotational.

In some instances, imaging an object using the disclosed imaging systems may comprise: illuminating a first optical transformation device with a light beam, applying by the first optical transformation device a first optical transformation to the light beam to produce an illumination pattern, providing the illumination pattern to the object by an object-facing optical component onto the object, directing light reflected, transmitted, scattered, or emitted by (e.g., output from) the object to a second optical transformation device, applying by the second optical transformation device a second optical transformation to light reflected, transmitted, scattered, or emitted by (e.g., output from) the object and relaying it to one or more image sensors configured for time delay and integration (TDI) imaging; and scanning the object relative to the object-facing optical component, or the object-facing optical component relative to the object, wherein relative motion of the object and object-facing optical component during the scan is synchronized to the time delay and integration (TDI) imaging by the one or more image sensors such that a scanned image of all or a portion of the object is acquired by each of the one or more image sensors. In some instances, the illumination pattern is scanned across the object, where the scanning pattern is synchronized to the TDI imaging by the one or more image sensors to acquire the scanned image of all or a portion of the object. In some cases, the speed and the direction of the scanning is synchronized to the TDI imaging. The scanning may comprise moving the illumination pattern, moving the object, or both.

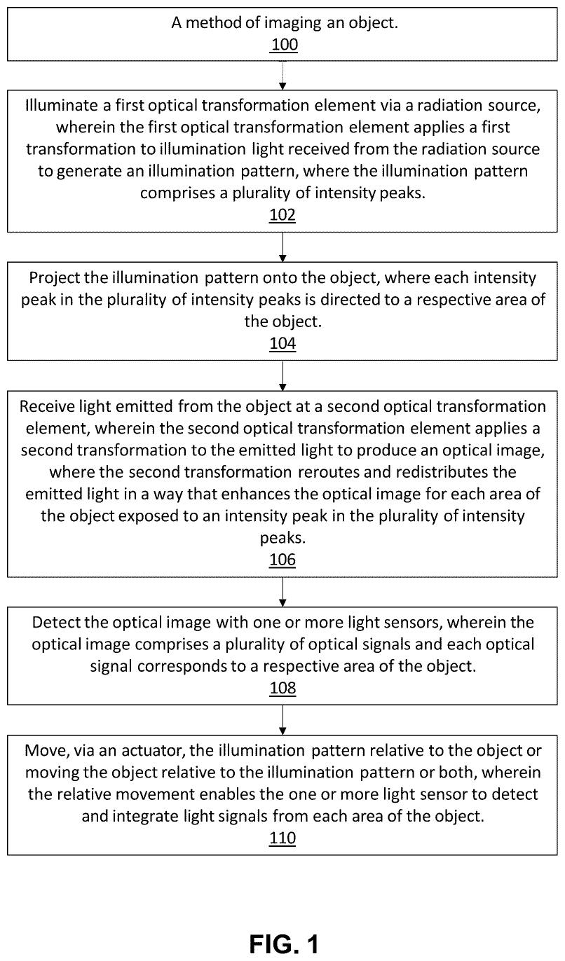

FIG. 1 provides a flowchart illustrating an example method of imaging an object 100, in accordance with some implementations described herein. In step 102, a first optical transformation device is used to transform light provided by a radiation source to generate an illumination pattern comprising a plurality of illumination intensity peaks. In step 104, the patterned illumination is directed to the object being imaged (e.g., using a projection optical assembly), where each illumination intensity peak (or illumination intensity maxima) is directed to a corresponding point or location on the object. In step 106, light that is reflected, transmitted, scattered, or emitted by the object in response to being illuminated by the patterned illumination is collected and directed to a second optical transformation device that applies a second optical transformation to the collected light and reroutes and redistributes in a way that compensates for a spatial shift that would have been observed by each individual image sensor pixel of a TDI image sensor in an otherwise identical imaging system that lacked the second optical transformation device (i.e., the second optical transformation device produces a transformed optical image). In step 108, the transformed optical image is focused on one or more image sensors configured for TDI imaging that detect and integrate optical signals to acquire an enhanced resolution image of the object. In step 110, which is performed in parallel with the image acquisition in step 108, an actuator is used to move the object relative to the illumination pattern (and imaging optics), or to move the illumination pattern (and imaging optics) relative to the object, so that relative movement of the object and the pixel-to-pixel transfer of accumulated photoelectrons in the one or more TDI image sensors is synchronized, and light arising from each point on the object is detected and integrated to produce an enhanced resolution, high SNR image.

In some instances, only a portion of the object may be imaged within a scan. In some instances, a series of images is acquired, e.g., through performing a series of scans where the object is translated in one or two dimensions by all or a portion of the field-of-view (FOV) between scans, and the series of scans is aligned relative to each other to create a composite image of the object having a larger total FOV.

### Illumination Systems for Enhanced Resolution

In addition to increased scanning rate, imaging and/or sequencing throughput can also be raised by increasing the density of analytes on a substrate. However, denser arrays of analytes require concomitantly increased imaging resolution. TDI imaging with optical transformation can improve resolution to a degree. By utilizing excitation illumination that is directed to a substrate external to an objective lens of an imaging system, resolution can be improved even more. That is, an effective illumination NA greater than the NA permitted by an objective can be used to increase the amount of illumination directed to an analyte. This can improve resolution by a) increasing the density of illumination points (e.g., illumination intensity maxima) and b) decreasing the size of illumination points.

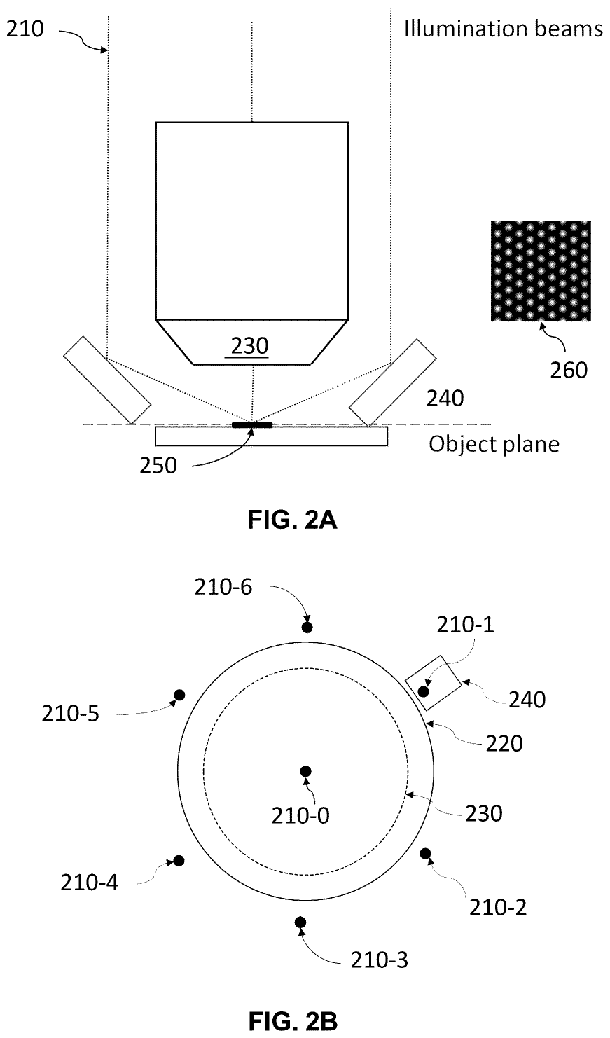

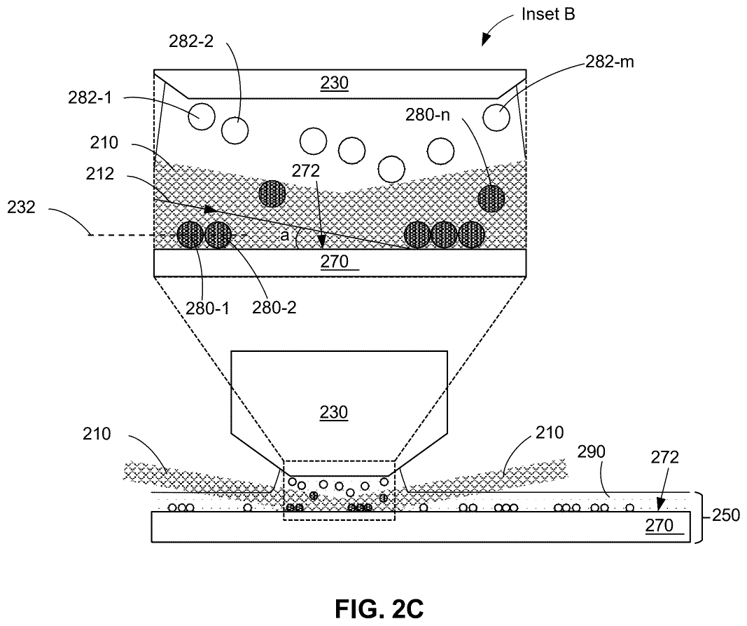

FIG. 2A illustrates an example illumination configuration that supports a modified form of CoSI where discrete collimated beams at angles outside of the numerical aperture of objective lens 230 are directed onto sample 250 via optical element 240. This configuration is referred to as external continuous structured illumination (X-CoSI or xCoSI). FIG. 2B shows a top schematic representation of the system shown in FIG. 2A. For simplicity, the object plane and sample are omitted. Also, for simplicity, only one example optical element 240 is shown being associated with input beam 210-1.

As seen in FIG. 2A, the input illumination 210 (e.g., the external illumination light beams, input light, or illumination light) passes through objective system 220 and has an incident angle that is much greater than the numerical aperture of objective lens 230, when redirected. In some embodiments, the incident angle can be close to 90 degrees. As a result, a denser illumination pattern 260 can be achieved. Since spacing between structured elements in a structured illumination pattern (e.g., dots in a structured illumination pattern 260 shown in FIG. 2A) are based on the highest order of the diffraction pattern included in the structured illumination pattern, using an illumination pattern that includes only zeroth and 1st orders of the diffraction pattern in CoSI configurations may result in background noise levels (e.g., from out-of-focus emitters) that are higher than desired, since the structured elements are closely spaced to one other. In contrast, systems with external illumination (i.e., xCoSI), however, may include even higher orders of the diffraction pattern, such as the third and fourth orders of the diffraction pattern (as well as any other higher orders of the diffraction pattern) in the structured illumination pattern, resulting in a structured illumination pattern with structured elements that are spaced further apart (e.g., dots in the dotted illumination pattern are spaced further apart from one another) compared to a structured illumination pattern that does not include higher orders of the diffraction pattern. Further, the provision of the structured illumination pattern using external (i.e., oblique) illumination methods can further reduce the background noise due to less illumination of out-of-focus regions of a sample (e.g., out-of-focus emitters).

In some embodiments, an individual optical element 240 is associated with each input beam (e.g., 210-1, 210-2, etc.) that does not pass through the objective lens system (e.g., external beams). In some embodiments, the same optical element can be used to redirect two different input light beams. For example, 2, 3, 4, 5 or more optical elements, or a single optical element, can be used to direct 6 input beams as shown in FIG. 2B. In some embodiments, a multi-faceted prism can be used to direct multiple beams towards the sample. For example, additional elements (one or multiple) can be used to create the illumination beams (e.g., mutually coherent beams) and to route them towards the multi-faceted prism that directs the beams onto the sample.

In some situations, these individual optical elements 240 can be used to provide active phase compensation for each input light beam (e.g., beamlet). In some cases, individual optical elements 240 can modify the shape, angle, size, and relative positioning of the input light beams. In some cases, the optical elements comprise immersion couplers (e.g., prism couplers). In some cases, the optical elements are in contact with the object (e.g., rest on the surface of the object plane or contacted to the surface via a liquid layer). The optical elements may be incorporated into the objective jacket or the objective window. The optical elements may be mirrors.

In some cases, the input light beams are produced by directing illumination from a radiation source through an optical transformation device (e.g., a diffraction grating, microlens array, etc.). in some cases, the illumination light may be transmitted through an objective element (e.g., through the objective jacket) but external to the objective lens.

To provide optimal resolution improvement, each external beam will be incident on a same sized field of view of the object (e.g., a substrate). In some cases, each field of view comprises an area at least 10 μm×10 μm, 10 μm×100 μm, 100 μm×100 μm, 10 μm×1 mm, 100 μm×1 mm, 1 mm×1 mm, 10 μm×10 mm, 100 μm×10 mm, 1 mm×10 mm, or 10 mm×10 mm. By way of specific example, each external beam field of view may be 2.6 mm×10 μm.

In some cases, central input light beam 210-0 may be omitted. The central illumination light beam primarily impacts axial resolution (e.g., z-axis resolution), where the external light beams primarily influence lateral resolution (e.g., xy-axis resolution). In some cases, axial resolution is less important than lateral resolution (e.g., when the analyte to be analyzed is substantially planar or substantially a point), and the central input light beam may not be used (e.g., only external input light may be required). In other cases, axial resolution may be more essential, and a central input light beam may be used to improve overall resolution. For example, where the analyte is a cell, tissue, or other sample with three-dimensional characteristics, increased axial resolution may be desired.

In some cases, a central light beam may be beneficial for suppressing fluorescence background. In addition, a central light beam may help suppress unwanted fringes in the interference pattern, where fringes are a product of a ratio of central beam to external beam amplitudes. In the interference pattern provided by the illumination light, only primary fringes (e.g., the regular grid of illumination maxima in the interference pattern). Additional, unwanted fringes can negatively impact the contrast of images.

FIG. 2C illustrates a specific method of external illumination of a sample as described with respect to FIGS. 2A and 2B, e.g., oblique illumination of a sample 250. The sample 250 includes a substrate 270 and a plurality of emitters (e.g., emitters 280-1, 280-2, . . . 280-n, and 282-1, 282-2, . . . 282-m). The plurality of emitters includes a first set of emitters (e.g., emitters 280-1, 280-2, . . . 280-n) and a second set of emitters (e.g., emitters 282-1, 282-2, . . . 282-m). As shown in inset B, the input illumination 210 (also represented by ray 212, which is a chief ray of the input illumination 210) is incident upon a surface 272 of the substrate 270 at an oblique angle α relative to the surface 272 of the substrate 270. In some embodiments the oblique angle α is 85 degrees, 80 degrees, 75 degrees, 70 degrees, 65 degrees, 60 degrees, 55 degrees, 50 degrees, 45 degrees, 40 degrees, 35 degrees, 30 degrees, 25 degrees, 20 degrees, 15 degrees, 10 degrees, or 5 degrees or smaller. In some embodiments, the total of 90−α is larger than an acceptance angle (or numerical aperture) of the objective lens 230.

In this example, the sample (e.g., sample 250) includes a plurality of emitters (e.g., the first set of emitters (e.g., emitters 280-1, 280-2, . . . 280-n) and the second set of emitters (e.g., emitters 282-1, 282-2, . . . 282-m)). As shown, emitters 280-1, 280-2, . . . 280-n are located at or within a different distance from the objective lens 230 than emitters 282-1, 282-2, . . . , and 282-m. That is, emitters 280-1, 280-2, . . . , and 280-n are located at a different distance from a focal plane 232 of the objective lens 230 than emitters 282-1, 282-2, . . . , and 282-m. Some of the emitters, such as emitters 280-1 and 280-2, are located at or near the focal plane 232 of the objective lens 230. Some of the emitters, such as emitters 282-1 and 282-2, are located at a plane that is different from (e.g., away from, spaced apart from) the focal plane 232 of the objective lens 230. In some embodiments the focal plane 232 of the objective lens 230 is separated from the objective lens 230 by a distance that is substantially equal (e.g., within the depth of field of the input illumination 210) to a focal length of the objective lens 230. In some embodiments, the focal plane 232 of the objective lens 230 is located at a position where the substantially strongest signal is received from the sample (e.g., within 80%, 85%, 90%, 95%, 96%, 97%, 98%, 99%, or higher of the highest intensity signal or highest peak signal). In some embodiments, the focal plane 232 of the objective lens 230 is located at a position where the substantially best signal-to-noise ratio (SNR) of an image of the sample is achieved (e.g., within 80%, 85%, 90%, 95%, 96%, 97%, 98%, 99%, or higher of the best SNR). In some embodiments, the focal plane 232 of the objective lens 230 is located at a position where a substantially best resolution (e.g., lateral resolution, axial resolution) of an image of the sample is achieved (e.g., within +1%, +2%, +3%, +4%, +5%, +10%, +15%, +20%, +25%, or +30% of the smallest achievable resolution). In some embodiments the focal plane 232 of the objective lens 230 is located at a position that provides an acceptable compromise between the resolution, the signal strength, and the SNR of an image of the sample.

As shown in inset B, the oblique angle of incidence a of the input illumination 210 allows a first set of emitters (e.g., emitters 280-1, 280-2, . . . 280-n) to be illuminated without illuminating a second of the emitters (e.g., emitters 282-1, 282-2, . . . 282-m). In some embodiments the emitters are configured to output emission light in response to receiving input illumination 210. In such cases, the objective lens 230 can receive emission light output from emitters of the first set of emitters (e.g., emitters 280-1, 280-2, . . . 280-n) that are illuminated by (e.g., that receive illumination from) the input illumination 210. In contrast, emitters of the second set of emitters (e.g., emitters 282-1, 282-2, . . . 282-m) are not illuminated by (e.g., that do not receive) the input illumination 210, and thus, do not output emission light. Thus, emission light received by the objective lens 230 can generate an image that represents at least a portion of the illuminated emitters of the first set of emitters (e.g., emitters 280-1, 280-2, . . . 280-n) without representing the emitters of the second set of emitters (e.g., emitters 282-1, 282-2, . . . 282-m) that are not illuminated (i.e., emitters outside the focal plane of the system at the illuminated portion of the sample 250). In some embodiments an optical imaging system that utilizes oblique illumination, as shown in FIGS. 2A-2C, can benefit from background reduction compared to conventional illumination methods, due to the oblique illumination providing input illumination 210 to only a desired subset of the sample (e.g., emitters positioned at or near the focal plane of the objective lens 230, which includes at least a portion of the first set of emitters, namely emitters 280-1, 280-2, . . . , and 280-n).

In some embodiments, the illumination configuration shown includes an immersion fluid 290 (e.g., liquid). For example, when the objective lens 230 is an immersive objective lens, the illumination configuration includes an immersion fluid 290 (e.g., water, oil). In such cases, the emitters 280-1, 280-2, . . . , and 280-n, and the emitters 282-1, 282-2, . . . , and 282-m are suspended or surrounded by the immersion fluid 290. In some embodiments the illumination configuration does not include the immersion fluid 290. While the immersion fluid 290 is shown in FIG. 2C, the immersion fluid 290 is not shown in inset B for ease of illustration. In some cases, alternatively or in addition to the immersion fluid, the emitters may be immersed and/or suspended in a solution layer, such as a reagent solution layer, adjacent to the top surface of the substrate.

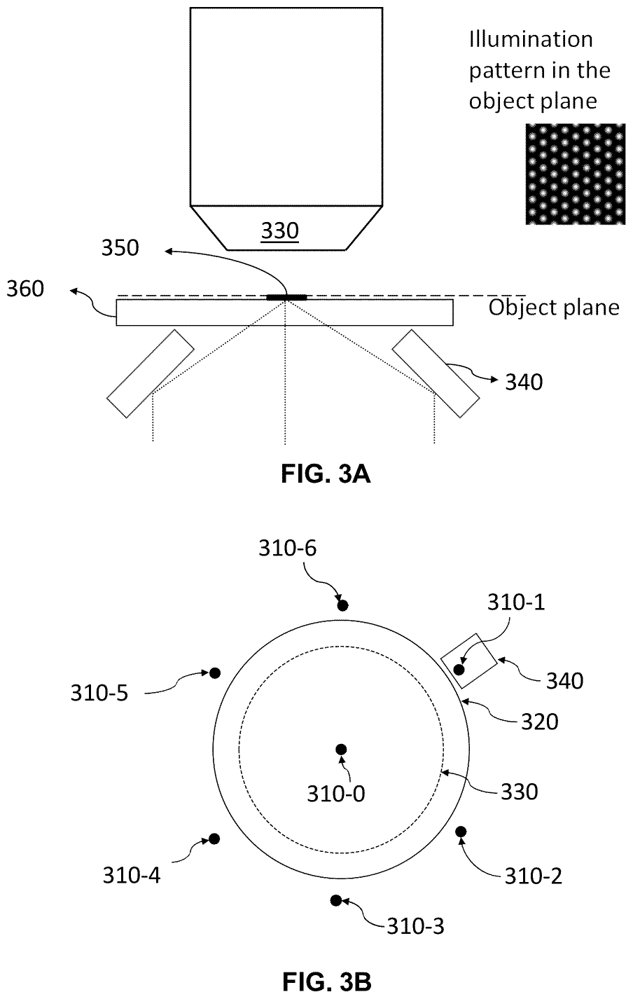

FIG. 3A illustrates another example illumination configuration that supports xCoSI where input illumination 310, in the form of discrete collimated beams at angles greater than the numerical aperture of objective lens 330, is directed, not via the objective system 320, onto sample 350 as back illumination via optical element 340. In a back illumination configuration, the input light may be provided from a first surface of the substrate (e.g., sample platform 360) which opposes a second surface of the substrate that comprises the sample 350, such that the light travels through the depth of the substrate prior to intersecting the sample. Incoming beams are reflected and refracted before reaching sample 350. In a configuration like this, sample platform 360, or at least a portion thereof, comprises one or more optical elements that allow reflected light from optical element 340 to pass through before reaching sample 350.

Similar to the embodiment shown in FIGS. 2A and 2B, the input illumination 310 here has an incident angle that is much greater than the numerical aperture of objective lens 330, when redirected. In a back illumination configuration, all incoming beams as well as an optional center beam do not pass through the objective lens system. In some embodiments, the incident angle can be close to 90 degrees. As a result, a denser illumination pattern can be achieved (FIG. 3A, right). In some embodiments, individual optical element 340 is associated with each input light beam (e.g., 310-1, 310-2, etc.). In some embodiments, the same optical element can be used to redirect two different input light beams. For example, 2, 3, 4, 5 or more optical elements, or a single optical element, can be used to direct 6 input beams as shown in FIG. 3B. In some embodiments, a multi-faceted prism can be used to direct multiple beams towards the sample. For example, additional elements (one or multiple) can be used to create the illumination beams (e.g., mutually coherent beams) and to route them towards the multi-faceted prism that directs the beams onto the sample.

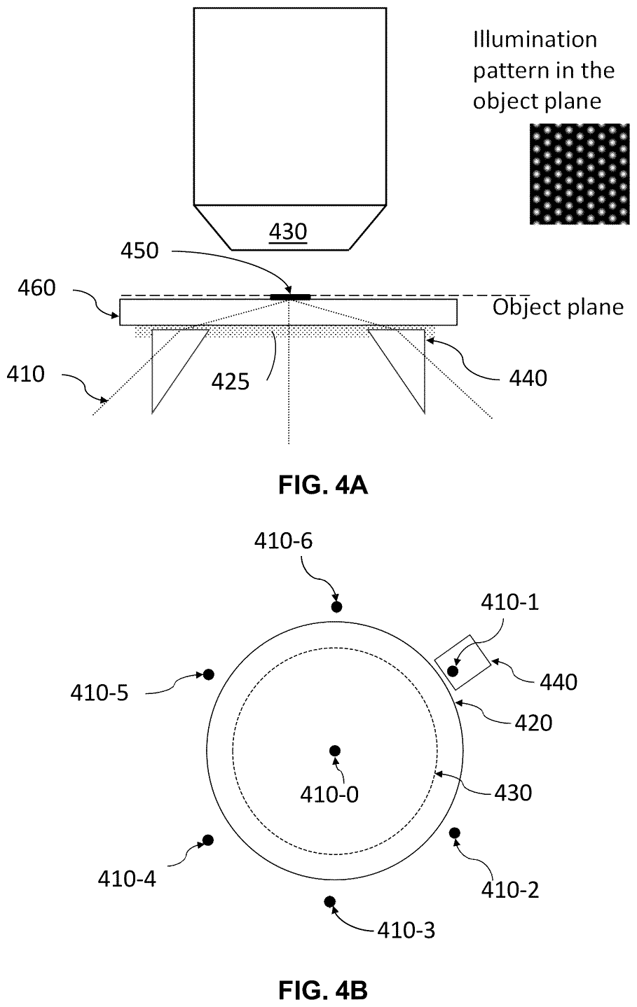

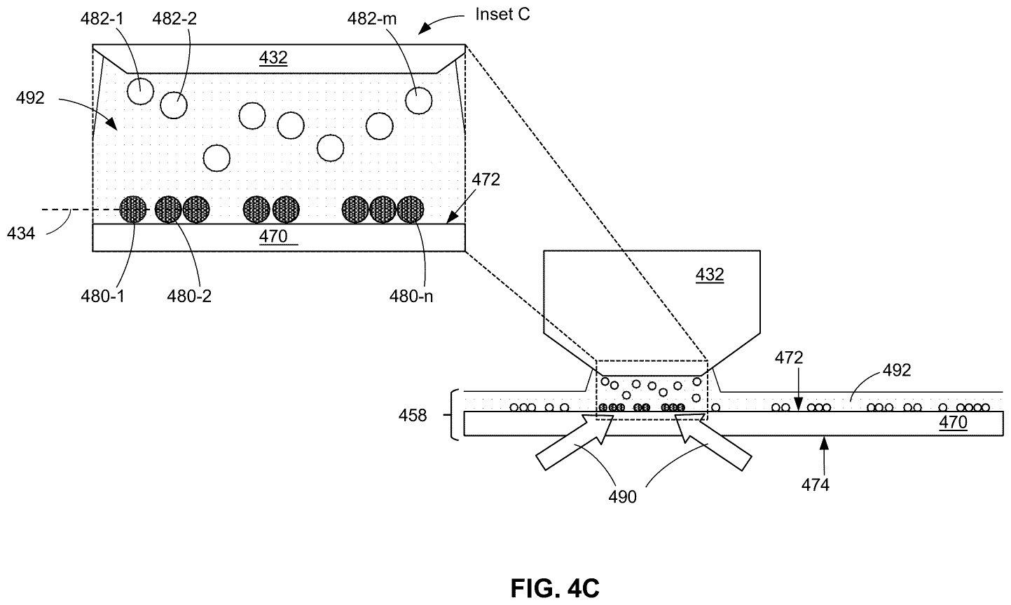

FIG. 4A illustrates another example illumination configuration that supports xCoSI where back illumination is provided to sample 450 via a configuration similar to that of Total Internal Reflection Fluorescence (TIRF) microscopy. One benefit of TIRF, typically, is decreased background, which is due to the thin axial illumination. Here, input illumination 410, in the form of discrete collimated beams at angles greater than the numerical aperture of objective lens 430, is directed onto sample 450 as back illumination via optical element 440, and not via objective system 420. The input illumination 410 is refracted multiple times (e.g., first through optical element 440 and then through sample platform 460) before reaching sample 450.

In some embodiments, the illumination configuration shown in FIG. 4A also includes a fluid 425 (e.g., an immersion fluid) such that at least a portion of the optical element(s) (such as optical element 440) used to direct the input illumination light 410 is submerged in the fluid 425. In some embodiments, a facet of the optical element(s) (such as optical element 440) that outputs the input illumination light 410 is adjacent to and in contact with the fluid 452. In some embodiments, the fluid 452 is an index-matching fluid that has an index of refraction that is substantially similar to (e.g., within +/−1%, +/−2%, +/−3%, +/−4%, +/−5%, +/−6%, +/−7%, +/−8%, +/−9%, +/−10%, +/−15%, or +/−20%) an index of refraction of the sample platform 460. In some embodiments, the fluid 425 has an index of refraction that is substantially similar to an index of refraction of the sample platform 460 such that the input illumination light 410 (e.g., input illumination light beam) is refracted at an interface between the fluid 425 and the sample platform 460 so that a chief ray of the input illumination light 410 propagates within the sample platform 460 at an angle that allows for total internal reflection (TIR) within the sample platform 460.

Back illumination allows illumination optics to access a sample without any obstruction. In some cases, when back illumination is used, the substrate may be transparent or partially transparent. XCoSI illumination as illustrated in FIGS. 4A and 4C differs from conventional TIRF in that xCoSI illumination is patterned (e.g., structured). However, xCoSI may be compatible with TIRF, where illumination would comprise evanescent light.

In the TIRF-like embodiments, when redirected, input illumination 410 has an incident angle that is much greater than the numerical aperture of objective lens 430. This is also a back illumination configuration where all incoming beams as well as an optional center beam do not pass through the objective lens system. As a result, a denser illumination pattern can be achieved (FIG. 4A, right). In addition, there is no risk of illumination light being present in the imaging pathway (e.g., the detection pathway). In some embodiments, individual optical element 440 is associated with each input light beam (e.g., 4410-1, 4410-2, etc.). In some embodiments, the same optical element can be used to redirect two different input light beams. For example, 2, 3, 4, 5, or more optical elements, or a single optical element, can be used to direct 6 input beams as shown in FIG. 4B. In some embodiments, a multi-faceted prism can be used to direct multiple beams towards the sample. For example, additional elements (one or multiple) can be used to create the illumination beams (e.g., mutually coherent beams) and to route them towards the multi-faceted prism that directs the beams onto the sample.

FIG. 4C illustrates an example of back illumination at a sample platform 470 (e.g., sample platform 360 in FIG. 3A and sample platform 460 in FIG. 4A). The sample 458 (e.g., sample 350 in FIG. 3A and sample 450 in FIG. 4A) includes a plurality of emitters (e.g., emitters 480-1, 480-2, . . . 480-n, and 482-1, 482-2, . . . 482-m) disposed on a top surface 472 of the sample platform 470. The input illumination 490 (e.g., input illumination 410 in FIG. 4A) is incident upon a bottom surface 474 of the sample platform 470. As shown in inset C, emitters of the plurality of emitters can be located at various distances from the objective lens 432 and at various distances from a focal plane 434 of the objective lens 432. A first set of emitters (e.g., emitters 480-1, 480-2, . . . 480-n) are located at or near focal plane 434 of the objective lens 432. A second set of emitters (e.g., emitters 482-1, 482-2, . . . 482-m) are located at a plane that is different from (e.g., away from, spaced apart from) the focal plane 434 of the objective lens 432. In some embodiments the focal plane 434 of the objective lens 432 is separated from the objective lens 432 by a distance that is substantially equal (e.g., within a depth of field of the input illumination 490) to a focal length of the objective lens 432. In some embodiments, the focal plane 434 of the objective lens 432 is located at a position where the substantially strongest signal is received from the sample (e.g., within 80%, 85%, 90%, 95%, 96%, 97%, 98%, 99%, or higher of the highest intensity signal or highest peak signal). In some embodiments, the focal plane 434 of the objective lens 432 is located at a position where the substantially best signal-to-noise ratio (SNR) of an image of the sample is achieved (e.g., within 80%, 85%, 90%, 95%, 96%, 97%, 98%, 99%, or higher of the best SNR). In some embodiments, the focal plane 434 of the objective lens 432 is located at a position where a substantially best resolution of an image of the sample is achieved (e.g., within +1%, +2%, +3%, +4%, +5%, +10%, +15%, +20%, +25%, or +30% of the smallest achievable resolution). In some embodiments the focal plane 434 of the objective lens 432 is located at a position that provides an acceptable compromise between the resolution, the signal strength, and the SNR of an image of the sample.

As shown in inset C, back illumination of the sample 458 allows the first set of emitters (e.g., emitters 480-1, 480-2, . . . 480-n), that are located at or near the focal plane 434 of the objective lens 432, to be illuminated without illuminating the second set of emitters (e.g., emitters 482-1, 482-2, . . . 482-m) that are located away from the focal plane 434 of the objective lens 432. In some embodiments the emitters of the first set of emitters (e.g., emitters 480-1, 480-2, . . . 480-n) and emitters of the second set of emitters (e.g., emitters 482-1, 482-2, . . . 482-m) are configured to output emission light in response to receiving input illumination 490 (e.g., input light). In such cases, the objective lens 432 receives emission light output from at least a portion of the first set of emitters (e.g., emitters 480-1, 480-2, . . . 480-n) that are illuminated by (e.g., that receive illumination from) the input illumination 490. In contrast, the second set of emitters (e.g., emitters 482-1, 482-2, . . . 482-m) are not illuminated by (e.g., do not receive) the input illumination 490 and thus, do not output emission light. Thus, emission light received by the objective lens 432 can generate an image that represents at least a portion of the illuminated emitters (e.g., emitters 480-1, 480-2, . . . 480-n) without representing the emitters (e.g., emitters 482-1, 482-2, . . . 482-m) that are not illuminated. In some embodiments, an optical system that utilizes back illumination, as shown in FIGS. 3A and 4A, can benefit from background reduction compared to conventional illumination methods, due to the back illumination providing input illumination 490 to only a desired portion (e.g., a subset) of the sample (e.g., the first set of emitters, namely, emitters 480-1, 480-2, . . . 480-n).

Another advantage of the embodiments shown in FIGS. 4A-4C (e.g., for TIRF-like systems with patterned illumination) is that they offer an even higher effective numerical aperture (NA) of the illumination, and therefore higher resolution. In these cases, the effective illumination NA is not limited by the refractive index of the immersion fluid (and/or of the objective), but by the higher refractive index of the substrate material (which is at least partially transparent for this scheme). Another advantage is that, in these configurations, the illumination light (only the tilted beams) only penetrates the near-surface layer of the immersion liquid, which can reduce background fluorescence. With TIRF, no beam exits the sample platform on the sample side.

In some embodiments, the illumination configuration shown (e.g., in FIG. 4C) includes an immersion fluid 492. For example, when the objective lens 432 is an immersive objective lens, the illumination configuration includes an immersion fluid 492 (e.g., water, oil). In such cases, the emitters (e.g., emitters of the first set of emitters 480-1, 480-2, . . . 480-n and emitters of the second set of emitters 482-1, 482-2, . . . 482-m) are suspended or surrounded by the immersion fluid 492. In some embodiments, the illumination configuration does not include the immersion fluid 492. In some cases, alternatively or in addition to the immersion fluid, the emitters may be immersed and/or suspended in a solution layer, such as a reagent solution layer, adjacent to the top surface of the substrate.

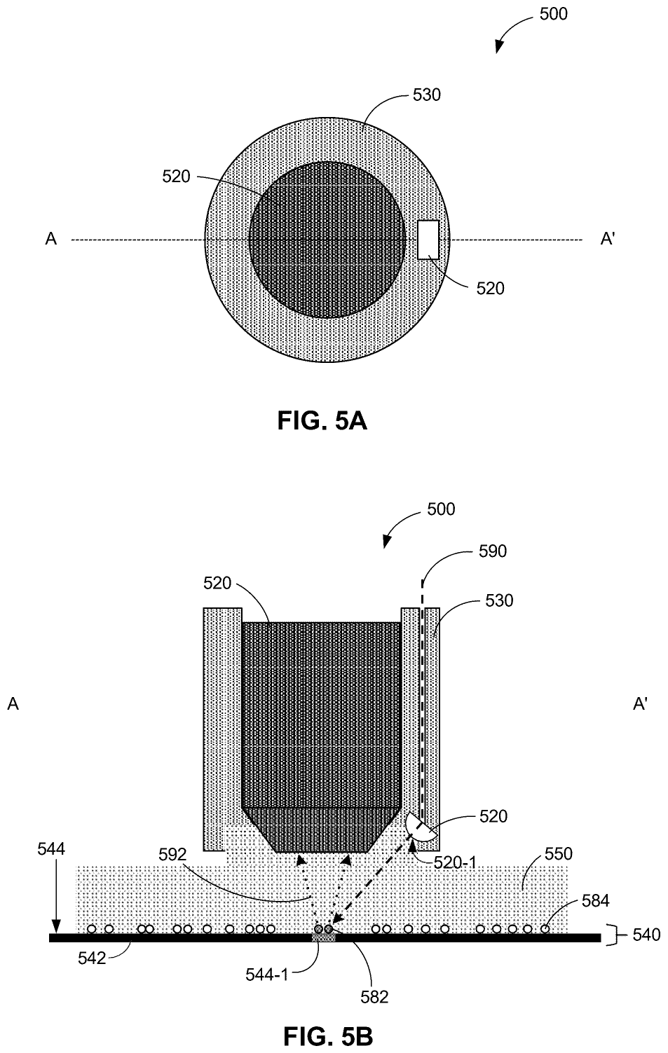

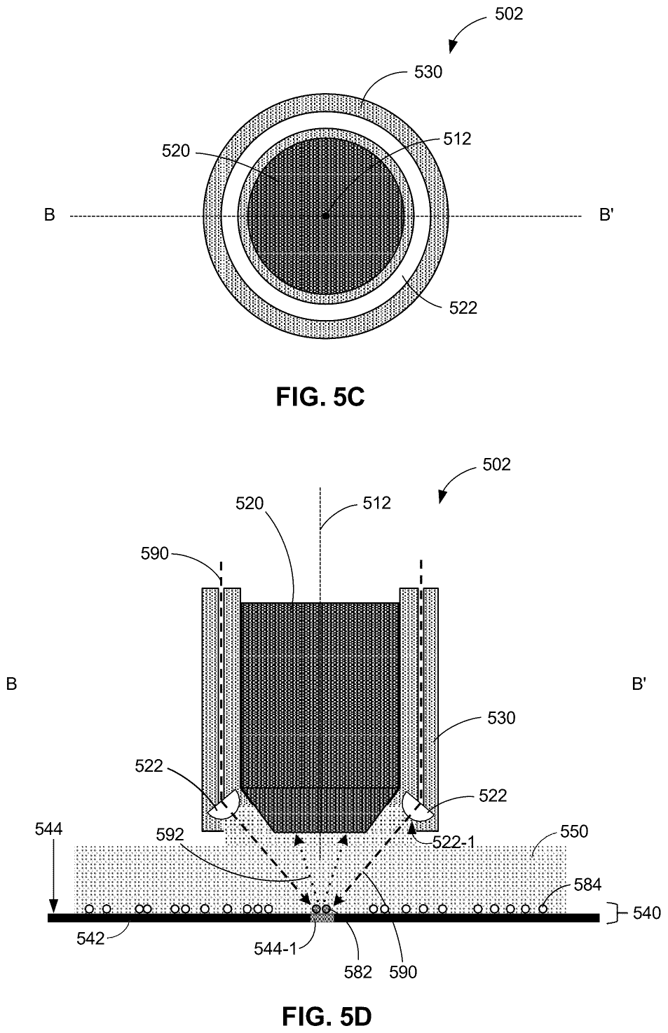

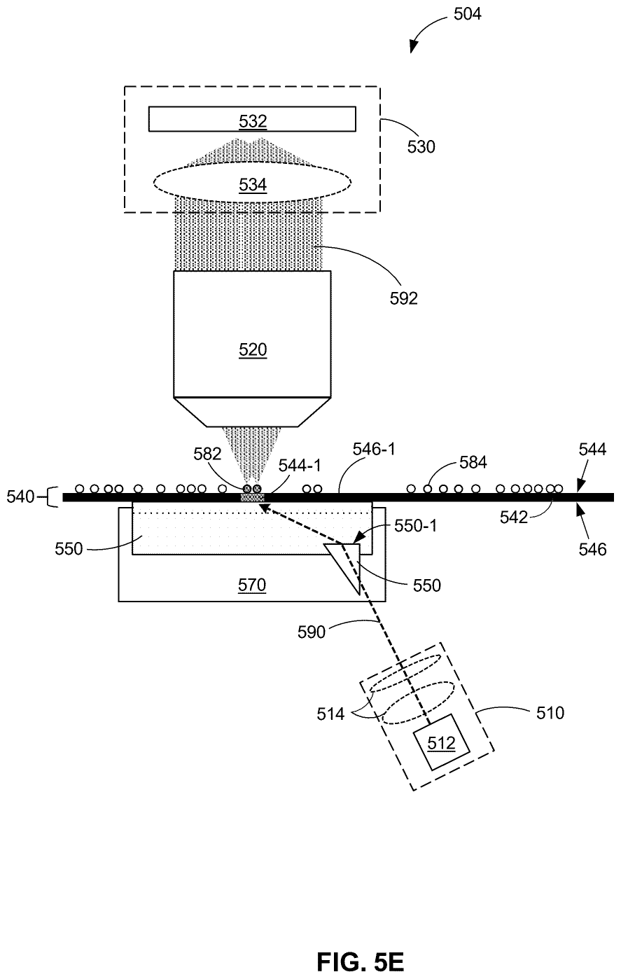

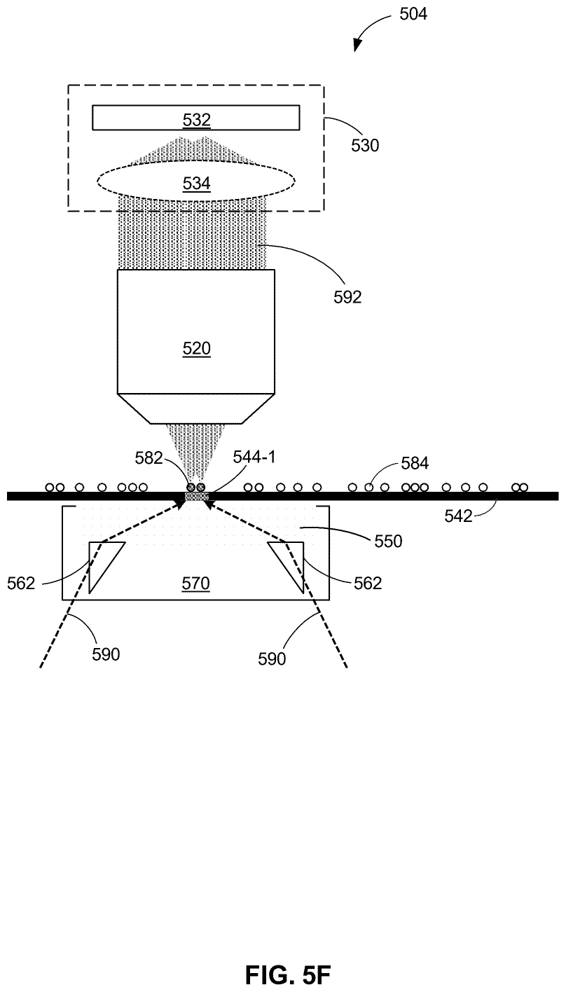

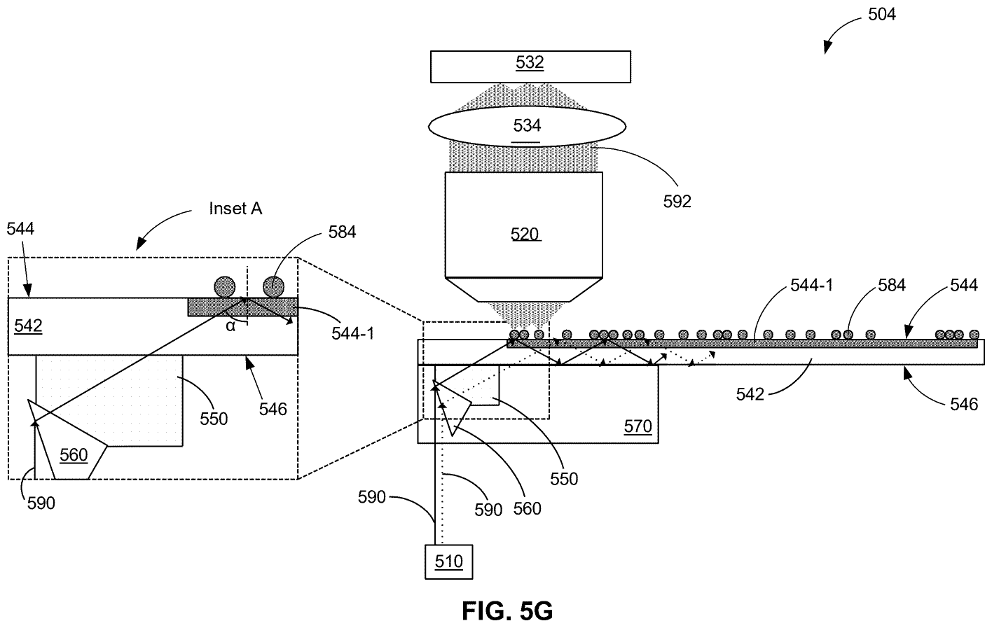

FIGS. 5A and 5B illustrate additional examples of illumination that bypasses an objective lens. FIG. 5A illustrates a top-down view of an example optical imaging system 500. The optical imaging system 500 includes an objective lens 520 and an optical component 520. The optical component 520 is configured to provide illumination light to a sample, and the objective lens 520 is configured to collect emission light output from the sample. In some cases, the optical component 520 is a prism. In some cases, the optical component 520 is a cylindrical lens. As shown in FIG. 5A, the optical component 520 is distinct and separate from the objective lens 520. In some cases, the optical imaging system 500 also includes an objective jacket 530 that is configured to house (e.g., support) the objective lens 520. In some cases, the objective jacket 530 is also configured to house (e.g., support) the optical component 520.

In some cases, optical imaging system 500 includes more than one optical component 520 (e.g., 2, 3, 4, 5, 6, or more optical components), where the more than one optical components are configured to provide illumination light to a sample. In some cases, the more than one optical components 520 are positioned at radial positions within the objective jacket 530. In some cases, the more than one optical components 520 are positioned at radial positions equidistance from each other within the objective jacket 530 (e.g., to provide multiple beams of illumination light to one or more portions of the surface 544). In some cases, the more than one optical components 520 provide illumination concurrently to a same portion 544-1 of the surface.

FIG. 5B illustrates a cross-sectional view of the optical imaging system 500 shown in FIG. 5A. The optical component 520 is configured to receive illumination light 590 and direct the illumination light 590 toward a sample 540 such that the illumination light 590 has an optical path that does not pass through the objective lens 520.

As shown in FIG. 5B, the objective lens 520 is configured to receive the emission light 592 output from the illuminated portion 544-1 of surface 544 the substrate 542 and transmit the emission light 592 to a detection module 530.

In some cases, the objective lens 520 is positioned adjacent to the surface 544 of the substrate 542. In some cases, the objective lens 520 is spaced apart from the surface 544 of the substrate 542 by a predetermined distance. For example, the objective lens 520 may be spaced apart from the surface 544 of the substrate 542 by a distance that is substantially similar to a focal distance of the objective lens 520.

In some cases, the optical component 520 is positioned adjacent to and spaced apart from the surface 544 of the substrate 542. In some cases, the optical component 520 includes a surface 520-1 that is adjacent to (e.g., facing, next to, on top of) the surface 544 of the substrate 542. For example, when the optical component 520 is a prism, the prism is positioned so that at least one of the facets of the prism is adjacent to (e.g., faces) the surface 544 of the substrate 542. In another example, when the optical component 520 is a cylindrical lens, the cylindrical lens is positioned so that a concave surface or a convex surface of the cylindrical lens is adjacent to (e.g., faces) the surface 544 of the substrate 542.

In some cases, at least a portion of the objective lens 520, at least a portion of the surface 520-1 of optical component 520 and at least a portion 544-1 of the surface 544 of the substrate 542 are immersed in an immersion fluid 550 that has an index of refraction that is different from the index of refraction of air. For example, when the objective lens 520 is an immersion lens, the objective lens 520 and at least a portion 544-1 of the surface 544 of the substrate 542 are immersed in an immersion fluid 550 such as oil, water, or a buffer solution.

In some cases, at least a portion of the objective lens 520 and at least a portion of the surface 520-1 of the optical component 520 are immersed in an immersion fluid 550 that has an index of refraction that is substantially the same (e.g., within +/−1%, +/−2%, +/−3%, +/−4%, +/−5%, +/−6%, +/−7%, +/−8%, +/−9%, +/−10%, +/−15%, or +/−20%) as an index of refraction of the substrate 542.

FIGS. 5C and 5D illustrate examples of illumination using a toroidal optical component. FIG. 5C illustrates a top-down view of an example optical imaging system 502. The optical imaging system 502 includes an objective lens 520 and a toroidal optical component 522. In some cases, the toroidal optical component 522 is a toroidal cylindrical lens 522 that is configured to provide illumination light to the sample 540. The toroidal optical component 522 is distinct and separate from the objective lens 520. In some cases, the optical imaging system 500 also includes an objective jacket 530 that is configured to house (e.g., support) the objective lens 520. In some cases, the objective jacket 530 is also configured to house (e.g., support) the toroidal optical component 522.

FIG. 5D illustrates a cross-sectional view of the optical imaging system 502. As shown, the toroidal optical component 522 (e.g., the toroidal cylindrical lens 522) surrounds the objective lens 520 in a radial direction that is perpendicular to an optical axis 512 of the objective lens 520.

The toroidal optical component 522 is configured to receive illumination light 590 from an illumination source, and the toroidal optical component 522 is configured to transmit (e.g., direct) the illumination light 590 toward a portion 544-1 of the surface 544 of the substrate 542. The optical path of the illumination light 590 does not pass through the objective lens 520. The objective lens 520 is configured to collect emission light 592 output from the sample 540 and transmit the emission light 592 output from the sample 540 toward a detection module 530.

In some cases, the toroidal optical component 522 is positioned adjacent to and spaced apart from the surface 544 of the substrate 542. In some cases, the toroidal optical component 522 includes a surface 522-1 that is adjacent to (e.g., faces) the surface 544 of the substrate 542. For example, the toroidal optical component 522 is positioned so that a concave surface or a convex surface of the toroidal optical component 522 is adjacent to (e.g., faces) the surface 544 of the substrate 542.

In some cases, at least a portion of the objective lens 520, at least a portion of the surface 520-1 of optical component 520 and at least a portion 544-1 of the surface 544 of the substrate 542 are immersed in an immersion fluid 550 that has an index of refraction that is different from the index of refraction of air. For example, when the objective lens 520 is an immersion lens, the objective lens 520 and at least a portion 544-1 of the surface 544 of the substrate 542 are immersed in an immersion fluid 550 such as oil, water, or a buffer solution.

In some cases, at least a portion of the objective lens 520 and at least a portion of the surface 520-1 of the optical component 520 are immersed in an immersion fluid 550 that has an index of refraction that is substantially the same (e.g., within +/−1%, +/−2%, +/−3%, +/−4%, +/−5%, +/−6%, +/−7%, +/−8%, +/−9%, +/−10%, +/−15%, or +/−20%) as the index of refraction of the substrate 542.

FIGS. 5E-5G illustrate examples of optical imaging systems with a bottom illumination scheme. FIG. 5E illustrates an example optical imaging system 504. The optical imaging system 504 includes an illumination module 510, an optical component 560, a fluid retention unit 570, an objective lens 520, and a detection module 530. The optical component 560 is configured to receive illumination light 590 output from the illumination module 510 and provide the illumination light 590 to the sample 540. The objective lens 520 is configured to collect emission light 592 output from the sample 540. The fluid retention unit 570 is configured to contain (e.g., hold) a fluid 550 in contact with a bottom surface 546 of a substrate 542 of the sample 540. In some cases, the fluid retention unit 570 is also configured to house the optical component 560. In some cases, the fluid 550 has a refractive index that is substantially the same (e.g., within +/−1%, +/−2%, +/−3%, +/−4%, +/−5%, +/−6%, +/−7%, +/−8%, +/−9%, +/−10%, +/−15%, or +/−20%) as the refractive index of the substrate 542. In some cases, the fluid 550 has refractive index that is substantially the same (e.g., within +/−1%, +/−2%, +/−3%, +/−4%, +/−5%, +/−6%, +/−7%, +/−8%, +/−9%, +/−10%, +/−15%, or +/−20%) as the refractive index of the optical component 560.

As shown in FIG. 5E, the optical component 560 receives illumination light 590 from the illumination module 510 and directs the illumination light 590 through the fluid 550 and toward the substrate 542. The illumination light 590 is incident on the bottom surface 546 of the substrate 542 and is transmitted through the bottom surface 546 of the substrate 542 before being incident upon the top surface 544 of the substrate 542 and illuminating at least a portion 544-1 of the top surface 544 of the substrate 542. In some cases, the portion 544-1 of the top surface 544 of the substrate 542 is illuminated through an evanescent wave of the illumination light 590 that is transmitted through the substrate 542 (e.g., illumination light 590 is reflected by the top surface 544 and the resulting evanescent wave propagates to illuminate emitters 582).

In some cases, the optical component 560 is positioned adjacent to and spaced apart from the bottom surface 546 of the substrate 542. In some cases, the optical component 560 includes a surface 560-1 that is adjacent to (e.g., faces) the surface 544 of the substrate 542. For example, when the optical component 560 is a prism, the prism is positioned so that at least one of the facets of the prism is adjacent to (e.g., faces) the surface 544 of the substrate 542. In another example, when the optical component 560 is a cylindrical lens, the cylindrical lens is positioned so that a concave surface or a convex surface of the cylindrical lens is adjacent to (e.g., faces) the surface 544 of the substrate 542. In some cases, at least a portion (e.g., the surface 560-1) of the optical component 560 and at least a portion 546-1 of the bottom surface 546 of the substrate 542 are immersed in the fluid 550 so that the fluid 550 is in contact with both the surface 560-1 of the optical component 560 and the portion 546-1 of the bottom surface 546 of the substrate 542.

In some cases, as shown in FIG. 5F, the optical component is a toroidal optical component 562 (similar to toroidal optical component 522 shown in FIGS. 5C and 5D). In some cases, the toroidal optical component 562 is configured to provide substantially symmetric illumination (e.g., provide illumination across all azimuthal angles of the substrate 542) of the portion 544-1 of the top surface 544 of the substrate 542.

FIG. 5G illustrates an implementation of the optical imaging system 504 shown in FIG. 5E where the illumination light 590 propagates through the substrate 542 via total internal reflection (also referred to herein as TIR). In some cases, as shown in inset A, the illumination light 590 is incident upon the top surface 544 of the substrate 542 at an angle α that is greater than a critical angle of the surface 544 interface (e.g., with air or with an immersion fluid such as oil, water, or a buffer solution). Thus, the illumination light 590 propagates through the substrate 542 until the illumination light 590 is absorbed by the one or more emitters 584 located on the surface 544 of the substrate 542 or is attenuated based on losses associated with the substrate 542 and its surfaces 544 and 546.

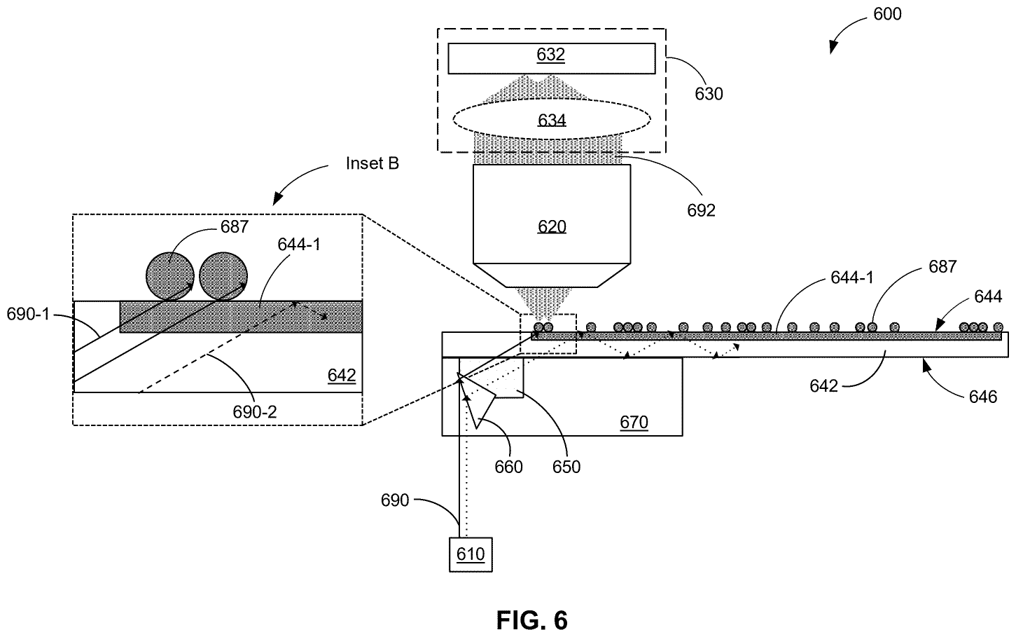

FIG. 6 illustrates an optical imaging system 600 for imaging a sample 640 that includes index-matched beads. The optical imaging system 600 includes an illumination module 610, an optical component 660, a fluid retention unit 670, an objective lens 620, and a detection module 630. The optical component 660 is configured to receive illumination light 690 from the illumination module 610 and provide the illumination light 690 to the sample 640. In some cases, the optical component 660 may be a toroidal optical component, such as toroidal optical component 562 shown in FIG. 5F. The objective lens 620 is configured to collect emission light 692 output from the sample 640.

As shown in FIG. 6, the optical component 660 receives illumination light 690 from the illumination module 610 and directs the illumination light 690 through the fluid 650 and toward the substrate 642. The illumination light 690 is incident on the bottom surface 646 of the substrate 642 and is transmitted through the bottom surface 646 of the substrate 642 before being incident upon the top surface 644 of the substrate 642 and illuminating at least a portion 644-1 of the top surface 644 of the substrate 642.

As shown in inset B, in some cases, the sample 640 includes one or more beads 687 disposed on the surface 644 of the substrate 642. In some cases, each bead of the one or more beads 687 has a refractive index that is substantially similar (e.g., within +/−1%, +/−2%, +/−3%, +/−4%, +/−5%, +/−6%, +/−7%, +/−8%, +/−9%, +/−10%, +/−15%, or +/−20%) to a refractive index of the substrate 642. Thus, when the illumination light is incident upon a portion of the surface 644 that includes a bead 687 (e.g., that has a bead 687 coupled to the portion of the surface 644), the illumination light is transmitted through the surface 644 of the substrate 642 and into the bead 687 (represented in inset B by light ray 690-1). When a portion of the illumination light 690 is incident upon a portion of the surface 644 that does not include a bead 687 (e.g., the portion of the surface 644 does not have a coupled bead 687), the illumination light 690 is reflected at the surface 644 of the substrate 642 via TIR and exits the substrate 642 via bottom surface 646. This serves to provide illumination light solely to beads 687 and can help to reduce background noise. In some cases, a bead 687 is coupled to an emitter 682. In some cases, a bead 687 is coupled to a plurality of emitters 682. In some cases, the emitters comprise labels coupled to nucleic acids.

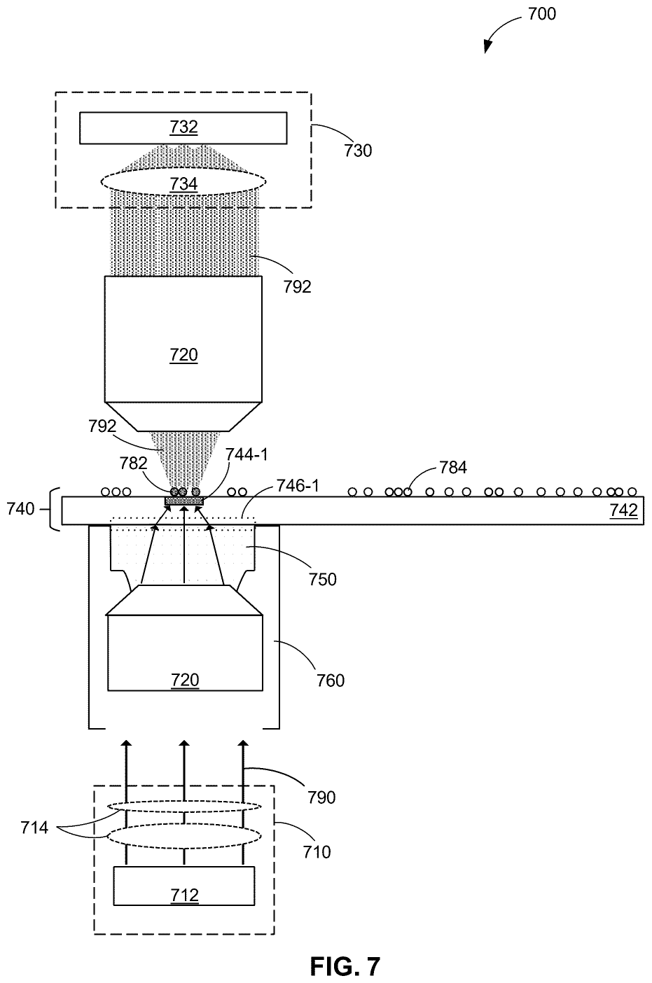

FIG. 7 illustrates an example optical imaging system 700. The optical imaging system 700 includes an illumination module 710 configured to output illumination light 790, an illumination objective lens 720 configured to transmit the illumination light 790 to a sample 740, a detection objective lens configured to receive emission light 792 output from the sample 740, and a detection module 730 configured to receive the illumination light 790 directed through the detection objective lens 720. In some cases, the optical imaging system 700 also includes an objective jacket 760 that is configured to house the illumination objective lens 720 and to contain (e.g., hold) a fluid 705 in contact with a bottom surface 746 of a substrate 742 of the sample 740. In some cases, the fluid 705 has a refractive index that is greater than a refractive index of the substrate 742. In some cases, at least a portion of the illumination objective lens 720 and at least a portion 746-1 of the bottom surface 746 of the substrate 742 are immersed in fluid 705.

In some cases, such as when the detection objective lens 720 is an immersion objective lens, the detection objective lens 720 and at least a portion 744-1 of the surface 744 of the substrate 742 are immersed in an immersion fluid 750 such as oil, water, or a buffer solution. In some cases, the detection objective lens 720 is positioned adjacent to the surface 744 of the substrate 742.

The illumination objective lens 720 is configured to receive illumination light 790 output from the illumination module 710 and direct the illumination light 790 through the fluid 705 and toward the substrate 742. The illumination light 790 is incident on the bottom surface 746 of the substrate 742 and is transmitted through (via refraction) the bottom surface 746 of the substrate 742 before being incident upon the top surface 744 of the substrate 742 and illuminating at least a portion 744-1 of the top surface 744 of the substrate 742. In some cases, a chief ray of the illumination light 790 is incident upon the bottom surface 746 of the substrate 742 at an angle that is larger than a critical angle at the interface of the substrate 742 (e.g., with between fluid 705 or air) so that the illumination light 790 propagates through the substrate 742 via TIR until the illumination light 790 is absorbed by the one or more emitters 784, or loses energy (e.g., is attenuated) through losses associated with the substrate 742 and its surfaces 744 and 746.

In some cases, the illumination objective lens 720 is positioned adjacent to the bottom surface 746 of the substrate 742. In some cases, the illumination objective lens 720 is positioned spaced apart from the bottom surface 746 of the substrate 742 by a distance that is substantially similar to a focal distance of the illumination objective lens 720.

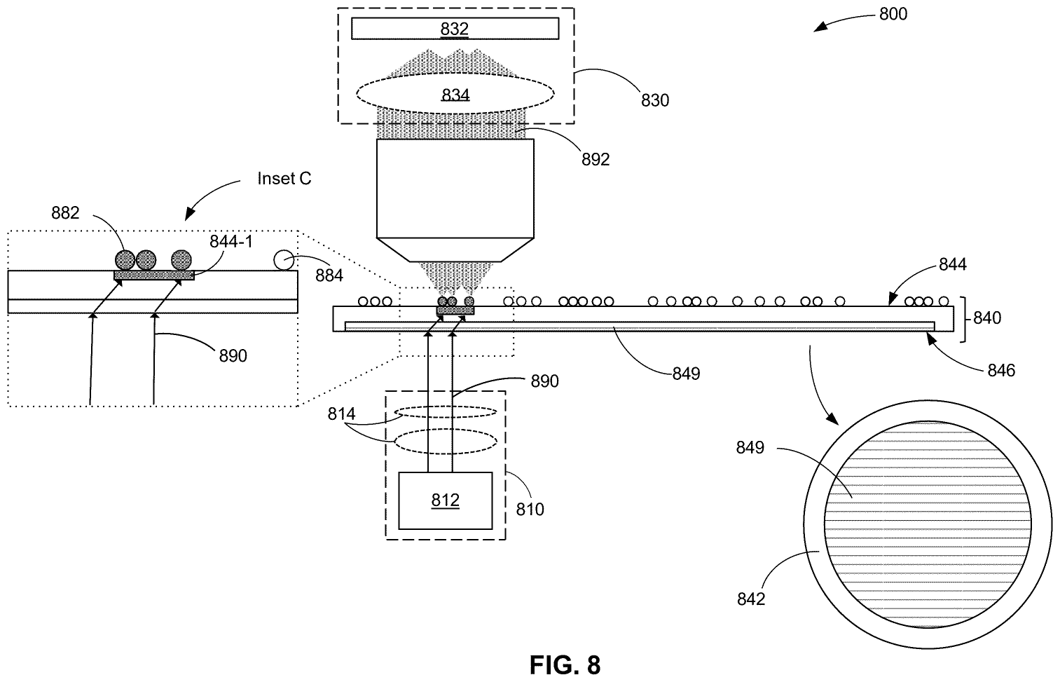

FIG. 8 illustrates an optical imaging system for illuminating a sample using a grating. The optical imaging system 800 is designed to image sample 840. The optical imaging system 800 includes an illumination module 810 configured to output illumination light 890, an objective lens 820 configured to transmit and/or direct emission light 892 output from the sample 840, and a detection module 830 configured to receive the emission light 892 output from the objective lens 820.

In some cases, as shown in FIG. 8, sample 840 includes a substantially planar substrate 842. In some cases, the substrate 842 has a substantially planar surface 844 (also referred to herein as top surface 844), and a bottom surface 846 that is substantially parallel to the top surface 844 (e.g., within +/−0.1 degrees, +/−0.2 degrees, +/−0.3 degrees, +/−0.4 degrees, +/−0.5 degrees, +/−1 degree). The substrate 842 also includes a grating 849 that is configured to receive illumination light 890 output from the illumination module 810 and to transmit the illumination light 890 through at least a portion of the substrate 842 so that the illumination light 890 illuminates (e.g., is incident on) a portion 844-1 of the top surface 844 of the substrate 842. In some cases, at least a portion (e.g., portion 844-1) of the substrate 842 is configured to output emission light 892 in response to receiving the illumination light 890. For example, the substrate 842 may include one or more emitters (e.g., emitters 882 and 884) on the top surface 844 that are configured to output emission light 892 in response to receiving the illumination light 890. For example, as shown in FIG. 8, emission light 892 is output from a first subset of emitters (e.g., including emitter 882) in response to receiving illumination light 890. In contrast, a second subset of emitters (e.g., including emitter 884), distinct from the first subset of emitters (e.g., including emitter 882), are not illuminated by illumination light 890 and thus, the second subset of emitters (e.g., including emitter 884) do not output emission light 892.

In some cases, the grating 849 includes one or more layers (e.g., one or more layers of semiconductor material) that are positioned (e.g., disposed) between the top surface 844 and the bottom surface 846 of the substrate 842. In some cases, the grating 849 is disposed adjacent to the bottom surface 846 of the substrate 842. In some cases, as shown in FIG. 8, the grating 849 is disposed on a portion, less than all, of the bottom surface 846 of the substrate 842. In some cases, the grating 849 is disposed on the entire bottom surface 846 of the substrate 842. In some cases, as shown in inset C, the grating 849 redirects the illumination light 890 so that a chief ray of the illumination light 890 is incident upon the grating 849 at a different angle than the angle at which a chief ray of the illumination light 890 is incident upon the first surface 844 of the substrate 842. In some cases, such as when the chief ray of the illumination light 890 that is incident upon the first surface 844 of the substrate 842 at an angle that is larger than a critical angle at an interface of the first surface (e.g., with an immersion fluid or air), the illumination light 890 may result in an evanescent wave that also illuminates emitters (e.g., emitter 882) and continue to propagate through the substrate 842 via TIR until the illumination light 890 is absorbed the one or more emitters or loses energy (e.g., is attenuated) through losses associated with the substrate 842 and its surfaces 844 and 846.

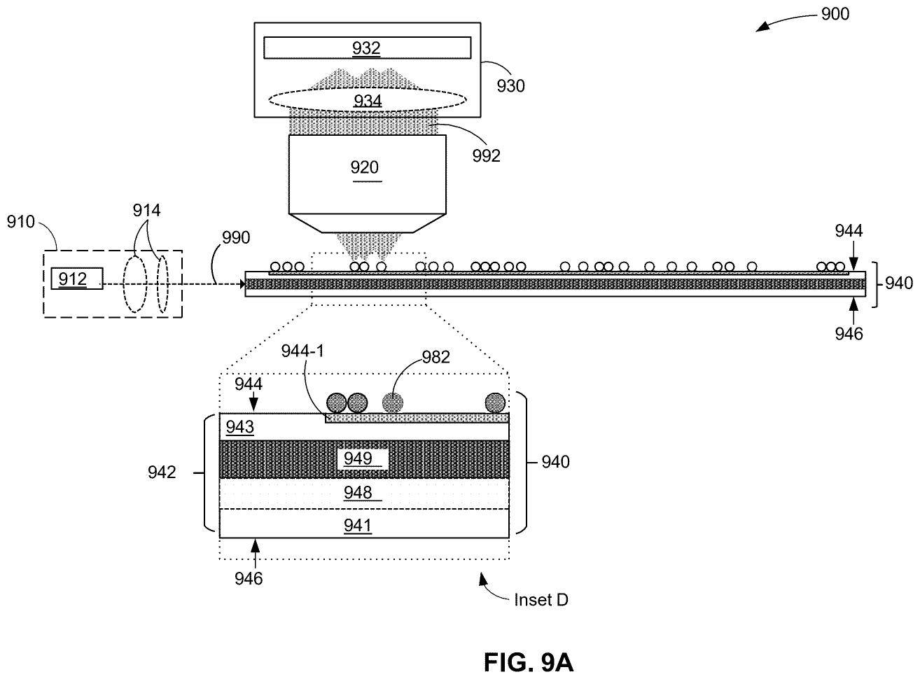

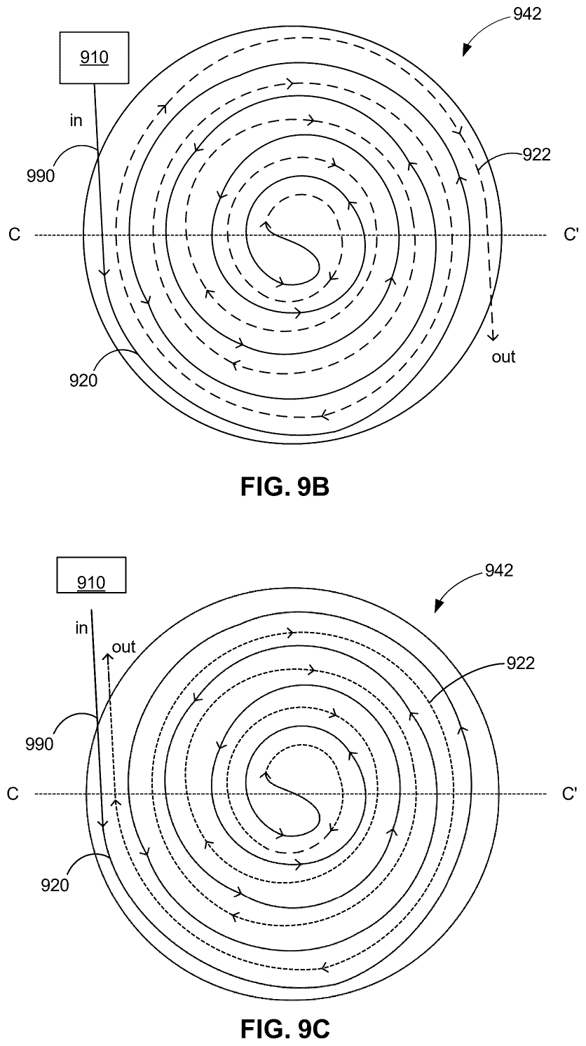

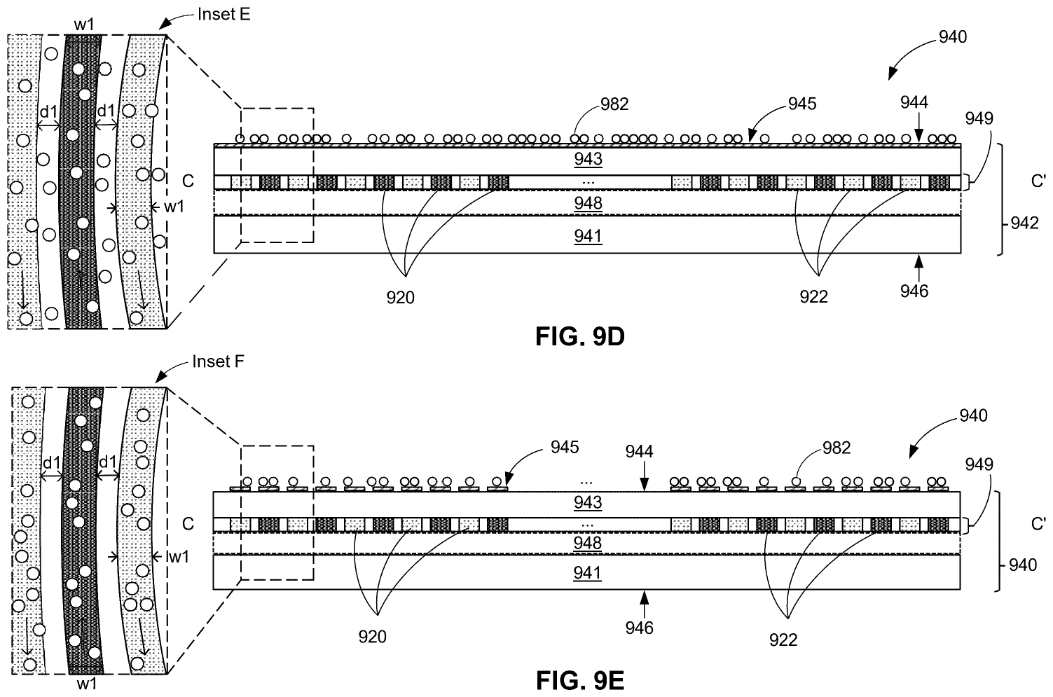

FIG. 9A illustrates an optical imaging system 900 for illuminating a sample using one or more waveguides. The optical imaging system 900 is designed to image sample 940. The optical imaging system 900 includes an illumination module 910 configured to output illumination light 990, an objective lens 920 configured to transmit and/or direct emission light 992 output from the sample 940, and a detection module 930 configured to receive the emission light 992 from the objective lens 920.

In some cases, as shown in inset D, a sample 940 includes a substantially planar substrate 942. In some cases, the substrate 942 has a substantially planar surface 944 (also referred to herein as top surface 944), and a bottom surface 946 that is substantially parallel to the top surface 944 (e.g., within +/−0.1 degrees, +/−0.2 degrees, +/−0.3 degrees, +/−0.4 degrees, +/−0.5 degrees, +/−1 degree). The substrate 942 also includes a waveguide layer 949 (e.g., guiding layer, core layer) that includes one or more waveguides. For example, a waveguide of the one or more waveguide can be any of, and not limited to: a slab waveguide, a rectangular waveguides, a circular waveguide, and an optical fiber. The one or more waveguides of the waveguide layer 949 are configured to receive illumination light 990 output from the illumination module 910 and transmit the illumination light 990 through at least a portion of the substrate 942 so that the illumination light 990 illuminates at least a portion 944-1 of the top surface 944 of the substrate 942. In some cases, the portion 944-1 of the top surface 944 of the substrate 942 is illuminated through an evanescent wave of the illumination light 990 that is propagating through the one or more waveguides in the waveguide layer 949. In some cases, at least a portion (e.g., portion 944-1) of the substrate 942 is configured to output emission light 992 in response to receiving the illumination light 990 (e.g., being illuminated by an evanescent wave of the illumination light 990). For example, the substrate 942 may include one or more emitters 982 on the top surface 944 that are configured to output emission light 992 in response to receiving illumination light 990 (e.g., being illuminated by an evanescent wave of the illumination light 990). For example, emission light 992 is output from emitters 982 that are illuminated by the illumination light 990 (or an evanescent wave of the illumination light 990). In contrast, emitters that are not illuminated by illumination light 990 do not output emission light 992. In some cases, the substrate 942 includes a base layer 941 that is disposed (e.g., positioned) between the bottom surface 946 of the substrate 942 and the waveguide layer 949. For example, the base layer 941, for example, may be a silicon layer, such as a silicon wafer. In some cases, the substrate 942 includes an insulation layer 948 that is disposed (e.g., positioned) between the bottom surface 946 of the substrate 942 and the waveguide layer 949. For example, the insulation layer 948, may be an oxide layer, such as a silicon oxide layer. When the substrate 942 includes an insulation layer 948, the base layer 941 is disposed (e.g., positioned) between the bottom surface 946 of the substrate 942 and the insulation layer 948. In some cases, the substrate 942 includes a cladding layer 943 that is disposed (e.g., positioned) between the top surface 944 of the substrate 942 and the waveguide layer 949.

In some cases, the waveguide layer 949 has a predetermined thickness that is configured to allow certain optical modes of the illumination light 990 to propagate within the one or more waveguides. For example, the one or more waveguides may have dimensions (width and height) that allow only the fundamental mode (e.g., TEM00) of the illumination light 990 to propagate through the one or more waveguides. In another example, the one or more waveguides may have dimensions (width and height) that allow higher order modes or multiple modes of the illumination light 990 to propagate through the one or more waveguides. The waveguide layer 949 has a thickness that is at least equal to (e.g., equal to or greater than) the height of the one or more waveguides.

In some cases, the cladding layer 943 has a predetermined thickness that allows at least a portion of the evanescent wave of the illumination light 990 that propagates through the one or more waveguides of the waveguide layer 949 to illuminate at least a portion 941-1 of the first surface 944 of the substrate 942. The various layers of the substrate 942, as shown in inset D, are not illustrated to scale. Each of the layers of the substrate 942 (e.g., the base layer 941, the insulating layer 948, the waveguide layer 949, and the cladding layer 943) may have a thickness that is different from or similar to another layer within the substrate 942.

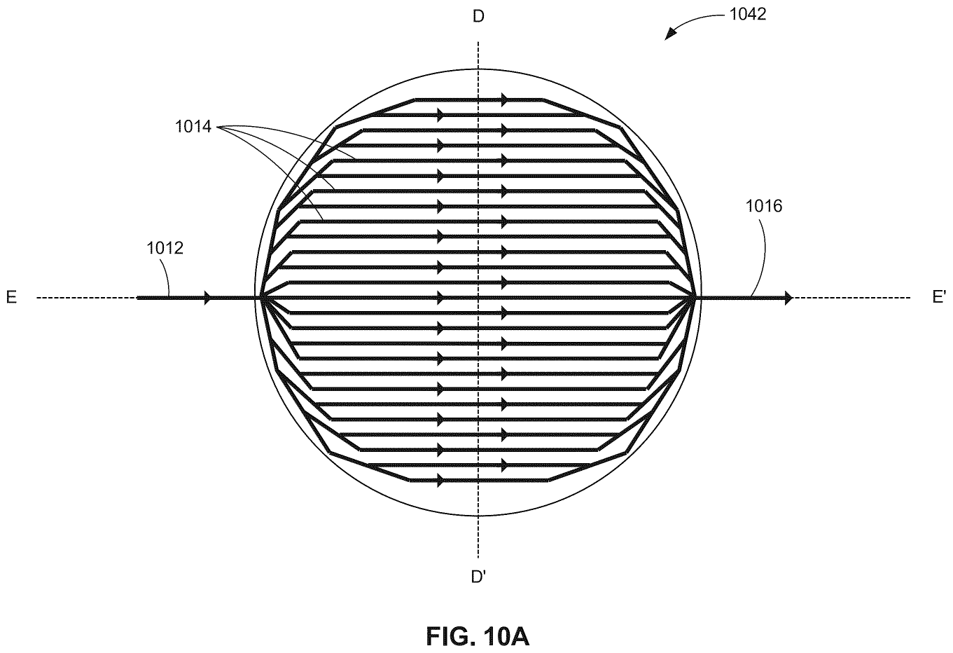

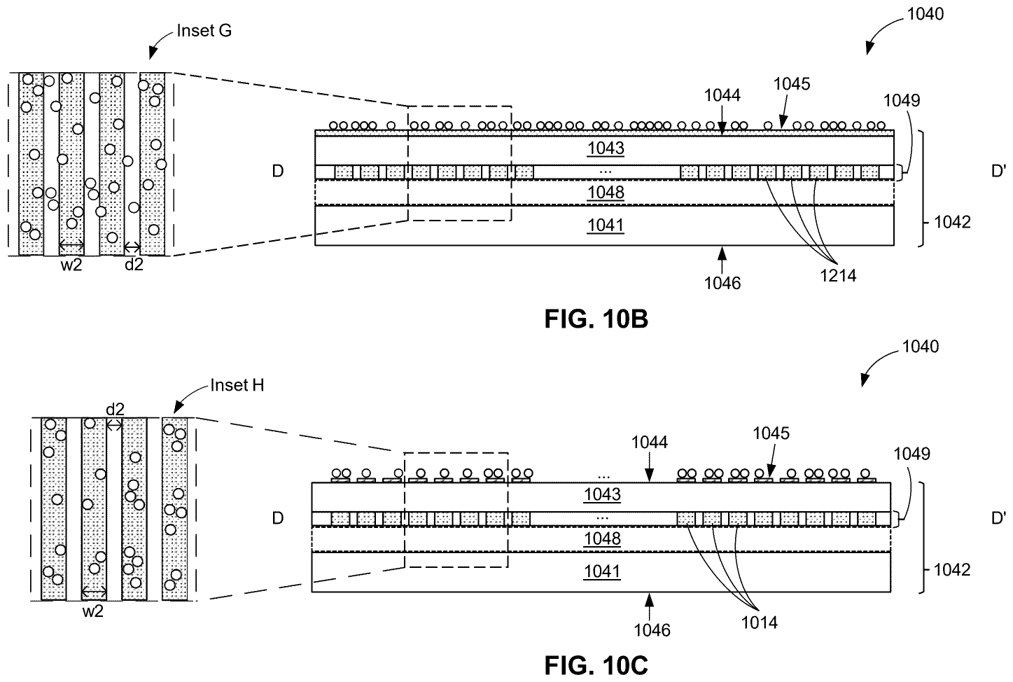

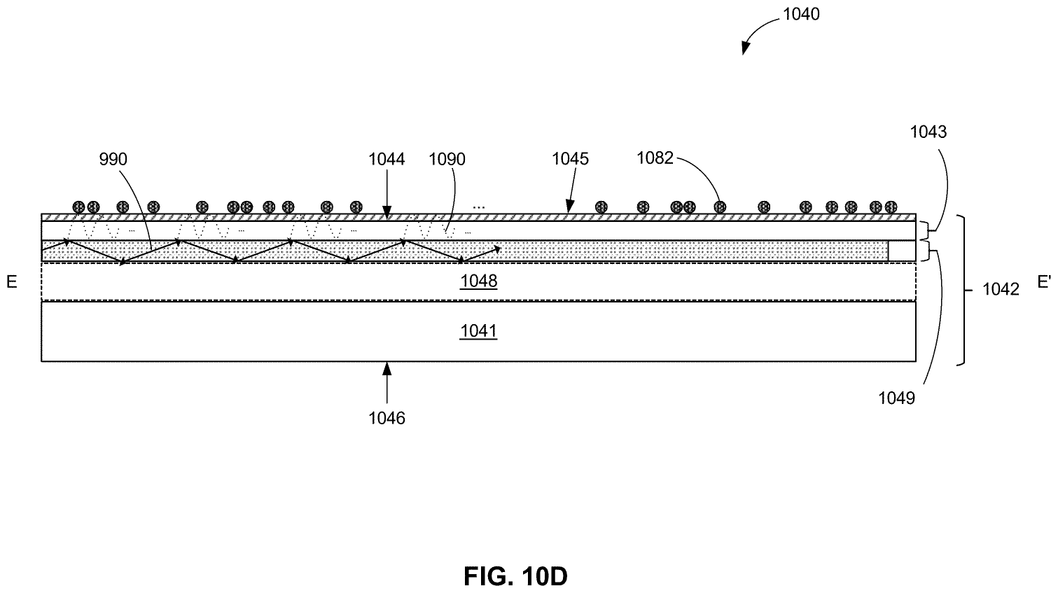

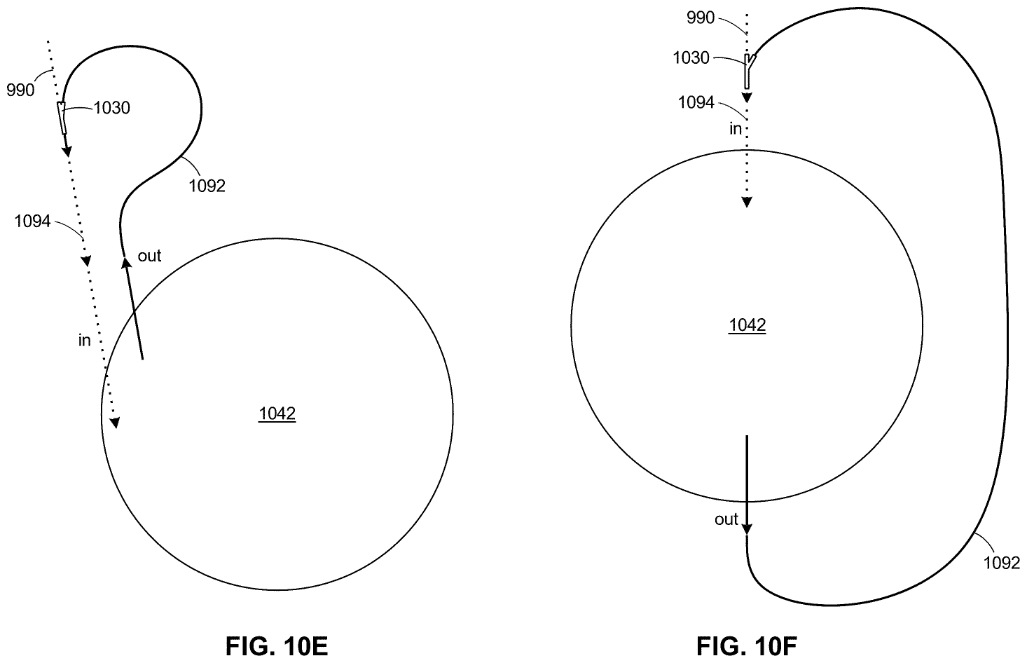

FIGS. 9B-9E and 10A-10D illustrate details regarding the sample and the one or more waveguides described in FIG. 9A. FIGS. 9B and 9C illustrate examples of spiral waveguide patterns in the waveguide layer 949 of the substrate 942. As shown in both FIGS. 9B and 9C, the one or more waveguides include a first waveguide 920 (shown in FIGS. 9B and 9C as solid lines with arrows pointing in the direction of light propagation) that has a first plurality of spiral rounds that spiral inward (in concentric circles that gradually decrease in radii) toward a center of the substrate 942. The one or more waveguides also include a second waveguide 922 that has a second plurality of spiral rounds (shown in FIGS. 9B and 9C as dashed lines) that spiral outward (in concentric circles that gradually increase in radii with arrows pointing in the direction of light propagation) outward from a center of the substrate 942. In some cases, as shown in FIG. 9A, the illumination light 990 enters the one or more waveguides of the substrate 942 at a different location on the substrate 942 (e.g., separated on the substrate 942 by at least any of 30 degrees, 40 degrees, 45 degrees, 90 degrees, 120 degrees, 160 degrees in an azimuthal direction) than an exit location on the substrate 942. In some cases, as shown in FIG. 9B, the illumination light 990 enters and exits the one or more waveguides of the substrate 942 at a substantially similar location on substrate 942 (e.g., the illumination light 990 enters the one or more waveguides at a position on the substrate 942 that is within any of +/−1 mm, +/−5 mm, +/−10 mm, +/−15 mm, +/−20 mm, +/−25 mm, +/−30 mm, +/−40 mm, +/−50 mm, +/−100 mm, and +/−200 mm of a position at which the illumination light 990 exits the one or more waveguides) (e.g., separated on the substrate 942 by no more than any of 30 degrees, 25 degrees, 20 degrees, 15 degrees, 10 degrees, 5 degrees in an azimuthal direction).

FIGS. 9D and 9E illustrate a cross-sectional view of substrate 942 shown in FIG. 9A and FIG. 9B. Insets E and F of FIGS. 9D and 9E, respectively, represent top-down views of surface 944 of substrate 942. In some cases, as shown in inset E of FIG. 9D and inset F of FIG. 9E, the one or more waveguides have a predetermined width w1 that is configured to allow certain optical modes of the illumination light 990 to propagate within the one or more waveguides. For example, a waveguide of the one or more waveguides may have a width w1 that is configured to allow only the fundamental mode (e.g., TEM00) of the illumination light 990 to propagate through the one or more waveguides. In another example, a waveguide of the one or more waveguides may have a width w1 that is configured to allow higher order modes or multiple modes of the illumination light 990 to propagate through the one or more waveguides. In some cases, as shown, the first waveguide 920 (e.g., the first plurality of spiral rounds, inward spiraling waveguide) and the second waveguide 922 (e.g., the second plurality of spiral rounds, outward spiraling waveguide) have a substantially same width (e.g., within a manufacturing tolerance, for example, having a width difference that is at most +/−1%, +/−2%, +/−3%, +/−4%, +/−5%, or +/−10%).

In some cases, as shown in inset E of FIG. 9D and inset F of FIG. 9E, the one or more waveguides of the waveguide layer 949 are spaced apart from each other by a predetermined distance d1 that does not allow illumination light 990 propagating in a waveguide of the one or more waveguides to be coupled into an adjacent waveguide. In some cases, the one or more waveguides of the waveguide layer 949 are spaced apart from each other by a predetermined distance d1 that allows illumination light 990 propagating in a waveguide of the one or more waveguides to be coupled into an adjacent waveguide.

In some cases, as shown in FIGS. 9D and 9E, the substrate 942 includes a coupling layer 945 that is configured to attach (e.g., bind) the one or more emitters 982 onto the top surface 944 of the substrate 942. When the coupling layer 945 is included, the coupling layer 945 is disposed (e.g., positioned, located) adjacent to (e.g., on top of, in contact with) the top surface 944 of the substrate 942. In some cases, the coupling layer 945 includes a layer of (3-Aminopropyl) trimethoxysilane (also referred to herein as APTMS). In some cases, the coupling layer 945 includes a single molecule layer of APTMS.

In some cases, a coupling layer 945 may comprise a distinct surface chemistry. In some cases, a surface chemistry may have a first affinity towards an object (e.g., a bead comprising nucleic acid molecules, e.g., amplicons, immobilized thereto), where the object comprises a sample to be imaged. In some cases, a surface chemistry may comprise a silane (e.g., tetramethylsilane). In some cases, the surface chemistry may comprise hexamethyldisilazane (HMDS). In some cases, the surface chemistry may comprise APTMS. In some cases, the surface chemistry may comprise a surface primer molecule or any oligonucleotide molecule that has any degree of affinity towards another molecule (e.g., a biological sample to be imaged).

In some cases, as shown in FIG. 9D, the coupling layer 945 is unpatterned so that APTMS encompasses (e.g., covers, is present on) at least a majority of the top surface 944 of the substrate 942. In some cases, APTMS encompasses (e.g., covers, is present on) a portion of the top surface 944 of the substrate 942 that is configured for imaging. In such a case, emitters of the one or more emitters 982 may be coupled to the surface 944 of the substrate 942 at portions of the substrate comprising APTMS (or another surface chemistry configured to bind to emitters). For example, as illustrated in Inset E, the locations of emitters 982 that are coupled to the surface do not correspond to the arrangement of waveguides (e.g., individually addressable locations comprising coupled emitters may be unpatterned).

In some cases, as shown in FIG. 9E, the coupling layer 945 is patterned on the top surface 944 of the substrate 942 so that at least a portion of the top surface 944 of the substrate 942 (e.g., at least a portion of the top surface 944 that is imaged by the optical imaging system 900) does not include APTMS. For example, the surface 944 may include the APTMS on portions that correspond to (e.g., are directly on top of, are aligned with) portions of the substrate that include a waveguide of the one or more waveguides. Since the APTMS is configured to couple (e.g., bind) emitters of the one or more emitters 982 to the surface 944 of the substrate 942, a substrate 942 that includes a patterned coupling layer 945 will include emitters only on portions of the surface 944 that have ATPMS. That is, the portion of the surface 944 that comprise APTMS and bind emitters may be individually addressable locations. For example, as shown in inset F, the substrate 942 includes a patterned coupling layer 945 that includes APTMS on portions of the surface 944 that correspond to portions of the substrate 942 that include a waveguide (or a portion of a waveguide). Thus, the majority of emitters 982 (e.g., at least any of 70%, 75%, 80%, 85%, 90%, 95%, 96%, 97%, 98%, and 99%) are located at a position on the surface 944 that is on top of a waveguide of the one or more waveguides. In contrast, the emitters 982 shown in inset E of FIG. 9D, which are on a substrate 942 that has an unpatterned layer of coupling layer 945, are located across portions of the surface 944 that include APTMS, including portions of the surface 944 that are directly above a waveguide (or a portion of a waveguide) and portions of the surface 944 that are no directly above a waveguide (or a portion of a waveguide).

In some cases the coupling layer may comprise a surface chemistry with a first affinity towards an object (e.g., a bead comprising nucleic acid molecules, e.g., amplicons, immobilized thereto), and regions of the surface 944 that do not comprise the coupling layer (e.g., regions that are not directly above a waveguide) may comprise a surface chemistry with a second affinity towards the object, where the second affinity is greater than the first affinity. In such cases, emitters may preferentially be coupled to regions of the surface 944 that do not comprise the coupling layer (e.g., emitters may be located on regions of the surface that are not directly over waveguides).

FIG. 10A illustrates an example of the one or more waveguides in the waveguide layer 1049 of the substrate 1042. In some cases, as shown in FIG. 10A, the one or more waveguides include an input waveguide 1012, a plurality of waveguides 1014, and an output waveguide 1016. The input waveguide 1012 is configured to receive light (e.g., receive illumination light 990 from an illumination module 910, described above with respect to FIG. 9A) and transmit the light toward the plurality of waveguides 1014. The plurality of waveguides 1014 are configured to receive light from the input waveguide 1012 and transmit the light from the input waveguide 1012 toward the output waveguide 1016. In some cases, the plurality of waveguides 1014 are configured to illuminate a large (e.g., a majority greater than any of 50%, 60%, 70%, 80%, 90%, and 95%) area of the surface 1044 of the substrate 1042. In some cases, the plurality of waveguides 1014 are configured to illuminate a portion 1041-1 of the surface 1044 of the substrate 1042 that is imaged by the optical imaging system 1000.

FIGS. 10B and 10C illustrate a cross-sectional view of substrate 1042, shown in FIG. 10A. Insets G and H of FIGS. 10B and 10C, respectively, represent top-down views of surface 1044 of substrate 1042. In some cases, as shown in inset G of FIG. 10B and inset H of FIG. 10C, waveguides of the plurality of waveguides 1014 have a predetermined width w2 that is configured to allow certain optical modes of the illumination light 990 to propagate within the plurality of waveguides 1014. For example, waveguides of the plurality of waveguides 1014 may have a width w2 that is configured to allow only the fundamental mode (e.g., TEM00) of the illumination light 990 to propagate through the plurality of waveguides 1014. In another example, waveguides of the plurality of waveguides 1014 may have a width w2 that is configured to allow higher order modes or multiple modes of the illumination light 990 to propagate through the plurality of waveguides 1014. In some cases, as shown, waveguides of the plurality of waveguides 1014, have a substantially same width w2 (e.g., within a manufacturing tolerance, for example, having a width difference that is no greater than any of +/−1%, +/−2%, +/−3%, +/−4%, +/−5%, and +/−10%).

In some cases, as shown in inset G of FIG. 10B and inset H of FIG. 10C, waveguides of the plurality of waveguides 1014 are spaced apart from each other by a predetermined distance d2 that does not allow illumination light 990 propagating in a waveguide of the plurality of waveguides 1014 to be coupled into an adjacent waveguide. In some cases, the waveguides of the plurality of waveguides 1014 are spaced apart from each other by a predetermined distance d2 that allows illumination light 990 propagating in a waveguide of the plurality of waveguides 1014 to be coupled into an adjacent waveguide.

In some cases, as shown in FIGS. 10B and 10C, the substrate 1042 includes a coupling layer 1045 that is configured to attach (e.g., bind) the one or more emitters 1082 onto the top surface 1044 of the substrate 1042. Details regarding the coupling layer 1045 are provided above with respect to FIGS. 9D and 9E (see e.g., description of coupling layer 945) and are not repeated here for brevity. FIG. 10B illustrates an example where the coupling layer 1045 is unpatterned, details of which are described above with respect to FIG. 9D and are not repeated here for brevity. FIG. 10C illustrates an example where the coupling layer 1045 is patterned, details of which are described above with respect to FIG. 9E and are not repeated here for brevity.

FIG. 10D illustrates a cross-sectional view of the substrate 1042 shown in FIG. 10A. This cross-sectional view follows along a propagation direction of light (e.g., illumination light 990, as) in the plurality of waveguides 1014. As shown, a waveguide of the plurality of waveguides 1014 allows the illumination light 690 to propagate through the substrate 1042 and illuminate portions of the surface 1044 of the substrate 1042. In some cases, as shown, the surface 1044 is illuminated via an evanescent wave 1090 of the illumination light 990, e.g., as described with respect to FIG. 9A. In some cases, the cladding layer 1043 has a predetermined thickness that allows at least a portion of the evanescent wave 1090 of the illumination light 990 to illuminate portions of the surface 1044.

FIGS. 10E and 10F illustrate examples of recycling light back into the one or more waveguides of a substrate (e.g., substrate 10442 of sample 1040) described in FIGS. 9A-9E and 10A-10D. As shown FIGS. 10E and 10F, light 1094 exiting the substrate (e.g., through an output waveguide) can be coupled back into the substrate 1042 (e.g., recycled or coupled back into the one or more waveguides of the waveguide layer 1049) via a coupler 1030 that is configured to combine light propagating in two different waveguides (e.g., slab waveguides, rectangular waveguides, circular waveguides, optical fibers) into a single waveguide. In this example, illumination light 990 (see e.g., FIG. 9A) is transmitted through the coupler 1030 before being received at the one or more waveguides. The coupler outputs light 1094 (which includes illumination light 690) to the one or more waveguides of the substrate 1042. As light 1094 propagates through the one or more waveguides of the substrate 1042, a non-zero amount of the light is lost (e.g., via absorption by the emitters 1082). In some cases, not all of the light 1094 is absorbed or lost during propagation within the one or more waveguides, and a portion of the light 1094 exits the one or more waveguides of the substrate 1042 as leftover light 1092. The leftover light 1092 is transmitted (e.g., guided, directed) through a waveguide (e.g., slab waveguides, rectangular waveguides, circular waveguides, optical fibers) that is coupled to the coupler 1030. The coupler 1030 receives the leftover light 1092 and combines the leftover light 1092 with illumination light 690 that is also received at the coupler 1030 to provide the one or more waveguides of the substrate 1042 with light 1094.

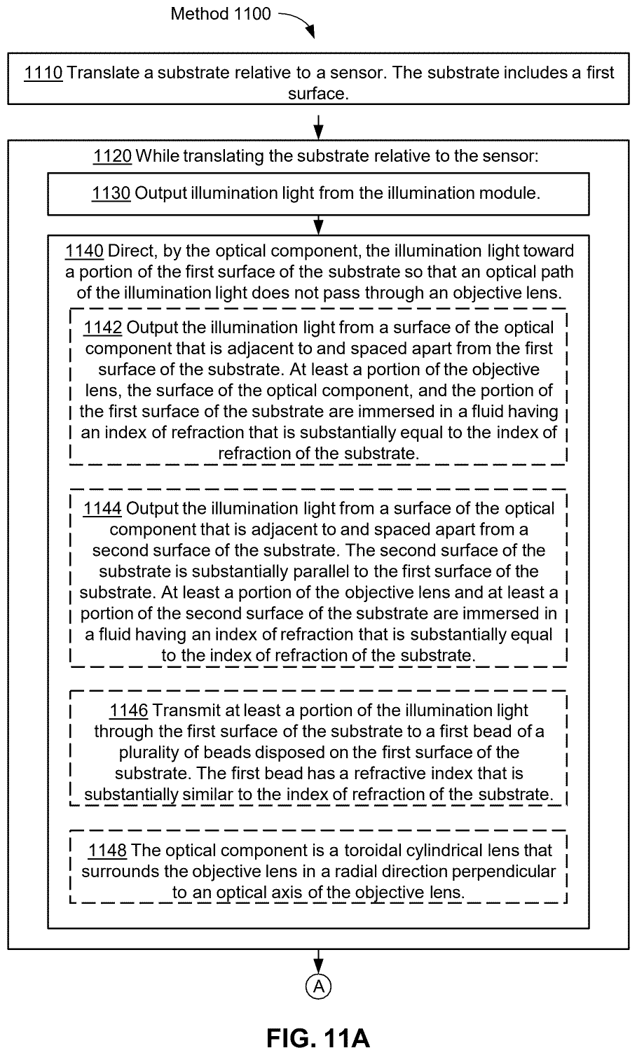

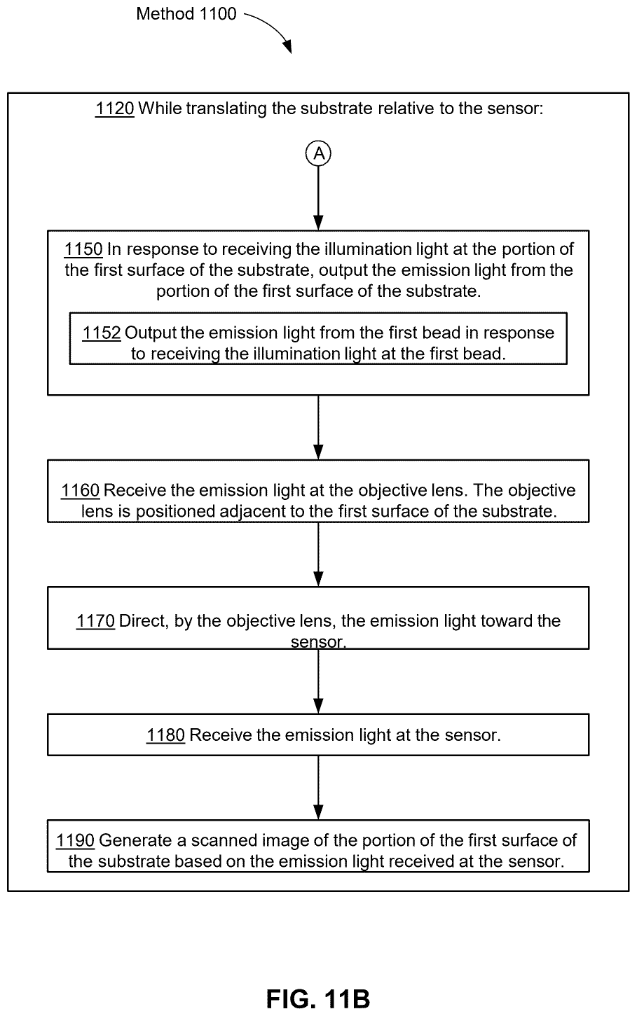

FIGS. 11A and 11B illustrate a method 1100 of providing illumination in an optical imaging system. The method is performed at an optical system (e.g., any of the optical imaging systems 500, 502, 504, or 600) that includes an illumination module (e.g., 510 as in FIGS. 5E and 5G and 610 as in FIG. 6), an objective lens (e.g., 520 or 620), an optical component 660 or the toroidal optical component 562, and a sensor (e.g., a sensor of the one or more sensors 532 or 632) that is configured for time delay integration imaging. The method 1100 includes (step 1110) translating a substrate (e.g., the substrate 542 or 642) relative to a sensor 532 or 632. The substrate has a first surface (e.g., the top surface 544 or 644). The method 1100 also includes, (step 1120) while translating the substrate relative to the sensor: outputting (step 1130) illumination light (e.g., 590 or 690) from the illumination module (e.g., 510 or 610) and directing (step 1140), by the optical component 560 or the toroidal optical component 562, the illumination light toward a portion (e.g., 544-1 or 644-1) of the first surface of the substrate so that the optical path of the illumination light does not pass through the objective lens. The method 1100 also includes, (step 1120) while translating the substrate relative to the sensor: outputting (step 1150) emission light (e.g., 592 or 692) from the portion of the first surface of the substrate in response to receiving the illumination light at the portion of the first surface of the substrate, and receiving (step 1160) the emission light at the objective lens. The objective lens is positioned adjacent to the first surface of the substrate. The method 1100 also includes, (step 1120) while translating the substrate relative to the sensor: directing (step 1170), by the objective lens, the emission light toward the sensor; receiving (step 1180) the emission light at the sensor; and generating (step 1190) a scanned image of the portion of the first surface of the substrate based on the emission light received at the sensor.

In some cases, directing (step 1140) the illumination light (e.g., 590 or 690) toward a portion (e.g., 544-1 or 644-1) of the first surface (e.g., 544 or 644) of the substrate (e.g., 542 or 642) by the optical component (e.g., objective lens 520 or 620) or the toroidal optical component (e.g., 522) includes (step 1142) outputting the illumination light (e.g., 690) from a surface of the optical component (e.g., the surface 520-1 of the optical component 520 or the surface 522-1 of the toroidal optical component 522) that is adjacent to and spaced apart from the first surface of the substrate. At least a portion of the objective lens, the surface of the optical component (e.g., the surface 520-1 of the optical component 520 or the surface 522-1 of the toroidal optical component 522), and the portion of the first surface of the substrate are immersed in a fluid (e.g., immersion fluid 550 or 650), which has an index of refraction that is substantially similar to (e.g., within +/−1%, +/−2%, +/−3%, +/−4%, +/−5%, +/−6%, +/−7%, +/−8%, +/−9%, +/−10%, +/−15%, or +/−20%) to the index of refraction of the substrate.

In some cases, the substrate (e.g., 542 or 642) further includes a second surface (e.g., 546 or 646) that is substantially parallel to the first surface (e.g., 544 or 644) (e.g., within +/−0.1 degrees, +/−0.2 degrees, +/−0.3 degrees, +/−0.4 degrees, +/−0.5 degrees, +/−1 degree), and directing (step 1140) the illumination light (e.g., 590 or 690) toward a portion (e.g., 544-1 or 644-1) of the first surface of the substrate by the optical component (e.g., the optical component 520 or 620 or the toroidal optical component 522) includes (step 1144) outputting the illumination light from a surface of the optical component (e.g., the surface 520-1 of the optical component 520 or the surface 522-1 of the toroidal optical component 522) that is adjacent to and spaced apart from the second surface of the substrate. At least a portion of the surface of the optical component (e.g., the surface 520-1 of the optical component 520 or the surface 522-1 of the toroidal optical component 522) and at least a portion (e.g., 546-1 or 646-1) of the second surface of the substrate are immersed in a fluid (e.g., 550) that has an index of refraction that is substantially similar to (e.g., within +/−1%, +/−2%, +/−3%, +/−4%, +/−5%, +/−6%, +/−7%, +/−8%, +/−9%, +/−10%, +/−15%, or +/−20%) the index of refraction of the substrate.

In some cases, the substrate (e.g., 542 or 642) further includes a plurality of beads (e.g., one or more beads 584 or 687) that are disposed on the first surface (e.g., 544 or 644). A first bead of the plurality of beads is positioned on the portion (e.g., 544-1 or 644-1) of the first surface of the substrate, and the first bead has an index of refraction that is substantially similar to (e.g., within +/−1%, +/−2%, +/−3%, +/−4%, +/−5%, +/−6%, +/−7%, +/−8%, +/−9%, +/−10%, +/−15%, or +/−20%) the index of refraction of the substrate. In such cases, directing (step 1140) the illumination light (e.g., 590 or 690) toward the portion of the first surface of the substrate by the optical component (e.g., the optical component 520 or the toroidal optical component 522) includes (step 1146) transmitting at least a portion of the illumination light through the first surface of the substrate and to the first bead.

In some cases, outputting (step 1150) emission light (e.g., 592 or 692) from the portion (e.g., 544-1 or 644-1) of the first surface (e.g., 544 or 644) of the substrate (e.g., 542 or 642) includes (step 1152) outputting the emission light from the first bead (e.g., 584 or 687) in response to receiving the illumination light (e.g., 590 or 690) at the first bead.

In some cases, the optical component is (1148) a toroidal cylindrical lens (e.g., toroidal cylindrical lens 522) that surrounds the objective lens (e.g., 520 or 620) in a radial direction perpendicular to an optical axis (e.g., 512) of the objective lens.

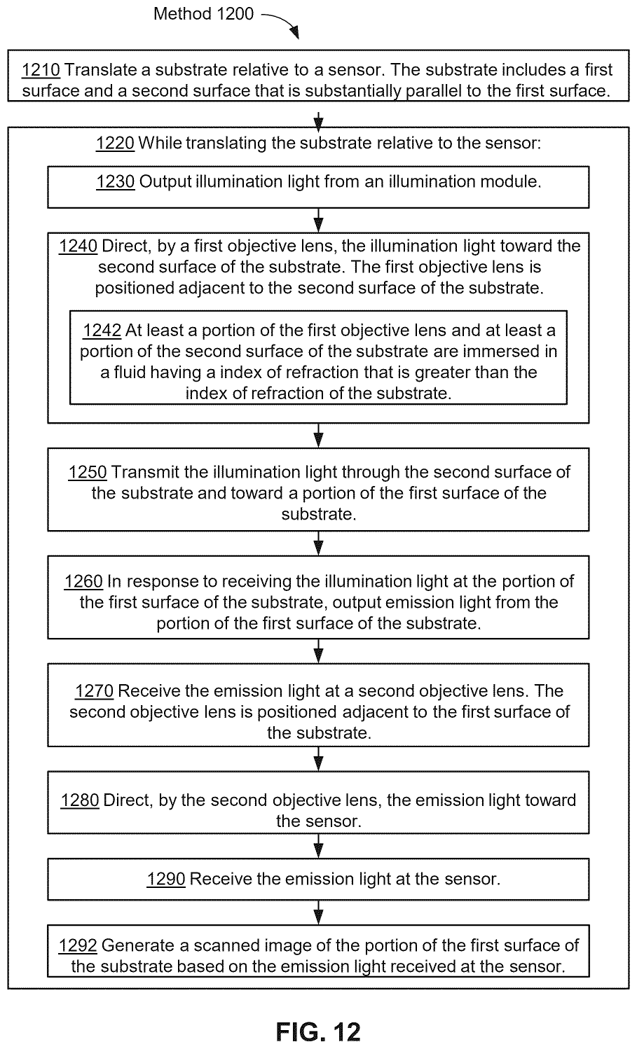

FIG. 12 illustrates a method 1200 of providing back illumination in an optical imaging system. The method 1200 is performed at an optical system 600 that includes an illumination module 610, a first objective lens (e.g., an illumination objective lens 620), a second objective lens (e.g., a detection objective lens 620), and a sensor (e.g., a sensor of the one or more sensors 532 or 632) that is configured for time delay integration imaging. The method 1200 includes (step 1210) translating a substrate (e.g., the substrate 642) relative to the sensor 632. The substrate 642 has a first surface (e.g., top surface 644) and a second surface (e.g., bottom surface 646) that is substantially parallel (e.g., within +/−0.1 degrees, +/−0.2 degrees, +/−0.3 degrees, +/−0.4 degrees, +/−0.5 degrees, +/−1 degree) to the first surface 644. The method 1200 also includes, (step 1220) while translating the substrate 642 relative to the sensor 632: outputting (step 1230) illumination light 690 from the illumination module 610, and directing (step 1240), by the first objective lens 620, the illumination light 690 toward the second surface 646 of the substrate 642. The first objective lens 620 is positioned adjacent to the second surface 646 of the substrate 642. The method 1200 also includes, (step 1220) while translating the substrate 642 relative to the sensor 632: transmitting (step 1250) the illumination light 690 through the second surface 646 of the substrate 642 toward a portion 644-1 of the first surface 644 of the substrate 642, outputting (step 1260) emission light 692 from the portion 644-1 of the first surface 644 of the substrate 642 in response to receiving the illumination light 690 at the portion 644-1 of the first surface 644 of the substrate 642, and receiving (step 1270) the emission light 692 at the second objective lens 620. The second objective lens 620 is positioned adjacent to the first surface 644 of the substrate 642. The method 1200 also includes, (step 1220) while translating the substrate 642 relative to the sensor 632: directing (step 1280), by the second objective lens 620, the emission light 692 toward the sensor 632; receiving (step 1290) the emission light 692 at the sensor 632; and generating (step 1292) a scanned image of the portion 644-1 of the first surface 644 of the substrate 642 based on emission light 692 received at the sensor 632.

In some cases, at least a portion of the first objective lens 620 and at least a portion 646-1 of the second surface 646 of the substrate 642 are immersed (1242) in a fluid 605 that has an index of refraction that is greater than the index of refraction of the substrate 642.

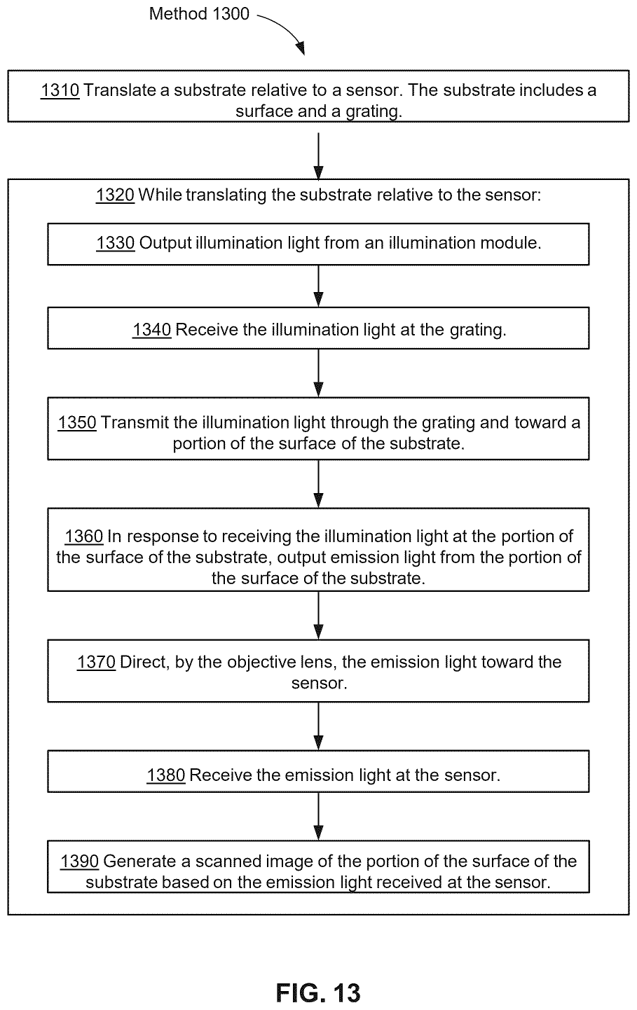

FIG. 13 illustrates a method 1300 of providing illumination in an optical imaging system using a substrate that includes a grating. The method 1300 is performed at an optical system 1000 that includes: an illumination module e.g., 910, an objective lens 920, and a sensor (e.g., a sensor of the one or more sensors 932) configured for time delay integration imaging, as described with respect to FIG. 9. The method 1300 includes (step 1310) translating a substrate (e.g., the substrate 1042) relative to the sensor. The substrate 1042 includes a surface (e.g., the top surface 1044) and a grating (e.g., the grating 1049). The method 1300 also includes (step 1320) while translating the substrate 1042 relative to the sensor: outputting (step 1330) illumination light (e.g., 990) from the illumination module and receiving (step 1340) the illumination light at the grating 1049. The method 1300 further includes, (step 1320) while translating the substrate 1042 relative to the sensor: transmitting (step 1350), by the grating 1049, the illumination light toward a portion 1044-1 of the surface 1044 of the substrate 1042. The method 1300 further includes, (step 1320) while translating the substrate 1042 relative to the sensor: outputting (step 1360) emission light (e.g., 992) from the portion 1044-1 of the surface 1044 of the substrate 1042 in response to receiving the illumination light at the portion 1044-1 of the surface 1044 of the substrate 1042. The method 1300 further includes, (step 1320) while translating the substrate 1042 relative to the sensor: (step 1370) directing, by the objective lens, the emission light toward the sensor; receiving (step 1380) the emission light at the sensor; and generating (step 1390) a scanned image of the portion 1044-1 of the surface 1044 of the substrate 1042 based on the emission light received at the sensor.

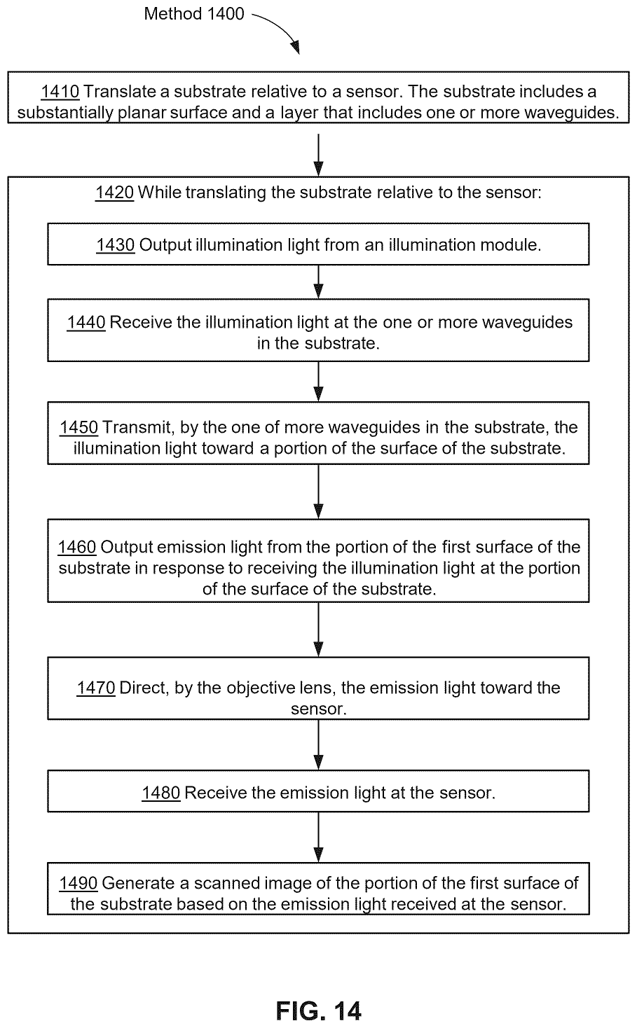

FIG. 14 illustrates a method 1400 of providing illumination in an optical imaging system using a substrate that includes one or more waveguides. The method 1400 is performed at an optical system 900 that includes an illumination module 910, an objective lens 920, and a sensor (e.g., a sensor of the one or more sensors 932) configured for time delay integration imaging. The method 1400 includes (step 1410) translating a substrate (e.g., the substrate 942) relative to the sensor 932. The substrate 942 includes a substantially planar surface (e.g., the top surface 944) and a layer (e.g., the waveguide layer 949) that includes one or more waveguides. The method 1400 also includes (step 1420) while translating the substrate 942 relative to the sensor 932: outputting (step 1430) illumination light (e.g., illumination light 990) from the illumination module 910, and receiving (step 1440) the illumination light 990 at the one or more waveguides in the substrate 942. The method 1400 also includes, (step 1420) while translating the substrate 942 relative to the sensor 932: transmitting (step 1450), by the one or more waveguides in the substrate 942, the illumination light 990 toward a portion 944-1 of the surface 944 of the substrate 942; and outputting (step 1460) emission light 992 from the portion 944-1 of the surface 944 of the substrate 942 in response to receiving the illumination light 990 at the portion 944-1 of the surface 944 of the substrate 942. The method 1400 further includes, (step 1420) while translating the substrate 942 relative to the sensor 932: directing (step 1470), by the objective lens 920, the emission light 992 toward the sensor 932; receiving (step 1480) the emission light 992 at the sensor 932; and generating (step 1490) a scanned image of the portion 944-1 of the surface 944 of the substrate 942 based on the emission light 992 received at the sensor 932.

These illumination configurations are provided by way of example only. Any one or any combination of them, when applicable, can be used in combination with any other methods disclosed herein or known to one of skill in the art. Such methods include but are not limited to a photon reassignment method or a TDI detection method.

Systems and Methods with Improved Background Rejection

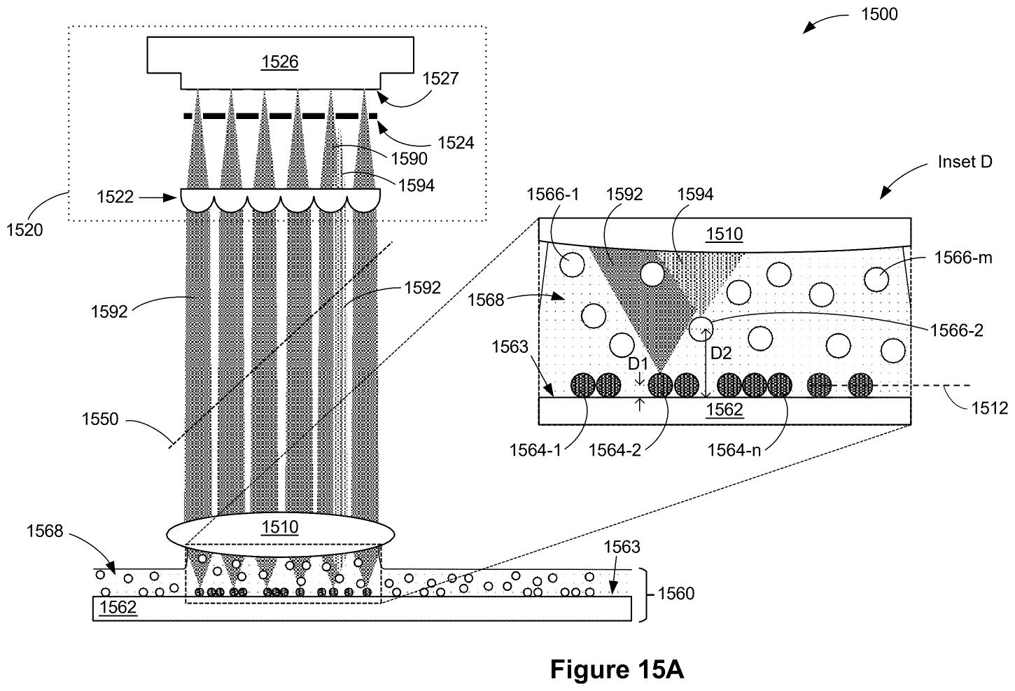

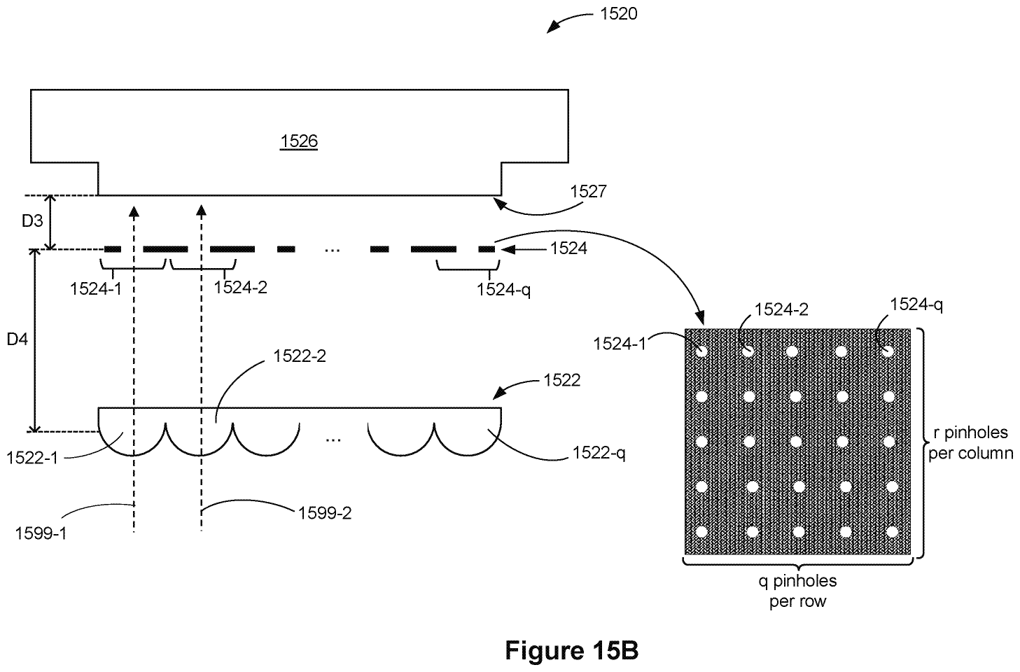

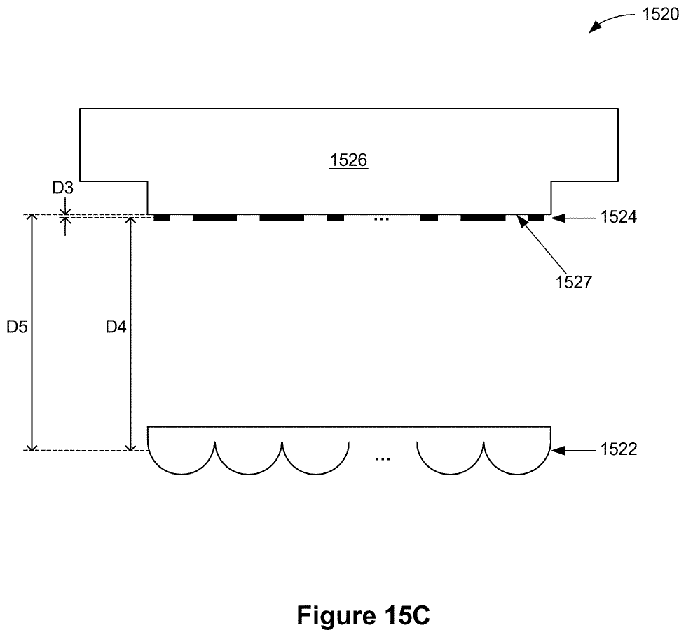

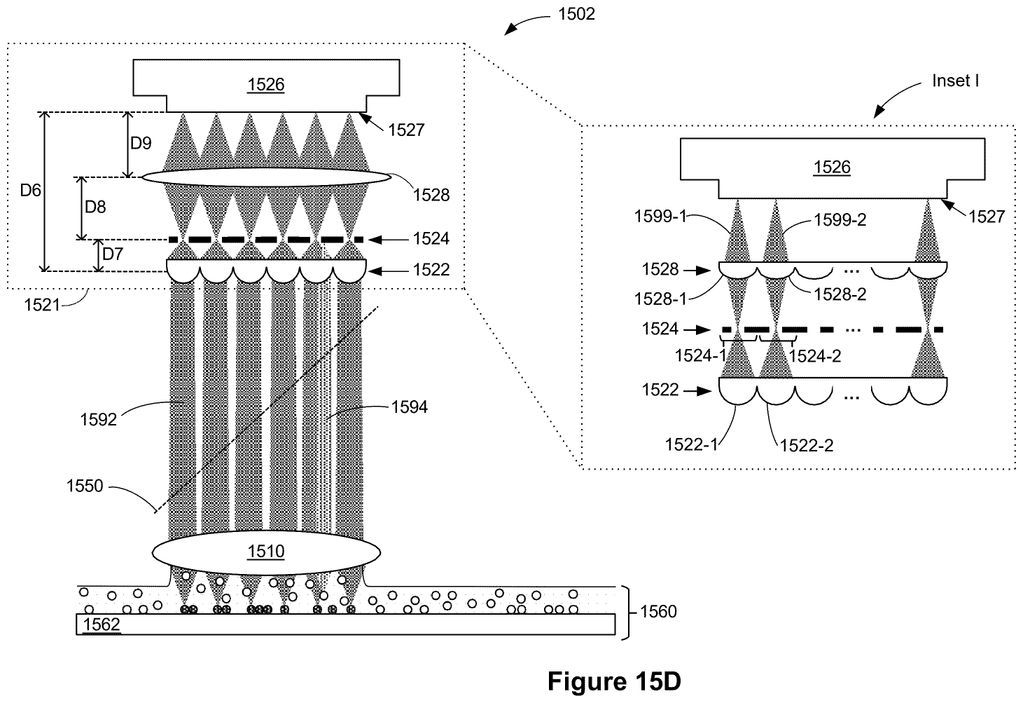

FIG. 15A illustrates a detection path for improved background rejection in an optical imaging system 1500. The detection path for optical imaging system 1500 includes an objective lens 1510 and a detection module 1520 configured to image a sample 1560. The objective lens 1510 is configured to receive emission light 1590 output from the sample 1560 and direct the emission light 1590 toward the detection module 1520 (e.g., toward an optical component of the detection module 1520). The detection module 1520 includes an optical transformation device 1522 (e.g., an optical transformation device 1522 for emission light, or a detection optical transformation device 1522), a pinhole array 1524 and one or more sensors 1526 (e.g., one detector or multiple detectors). In some embodiments, the optical transformation device 1522 is configured to receive light directed from the objective lens 1510 and perform photon reassignment at a sensor of the one or more sensors 1526. In some embodiments, the pinhole array 1524 is configured to block (e.g., attenuate, block transmission of or reduce transmission of) at least a portion of light incident on the pinhole array 1524. The pinhole array 1524 may reduce transmission of light using any of: redirection (e.g., reflecting or refracting) of the incident light, absorption of the incident light, or diffusion of the incident light. In some embodiments, each sensor of the one or more sensors 1526 is configured for time-delay integration imaging (e.g., each sensor is part of a time-delay integration detector or a time-delay integration camera).

The optical transformation device 1522 is configured to receive emission light 1590 from the objective lens 1510 (in some embodiments, via one or more optical components 1550) and transmit the emission light 1590 toward the pinhole array 1524. The pinhole array 1524 is configured to receive the emission light 1590 and transmit at least a portion of the emission light 1590 towards the one or more sensors 1526. In some embodiments, the pinhole array 1524 transmits a first portion (e.g., a subset), less than all, of the emission light 1590 output from the optical transformation device 1522. In some embodiments, the pinhole array 1524 blocks a second portion (e.g., a subset), less than all, of the emission light 1590 output from the optical transformation device 1522. The second portion of the emission light 1590 is distinct from the first portion of the emission light 1590. In some embodiments, the first portion 1592 of the emission light 1590 includes one or more distinct beams that are non-contiguous. The one or more sensors 1526 are configured to receive the first portion of the emission light 1590 that is transmitted through the pinhole array 1524. In some embodiments, one or more sensors 1526 capture multiple images of a moving sample (such as the sample 1560 or a portion of the sample 1560) and generate an image of the sample.

Although not shown in FIG. 15A for ease of illustration, the optical imaging system 1500 may include an illumination module (such as for example a patterned illumination source, oblique illumination shown in FIG. 2C, back illumination as shown in FIG. 4C, and/or any other suitable illumination source described herein).

In some embodiments, the optical imaging system 1500 includes one or more optical components 1550 configured to direct input illumination (e.g., illumination light) towards the objective lens 1510 or the sample 1560. In some embodiments, the one or more optical components 1550 are configured to direct emission light (e.g., light output from the sample 1560) towards the detection module 1520. The one or more optical components 1550 may include any number and any combination of optical components, such as lenses, polarization sensitive optical components, beam splitters, and/or dichroic mirrors. In a non-limiting example, FIG. 15A shows that the one or more optical components 1550 includes a dichroic mirror configured to direct input illumination towards the objective lens 1510 for illumination of the sample 1560 and to direct emission light 1590 towards the detection module 1520.

In the example shown in FIG. 15A, the sample 1560 includes a substrate 1562 (which may correspond e.g., to the substrate 270 as shown in FIG. 2C, the sample platforms 360, 460, and 470 shown in FIGS. 3A, 4A, and 4C, and/or any other suitable substrate described herein) and a plurality of emitters (e.g., emitters 1564-1, 1564-2, . . . , and 1564-n and emitters 1566-1, 1566-2, . . . , and 1566-m) that are disposed on (e.g., located on) a top surface 1563 of the substrate 1562. In some embodiments, the plurality of emitters (e.g., emitters 1564-1, 1564-2, . . . , and 1564-n and emitters 1566-1, 1566-2, . . . , and 1566-m) are immersed and/or suspended in an immersion fluid 1568 (e.g., a liquid). In a non-limiting example, the objective lens 1510 may be an immersion objective lens and the immersion fluid 1568 may be oil, water, or a solution (e.g., a buffer solution). In some cases, alternatively or in addition to the immersion fluid, the plurality of emitters may be immersed and/or suspended in a solution layer, such as a reagent solution layer, adjacent to the top surface 1563 of the substrate 1562. In some embodiments, the sample 1560 is illuminated with illumination light. In some embodiments, the illumination light includes patterned illumination. In some embodiments, the illumination light is structured illumination that forms a diffraction pattern (e.g., the structured illumination pattern 260 shown in FIG. 2A) at the object plane (e.g., the focal plane) of the objective lens 1510 (e.g., it forms a diffraction pattern at the top surface 1563 of the substrate 1562 when the substrate 1562 is positioned at or near the focal length of the objective lens 1510). The diffraction pattern (e.g., the structured illumination pattern 260 shown in FIG. 2A) may include the zeroth order diffraction pattern, the first order diffraction pattern, the second order diffraction pattern, and/or higher orders of the diffraction pattern (e.g., an nth order of the diffraction pattern). In some embodiments, the objective lens 1510 has a pupil diameter that is configured to transmit at least the first order of the diffraction pattern of the illumination light. In some embodiments, the objective lens 1510 has a pupil diameter that is configured to transmit at least the second order of the diffraction pattern of the illumination light.

As shown in inset D, the plurality of emitters includes a first set of emitters (e.g., emitters 1564-1, 1564-2, . . . , and 1564-n) that are located at or near the focal plane 1512 of the objective lens 1510, and a second set of emitters (e.g., emitters 1566-1, 1566-2, . . . , and 1566-m) that are located away from the focal plane 1512 of the objective lens 1510 (e.g., located at a plane that is spaced apart from and distinct from the focal plane 1512 of the objective lens 1510). In this example, the focal plane 1512 of the objective lens 1510 is located at a first distance D1 away from the surface 1563 of the substrate 1562, and emitter 1564-2 is also spaced apart from the surface 1563 of the substrate 1562 by substantially the same distance D1 (e.g., within a depth of field of an illumination light incident on the emitter). In contrast, an emitter of the second set of emitters 1566-2 is located at a second distance D2, distinct (e.g., different) from the first distance D1, away from the surface 1563 of the substrate 1562. That is, emitter 1564-2 is within the depth of field of the imaging system, while emitter 1566-2 is outside the depth of field of the system.

Each emitter of the plurality of emitters (e.g., emitters 1564-1, 1564-2, . . . , and 1564-n and emitters 1566-1, 1566-2, . . . , and 1566-m) is configured to output emitted light in response to receiving illumination light. For example, in response to receiving illumination light, the emitter 1564-2 outputs a light 1592 and the emitter 1566-2 outputs light 1594 that is distinct from the light 1592. Light 1592 and light 1594 are received at the objective lens 1510 and transmitted towards the detection module 1520 (e.g., via one or more optical components 1550). The optical transformation device 1522 receives light 1592 and light 1594 and transmits the light 1592 and the light 1594 toward the pinhole array 1524. The pinhole array 1524 transmits at least a portion of light 1592 and blocks transmission of at least a portion of light 1594. That is, at least a portion of light from emitters that are within the depth of field of the system (e.g., the first set of emitters 1564-1, 1564-2, . . . , and 1564-n) is transmitted by the pinhole and at least a portion of the light from emitters that are outside the depth of field of the system (e.g., emitters of the second set of emitters, namely, emitters 1566-1, 1566-2, . . . , and 1566-m) is blocked by the pinhole. Thus, the transmitted portion of the light 1592 is received at the one or more sensors 1526 and the portion of light 1594 that was not transmitted through the pinhole array 1524 is not received at the one or more sensors 1526. In some embodiments, the portion of light 1592 transmitted through the pinhole array 1524 is received at a surface 1527 of a sensor of the one or more sensors 1526 and the portion of light 1594 that was not transmitted through the pinhole array 1524 is not received at a surface 1527 of the sensor. Thus, an image generated by the one or more sensors 1526 does not include at least a portion of the light output from unwanted emitters (e.g., the second set of emitters 1566-1, 1566-2, . . . , and 1566-m), and thus, provides an improvement in background rejection over conventional imaging methods that do not include the pinhole array 1524. In some embodiments, as shown in FIG. 15A, the pinhole array 1524 is positioned between the optical transformation device 1522 and the one or more sensors 1526.

FIGS. 15B and 15C illustrate examples of the detection module 1520 used in the optical imaging system 1500 shown in FIG. 15A.

In some embodiments, as shown in FIG. 15B, the detection module 1520 includes an optical transformation device 1522, one or more sensors 1526, and a pinhole array 1524 located between the optical transformation device 1522 and the one or more sensors 1526. In some embodiments, the pinhole array 1524 (e.g., comprising the pinholes 1524-1, 1524-2, . . . , 1524-q) is a two-dimensional array of pinholes (e.g., masks, apertures). In this example, the pinhole array 1524 is a two-dimensional array of 5 by 5 pinholes. The pinhole array 1524 can be of any size and may include any number of pinholes. In some cases, the pinhole array 1524 can be generalized as a two-dimensional array of q by r pinholes. In some cases, the pinhole array 1524 can form any two-dimensional shape, including rectangular arrays or non-rectangular arrays, such as a polygonal array, circular array, or curved array. In some cases, the pinhole array 1524 may comprise an arrangement of irregular and/or randomly dispersed pinholes. In some cases, the pinhole array 1524 may comprise pinholes of uniform or non-uniform size and/or shape. In some embodiments, the size (e.g., diameter) of the pinhole (e.g., aperture) is calculated based on the diameter of an Airy disk (also referred to as Airy disc) as defined for the imaging system.

In some embodiments, the optical transformation device 1522 is a two-dimensional array of lenslets, such as a microlens array that is a physically contiguous set of lenslets disposed on a substrate. In this example, the optical transformation device 1522 includes lenslets 1522-1, 1522-2, . . . 1522-p. In some embodiments, the number of lenslets in the optical transformation device 1522 is the same as the number of pinholes in the pinhole array 1524. In some embodiments, the number of lenslets in the optical transformation device 1522 is different from the number of pinholes in the pinhole array 1524.

In some embodiments, the optical transformation device 1522 and the pinhole array 1524 are positioned so that a first portion 1599-1 of light (e.g., a portion of the emission light 1590) that is transmitted through a first lenslet 1522-1 of the optical transformation device 1522 is also transmitted through a first pinhole 1524-1 of the pinhole array 1524. Similarly, a second portion 1599-2 of light that is transmitted through a second lenslet 1522-2 of the optical transformation device 1522 is also transmitted through a second pinhole 1524-2 of the pinhole array 1524.

In some embodiments, the pinhole array 1524 is located adjacent to and spaced apart from the surface 1527 of a sensor of the one or more sensors 1526 by a predetermined distance D3. In some embodiments, as shown in FIG. 15B, the predetermined distance D3 is greater than zero.

In some embodiments, the pinhole array 1524 is located adjacent to and spaced apart from the optical transformation device 1522 by a predetermined distance D4 that is substantially similar to the focal length of the optical transformation device 1522 (e.g., within the system's depth of field).

In some embodiments, as shown in FIG. 15C, the pinhole array 1524 is located on the surface 1527 of a sensor of the one or more sensors 1526 and the predetermined distance D3 is substantially zero (e.g., within 100 nm, 200 nm, 300 nm, 400 nm, 500 nm, 1 μm, 5 μm, 10 μm, or less). For example, the pinhole array 1524 may be patterned or printed onto the surface 1527 of a sensor of the one of more sensors 1526. In another example, the pinhole array 1524 may be glued (e.g., fastened, joined) on the surface 1527 of a sensor of the one of more sensors 1526. In some embodiments, the pinhole array 1524 is patterned or printed onto a clear window (e.g., a protective layer, a protective film, a glass window, a plastic window, a clear window, or a transparent window) that is adjacent to the surface 1527 of a sensor of the one of more sensors 1526. In some embodiments, the pinhole array 1524 may be glued (e.g., fastened or joined) onto a clear window (e.g., a protective layer, a protective film, a glass window, a plastic window, a clear window, or a transparent window) that is adjacent to the surface 1527 of a sensor of the one of more sensors 1526.

In some embodiments, the distance D5 between the optical transformation device 1522 and the surface 1527 of a sensor of the one of more sensors 1526 is substantially similar to (e.g., equal to or less than 100 nm, 200 nm, 300 nm, 400 nm, 500 nm, 1 μm, 5 μm, 10 μm) the distance D4 between the optical transformation device 1522 and the pinhole array 1524. In some embodiments, the distance D5 between the optical transformation device 1522 and the surface 1527 of a sensor of the one of more sensors 1526 is substantially similar to the focal length of the optical transformation device 1522. In some embodiments, the distance D4 between the optical transformation device 1522 and the pinhole array 1524 is substantially similar to the focal length of the optical transformation device 1522.

FIG. 15D illustrates a detection path for an optical imaging system 1502 with improved background rejection. The optical imaging system 1502 is the same as the optical imaging system 1500 shown in FIG. 15A and includes a detection module 1521 instead of the detection module 1520. Details regarding the transmission of the emission light 1590 through the objective and one or more optical components are provided above in FIG. 15A and not repeated here for brevity. The detection module 1521 includes an optical transformation device 1522, a pinhole array 1524, an optical relay 1528 (e.g., optical relay device 1528), and one or more sensors 1526. In some embodiments, as shown in FIG. 15D, the pinhole array 1524 is positioned between the optical transformation device 1522 and the optical relay 1528. In some embodiments, the optical relay 1528 is positioned between the pinhole array 1524 and the one or more sensors 1526. Details regarding the optical transformation device 1522, the pinhole array 1524, and the one or more sensors 1526 are described in FIG. 15A. In some embodiments, the optical relay 1528 is an optical transformation device. In some embodiments, the optical relay 1528 includes one or more microlens arrays. In some embodiments, the optical relay 1528 includes one or more two-dimensional arrays of lenslets. For instance, the optical relay 1528 may include a first microlens array and a second microlens array (positioned in series such that light is transmitted through the first microlens array before being received at the second microlens array) that focuses the portion of the emission light 1590 transmitted through the pinhole array 1524 onto the surface 1527 of a sensor of the one or more sensors 1526.

As shown in FIG. 15D, the emission light 1590 is transmitted from the objective lens 1510 (e.g., via one or more optical components 1550) to the detection module 1521. The optical transformation device 1522 receives the emission light 1590 and transmits the emission light 1590 toward the pinhole array 1524. The pinhole array 1524 transmits at least a portion of the emission light 1590 (e.g., at least a portion of the light 1592 emitted from the first set of emitters 1564-1, 1564-2, . . . , and 1564-n), shown in FIG. 15A) toward the optical relay 1528. The optical relay 1528 transmits (e.g., directs or focuses) the portion of the emission light 1590 transmitted through the pinhole array 1524 onto the surface 1527 of a sensor of the one or more sensors 1526 so that an image of the sample 1560 (e.g., an image of a portion of the sample 1560 or an image of at least some of the plurality of emitters of sample 1560) may be generated based on the emission light 1590 received at the one or more sensors 1526.

In some embodiments, as shown in inset I, the optical transformation device 1522, the pinhole array 1524, and the optical relay 1528 are positioned so that a first portion 1599-1 of light (e.g., of emission light 1590) that is transmitted through a first lenslet 1522-1 of the optical transformation device 1522 is also transmitted through a first pinhole 1524-1 of the pinhole array 1524, and the first portion 1599-1 of light (e.g., of emission light 1590) transmitted through the first pinhole 1524-1 is also transmitted through a first lenslet 1528-1 of the optical relay 1528. Similarly, a second portion 1599-2 of light that is transmitted through a second lenslet 1522-2 of the optical transformation device 1522 is also transmitted through a second pinhole 1524-2 of the pinhole array 1524 and transmitted through second lenslet 1528-2 of the optical relay 1528.

In some embodiments, the optical transformation device 1522 is positioned at a predetermined distance D6 from the surface 1527 of a sensor of the one or more sensors 1526. In some embodiments, the predetermined distance D6 is greater than the focal distance of the optical transformation device 1522.

The pinhole array 1524 is positioned at a predetermined distance D7 from the optical transformation device 1522. In some embodiments, the predetermined distance D7 is substantially the same as the focal length of the optical transformation device 1522. The pinhole array 1524 is positioned at a predetermined distance D8 from the optical relay 1528. In some embodiments, the predetermined distance D8 is substantially the same as the focal distance of the optical relay 1528.

The optical relay 1528 is positioned at a predetermined distance D9 away from the surface 1527 of a sensor of the one or more sensors 1526. In some embodiments, the predetermined distance D9 is substantially the same as the focal distance of the optical relay 1528. Thus, the pinhole array 1524 is positioned at a plane (e.g., an optical plane) that is conjugate to the surface 1527 of a sensor of the one or more sensors 1526.

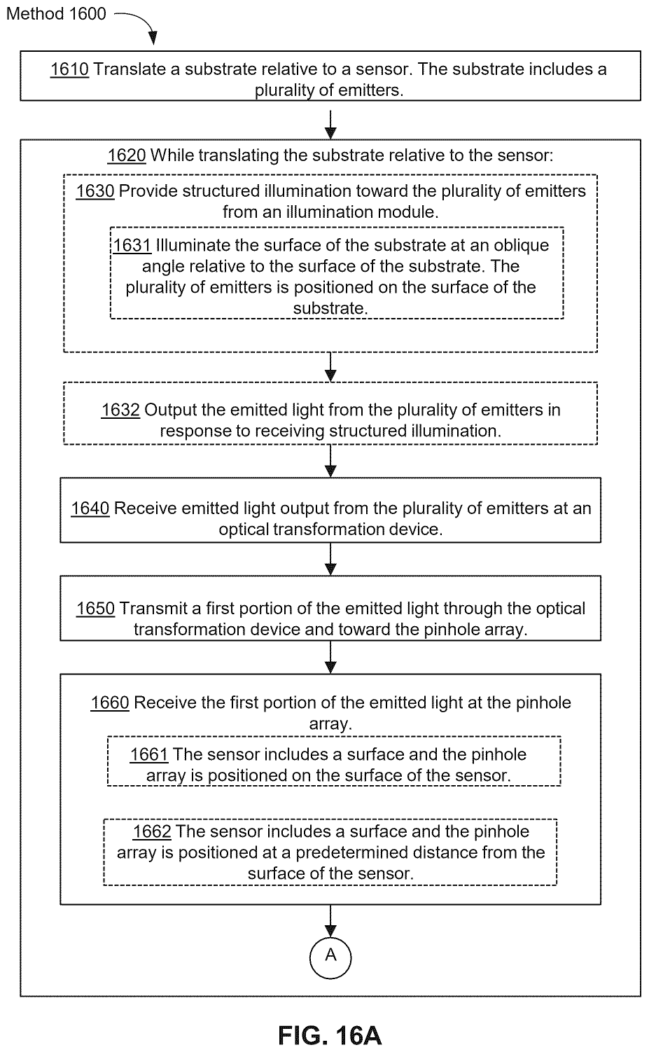

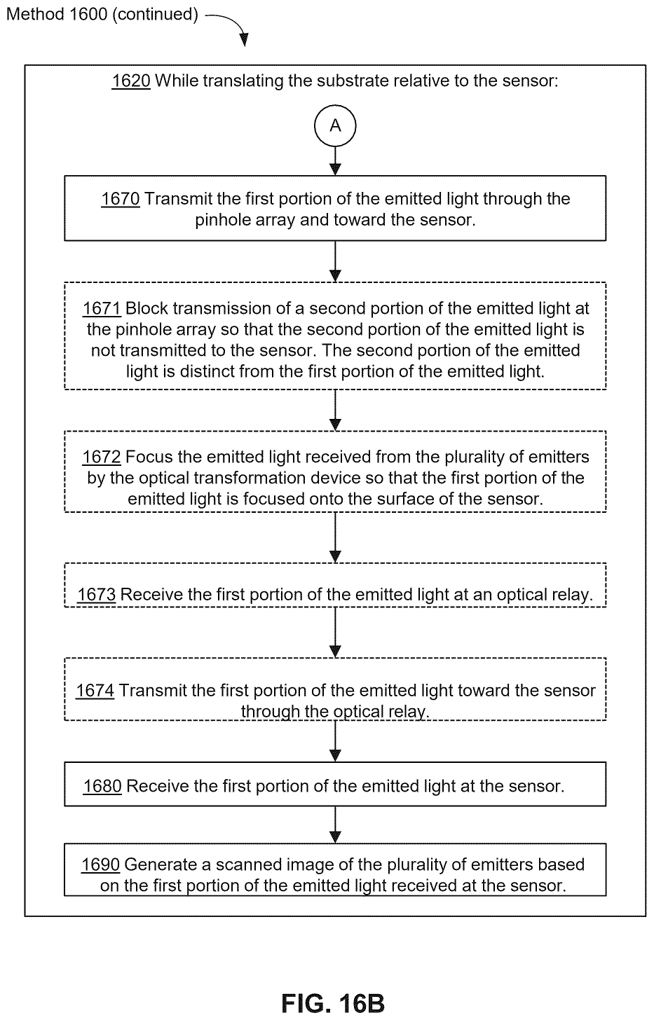

FIGS. 16A and 16B illustrate a method 1600 for improved background rejection in an optical imaging system. The method 1600 includes (step 1610) translating a substrate (e.g., the substrate 1562 of the sample 1560) relative to a sensor (e.g., a sensor of the one or more sensors 1526). The substrate 1562 includes a plurality of emitters (e.g., emitters 1564-1, 1564-2, . . . , and 1564-n, and emitters 1566-1, 1566-2, . . . , and 15646-m). The method 1600 further includes while translating (step 1620) the substrate 1562 relative to the sensor: (step 1640) receiving the emitted light 1590 output from the plurality of emitters at an optical transformation device 1522, (step 1650) transmitting a first portion of the emitted light (e.g., at least a portion of light 1592 emitted from emitter 1564-2, shown in FIG. 15A) through the optical transformation device 1522 and toward the pinhole array 1524, (step 1660) receiving the first portion of the emitted light at the pinhole array 1524, (step 1670) transmitting the first portion of the emitted light through the pinhole array 1524 and toward the sensor, (step 1680) receiving the first portion of the emitted light at the sensor, and (step 1690) generating a scanned image of the plurality emitters based on the first portion of the emitted light received at the sensor.

In some embodiments, translating the substrate 1562 relative to a sensor includes moving (e.g., in a lateral or radial direction) the substrate 1562. Alternatively or in addition, in some embodiments, translating the substrate 1562 relative to a sensor includes moving (e.g., in a lateral or radial direction) the sensor. Alternatively or in addition, in some embodiments, translating the substrate 1562 relative to a sensor includes changing the orientation of the substrate 1562 (e.g., rotating the substrate 1562). Alternatively or in addition, in some embodiments, translating the substrate 1562 relative to a sensor includes changing the orientation of the sensor (e.g., rotating the sensor).

In some embodiments, the method 1600 further includes, while translating (step 1620) the substrate 1562 relative to the sensor, (step 1630) providing structured illumination toward the plurality of emitters from an illumination module (such as for example a patterned illumination source, the oblique illumination shown in FIG. 2C, the back illumination shown in FIG. 4C, or any other suitable illumination source described herein).

In some embodiments, the method 1600 further includes, while translating (step 1620) the substrate 1562 relative to the sensor, (step 1631) illuminating the surface 1527 of the substrate 1562 at an oblique angle α relative to the surface 1527 of the substrate 1562. The plurality of emitters (e.g., emitters 1564-1, 1564-2, . . . , and 1564-n, and emitters 1566-1, 1566-2, . . . , and 1566-m) are positioned on the surface 1527 of the substrate 1562.

In some embodiments, the method 1600 further includes, while translating (step 1620) the substrate 1562 relative to the sensor, (step 1632) outputting the emitted light 1590 from the plurality of emitters (e.g., emitters 1564-1, 1564-2, . . . , and 1564-n, and emitters 1566-1, 1566-2, . . . , and 1566-m) in response to receiving structured illumination.

In some embodiments, the sensor of the one or more sensors 1526 includes a surface 1527, and the pinhole array 1524 is positioned on the surface 1527 of the sensor (shown in FIG. 15C).

In some embodiments, the sensor of the one or more sensors 1526 includes a surface 1527, and the pinhole array 1524 is positioned at a predetermined distance (e.g., non-zero distance, distance D3, shown in FIG. 15B) from the surface 1527 of the sensor.

In some embodiments, the method 1600 further includes, while translating (step 1620) the substrate 1562 relative to the sensor, (step 1671) blocking transmission of a second portion of the emitted light (e.g., at least a portion of the light 1594 emitted from the emitter 1566-2, shown in FIG. 15A) at the pinhole array 1524 so that the second portion of the emitted light is not transmitted to the sensor. The second portion of the emitted light is distinct from the first portion of the emitted light.

In some embodiments, the method 1600 further includes, while translating (step 1620) the substrate 1562 relative to the sensor, (step 1672) focusing the emitted light 1590 received from the plurality of emitters by the optical transformation device 1522 such that the first portion of the emitted light (e.g., at least a portion of the light 1592 emitted from the emitter 1564-2, shown in FIG. 15A) is focused onto the surface 1527 of the sensor.

In some embodiments, the method 1600 further includes, while translating (step 1620) the substrate 1562 relative to the sensor: (step 1673) receiving the first portion of the emitted light (e.g., at least a portion of the light 1592 emitted from emitter 1564-2, shown in FIG. 15A) at an optical relay 1528, and (step 1674) transmitting the first portion of the emitted light toward the sensor through the optical relay 1528.

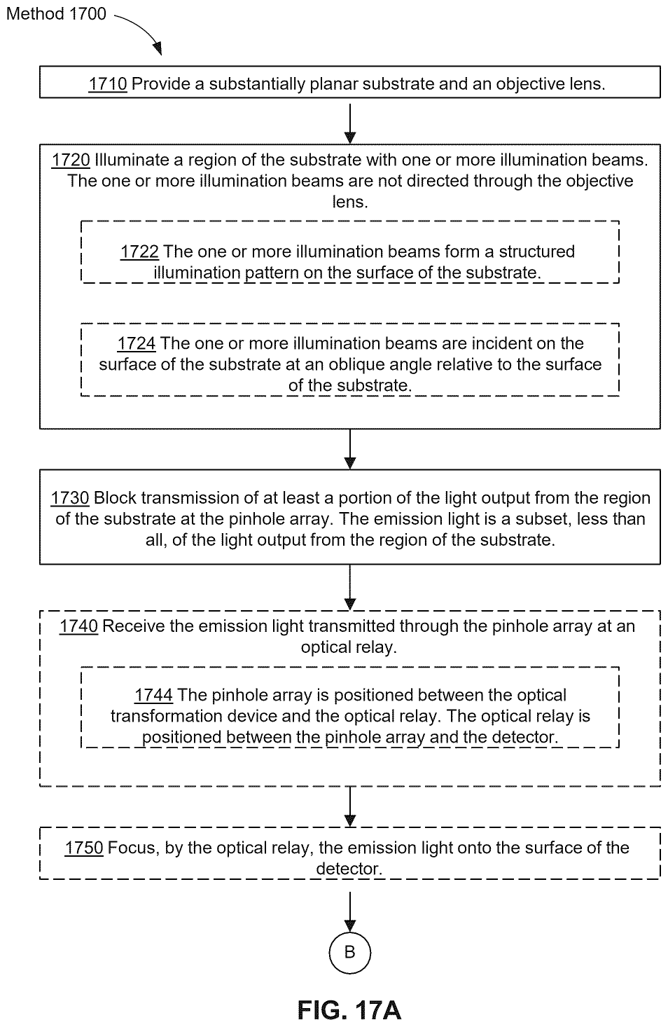

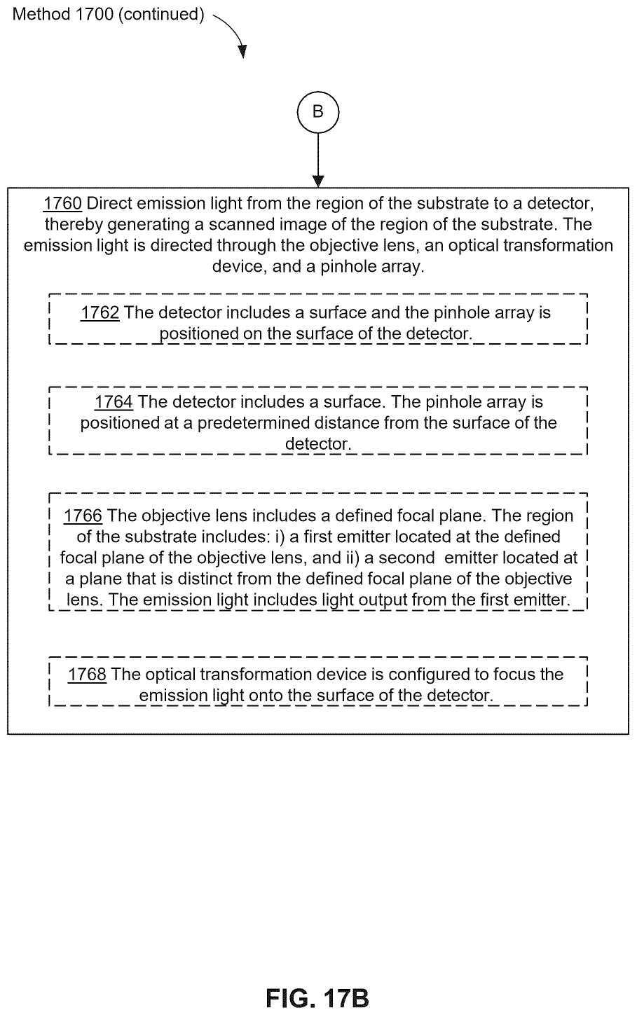

FIGS. 17A and 17B illustrate a method 1700 for improved background rejection in an optical imaging system. The method 1700 includes (step 1710) providing a substantially planar substrate 1562 (such as the substrate 270 shown in FIG. 2C, the sample platform 470, shown in FIG. 4C, or the substrate 1562 of sample 1560 shown in FIGS. 15A and 15D, or any other suitable substrate described herein) and an objective lens (e.g., the objective lens 230 shown in FIG. 2C, the objective lens 432 shown in FIG. 4C, or the objective lens 1510 shown in FIGS. 15A and 15D). The method also includes (step 1720) illuminating a region of the substrate with one or more illumination beams (e.g., the input illumination 210 shown in FIGS. 2A and 2C, or the input illumination 410 shown in FIGS. 4A and 4C). The method also includes (step 1760) directing emission light (e.g., the emission light 1590 shown in FIGS. 15A and 15D) from the region of the substrate to a detector (e.g., a sensor of the one or more sensors 1526 shown in FIGS. 15A-15D), thereby generating a scanned image of the region of the substrate. In some cases, as described elsewhere herein, the one or more illumination beams are not directed through the objective lens 1510 (e.g., the optical path of the illumination beams does not pass through the objective lens 1510). The emission light 1590 is directed through the objective lens 1510, an optical transformation device 1522, and a pinhole array 1524. FIGS. 2A, 2C, 4A, and 4C illustrate examples of illuminating the substrate as described in step 1710. FIGS. 15A and 15D illustrate examples of directing the emission light as described in step 1760.

In some embodiments, the one or more illumination beams (e.g., the input illumination 210 shown in FIGS. 2A and 2C or the input illumination 410 shown in FIGS. 4A and 4C) form (step 1722) a structured illumination pattern (e.g., the illumination pattern 260 shown in FIG. 2A) on the surface of the substrate.

In some embodiments, the one or more illumination beams (e.g., the input illumination 210 shown in FIGS. 2A and 2C, or the input illumination 410 shown in FIGS. 4A and 4C), are (step 1724) incident on the surface of the substrate at an oblique angle relative to the surface of the substrate.

In some embodiments, the method 1700 further includes (step 1730) blocking transmission of at least a portion of the light output from the region of the substrate at the pinhole array 1524. The emission light is a subset, less than all, of the light output from the region of the substrate. For example, as described in FIG. 15A, at least a portion of the light 1592 output from the emitter 1564-2 is transmitted through the pinhole array 1524, and at least a portion of the light 1594 output from emitter 1566-2 is blocked (e.g., not transmitted through) by the pinhole array 1524.

In some embodiments, the method 1700 further includes (step 1740) receiving the emission light transmitted through the pinhole array 1524 at an optical relay 1528 and (step 1750) focusing, by the optical relay 1528, the emission light onto the surface 1527 of the detector (e.g., a sensor of the one or more sensors 1526).

In some embodiments, the pinhole array 1524 is positioned (1744) between the optical transformation device 1522 and the optical relay 1528, and the optical relay 1528 is positioned between the pinhole array 1524 and the detector (e.g., a sensor of the one or more sensors 1526). An example is illustrated in FIG. 15D.

In some embodiments, the detector (e.g., a sensor of the one or more sensors 1526) includes (step 1762) a surface 1527 and the pinhole array 1524 is positioned on the surface 1527 of the detector. An example is illustrated in FIG. 15C.

In some embodiments, the detector (e.g., a sensor of the one or more sensors 1526) includes (step 1764) a surface 1527. The pinhole array 1524 is positioned at a predetermined distance D3 (e.g., a non-zero distance) from the surface of the detector. An example is illustrated in FIGS. 15A, 15B, and 15D.

In some embodiments, the objective lens 1510 includes (step 1766) a defined focal plane. The region of the substrate 1562 includes: (i) a first emitter (e.g., any of emitters 1564-1, 1564-2, . . . and 1564-n) located at the defined focal plane 1512 of the objective lens 1510 and ii) a second emitter (e.g., any of emitters 1566-1, 1566-2, . . . and 1566-m) located at a plane that is distinct from the defined focal plane of the objective lens 1510. The emission light includes light output from the first emitter (e.g., light 1592 output from any of emitters 1564-1, 1564-2, . . . and 1564-n). An example is illustrated in FIG. 15A.

In some embodiments, the optical transformation device 1522 is configured (step 1768) to focus the emission light (e.g., at least a portion of the light 1592 output from emitter 1564-2, shown in FIG. 15A) onto the surface of the detector (e.g., a sensor of the one or more sensors 1526).

### High Throughput Processing Methods

An open substrate as described herein may be processed within a modular local sample processing environment. A barrier comprising a fluid barrier may be maintained between a sample processing environment and an exterior environment during certain processing operations, such as reagent dispensing and detecting. Systems and methods comprising a fluid barrier are described further in U.S. Pat. Pub. No. 2021/0354126A1, which is entirely incorporated herein by reference.

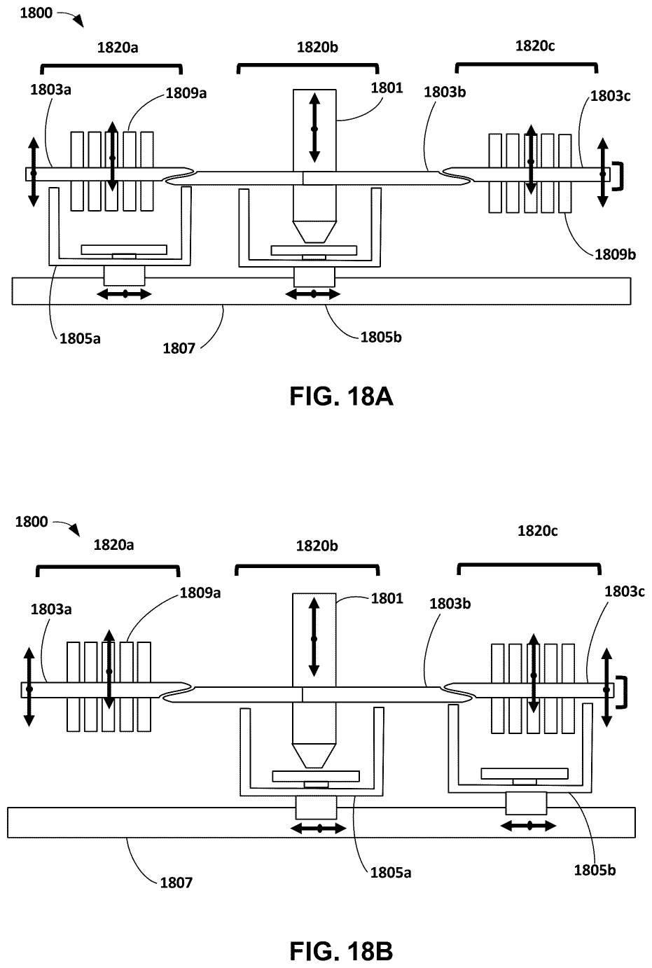

As shown in FIGS. 18A and 18B, a processing system 1800 (e.g., for use with open substrates) may comprise different operating stations (e.g., 1820a, 1802b, 1820c). For example, an operating station may comprise a chemical station (e.g., 1820a, 1820c) configured for reagent dispensing, analyte processing, and/or washing; a sample loading station, a sample storage station, or a detection station (e.g., 1820b), such as for detection of a signal or signal change. Any barrier system (e.g., 1805a, 1805b) of the processing system may be capable of traveling (e.g., along rail or track 1807) between different operating stations, thus moving an open substrate from one operating station to another. In some instances, different barrier systems may share the same rail or track or other motion path for travel between the different operating systems (e.g., as illustrated in FIGS. 18A and 18B). In such cases, the different barrier systems may be configured to move independently of each other on the same rail or track or other motion path, or to move in unison. In some instances, a respective different barrier system may move on a dedicated, separate rail or track or other motion path.

The processing system or any element thereof may be environmentally controlled. For instance, operating stations may have different local temperatures, pressures, and/or humidity. For example, a chemical station may comprise first operating conditions, and a detection station may comprise second, different operating conditions.

A barrier system may be configured to maintain a fluid barrier between a sample processing environment and an exterior environment. The barrier system is described in further detail in U.S. Pat. Pub. No. 2021/0354126, which is entirely incorporated herein by reference. A sample environment system may comprise a sample processing environment defined by a chamber and a lid plate, where the lid plate is not in contact with the chamber. While FIGS. 18A and 18B illustrate a processing system 1800 comprising three operating stations (e.g., 1820a, 1820b, 1820c) and two barrier systems (e.g., 1803a, 1803b), it will be appreciated that a processing system may have any number of operating stations and barrier systems.

An operating station 1820 may have one or more operating units configured to facilitate an operation with respect to a sample or the sample environment (or local environment(s) thereof). An operating unit may protrude into the sample environment of a barrier system from the external environment. An operating unit may comprise one or more detectors (2501) configured to facilitate detection of a signal or signal change from a sample; a fluid dispenser (e.g., 1809a, 1809b) configured to facilitate reagent or fluid dispensing to a sample; an environmental unit configured to facilitate environment regulation of a sample environment; a light source, heat source, or humidity source; or any one or more sensors.

In some instances, the processing system 1800 may comprise a plurality of modular plates (e.g., 1803a, 1803b, 1803c) that may be coupled or otherwise fastened to each other to create an uninterrupted plate 1803. In some instances, each modular plate may comprise one or more operating stations (e.g., operating stations are coupled or otherwise fastened to plate 1803). In some instances, a modular plate may be detachable from another modular plate or a remainder of the plate 1803 without disturbing sample environments of respective barrier systems, such as during an operation by one or more operating units on a barrier system, while another barrier system is subject to another operation at another operating station. Beneficially, detachment of a modular plate may allow access to a sample environment, such as to load or unload a chamber, without disturbing another sample environment (e.g., contained within another barrier system).

Chambers of the present disclosure may comprise a base and side walls to define an opening that nearly contacts the plate (or lid). The side walls may be a closed continuous surface, or a plurality of adjacent (and/or adjoining) surfaces. For example, the base may comprise or be the substrate. In some instances, the base may be coupled to the substrate. The substrate may be translatable relative to the base. The substrate may be rotatable relative to the base.

The substrates and/or detector systems described herein may undergo relative rotational motion, relative non-rotational motion, such as relative linear motion, relative non-linear motion (e.g., curved, arcuate, angled, etc.), and any other types of relative motion. Beneficially, relative motion between the one or more detection units in the detection station and the substrate may significantly increase detection efficiency.

In some instances, an open substrate (e.g., 1830a, 1830b) is retained in the same or approximately the same physical location during processing of an analyte and subsequent detection of a signal associated with a processed analyte. The open substrate may transition between different stations by transporting a sample processing environment containing the open substrate (such as the one described with respect to the barrier system) between the different stations. One or more mechanical components or mechanisms, such as a robotic arm, elevator mechanism, actuators, rails, and the like, or other mechanisms may be used to transport the sample processing environment.

In this illustrative re-stationing scheme, the detection station may be kept active (e.g., not have idle time not operating on a substrate) for all operating cycles by providing alternating different sample environment systems to the detection station for each consecutive operating cycle. Beneficially, use of the detection station is optimized. Based on different processing or equipment needs, an operator may opt to run the two chemistry stations (e.g., 1820a, 1820c) substantially simultaneously while the detection station (e.g., 1820b) is kept idle such as illustrated in FIG. 18A. Beneficially, different operations within the system may be multiplexed with high flexibility and control. For example, one or more processing stations may be operated in parallel with one or more detection stations on different substrates in different modular sample environment systems to reduce or eliminate lag between different sequences of operations (e.g., chemistry first, then detection).

### Computer System

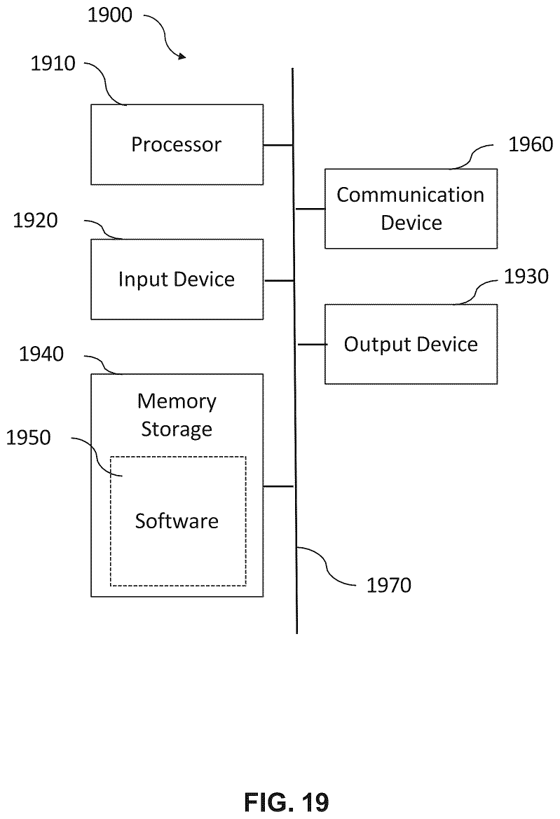

FIG. 19 illustrates an example of a computing device in accordance with one or more examples of the disclosure. Device 1900 can be a host computer connected to a network. Device 1900 can be a client computer or a server. As shown in FIG. 19, device 1900 can be any suitable type of microprocessor-based device, such as a personal computer, workstation, server, or handheld computing device (portable electronic device), such as a phone or tablet. The device can include, for example, one or more of processors 1910, input device 1920, output device 1930, storage 1940, and communication device 1960. Input device 1920 and output device 1930 can generally correspond to those described above, and they can either be connectable or integrated with the computer.

Input device 1920 can be any suitable device that provides input, such as a touch screen, keyboard or keypad, mouse, or voice-recognition device. Output device 1930 can be any suitable device that provides output for a user, such as a touch screen, haptics device, or speaker.

Storage 1940 can be any suitable device that provides storage, e.g., an electrical, magnetic, or optical memory including a RAM, cache, hard drive, or removable storage disk. Communication device 1960 can include any suitable device capable of transmitting and receiving signals over a network, e.g., a network interface chip or device. The components of the computer can be connected in any suitable manner, e.g., via a physical bus 1970 or wirelessly. Software 1950, which can be stored in memory/storage 1940 and executed by processor 1210, can include, for example, the programming that embodies the functionality of the present disclosure (e.g., as embodied in the devices described above).

Software 1950 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1940, that can contain or store programming for use by or in connection with an instruction execution system, apparatus, or device.

Software 1950 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, Tl or T3 lines, cable networks, DSL, or telephone lines.

Device 1900 can implement any operating system suitable for operating on the network. Software 1950 can be written in any suitable programming language, such as C, C++, Java, or Python. In various embodiments, application software embodying the functionality of the present disclosure can be deployed in different configurations, such as in a client/server arrangement or through a web browser as a web-based application or web service, for example.

### EXAMPLES

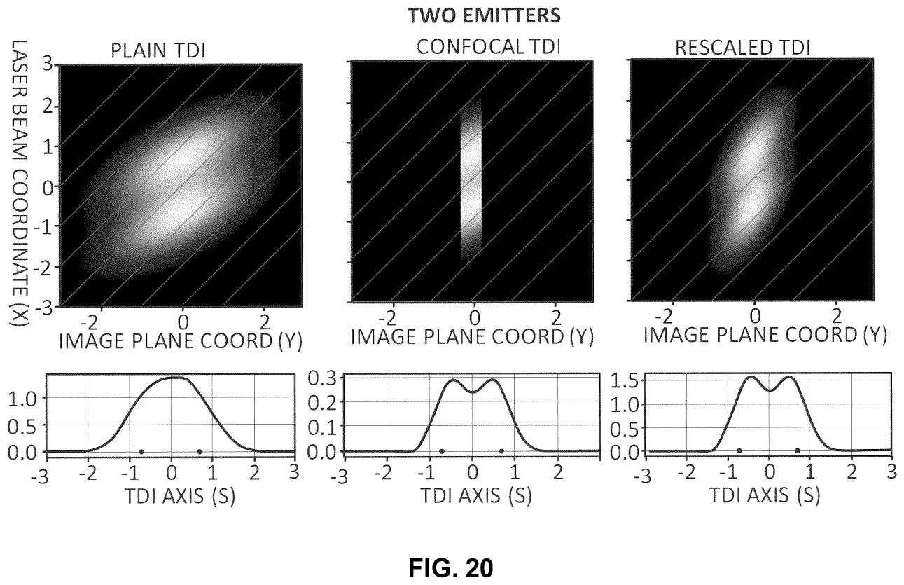

Example 1—Enhanced Resolution for Imaging of Two Emitters. FIG. 20 provides an example of the resolution improvement provided by optical transform TDI imaging systems, in accordance with some implementations described herein. Heat maps (i.e., simulated plots of image intensity as a function of laser beam coordinate (X) and image plane coordinate (Y)) are shown for two closely spaced point emitters as imaged using conventional TDI imaging (upper left), confocal TDI imaging (e.g., a confocal imaging system comprising a single pinhole aligned with the central pixel in a TDI image sensor; upper middle), and a rescaled TDI imaging system (comprising a second optical transformation device, e.g., a micro-lens array, to rescale the illumination PSF and detection PSF) as described herein (upper right). The corresponding image intensity profiles are plotted for the conventional TDI imaging system (lower left), the confocal TDI imaging system (lower middle), and the rescaled TDI imaging system (lower right). As can be seen, the rescaled TDI imaging system is capable of producing an image having image resolution that is comparable to (or better than) that obtained using a confocal TDI imaging system, and both the confocal TDI imaging system and rescaled TDI imaging system produce images having a significantly higher image resolution that that obtained using a conventional TDI imaging system. Furthermore, the rescaled TDI image has higher signal (and corresponding improvements in SNR and contrast) than the image obtained using confocal TDI imaging (see the relative intensity scales for the intensity profiles plots), as a significant portion of emitted light is blocked by the pinhole in the latter instrument.

Example 2—Improved resolution with external CoSI (xCoSI). As noted above, it is possible to increase the resolution of CoSI by altering illumination conditions. Specifically, by providing illumination external to the objective (e.g., by utilizing illumination angles greater than those permitted within the confines of an objective), the density of illumination beams, and hence the resolution of the system, can be increased.

To exemplify the resolution increase, a simulation of external CoSI was performed. This simulation used CoSI photon reassignment for both the CoSI and xCoSI. The assumed excitation and emission wavelengths were 532 nm and 570 nm, respectively. A hexagonal illumination pattern was used for CoSI and xCoSI. In the later system, this means that six illumination beams are routed external to the objective (see e.g., FIGS. 2A-4C). Additional illumination patterns are possible (e.g., 3, 4, 5, 7, 8, 9, 10 or more external illumination beams). For instance, if four external illumination beams were used, the illumination pattern would be a grid. For each imaging system, the detection NA is set to 0.72. For CoSI, the excitation NA is the same as the detection NA. For the external CoSI simulations, excitation NA can be increased (e.g., to 1.1 and 1.3, respectively).

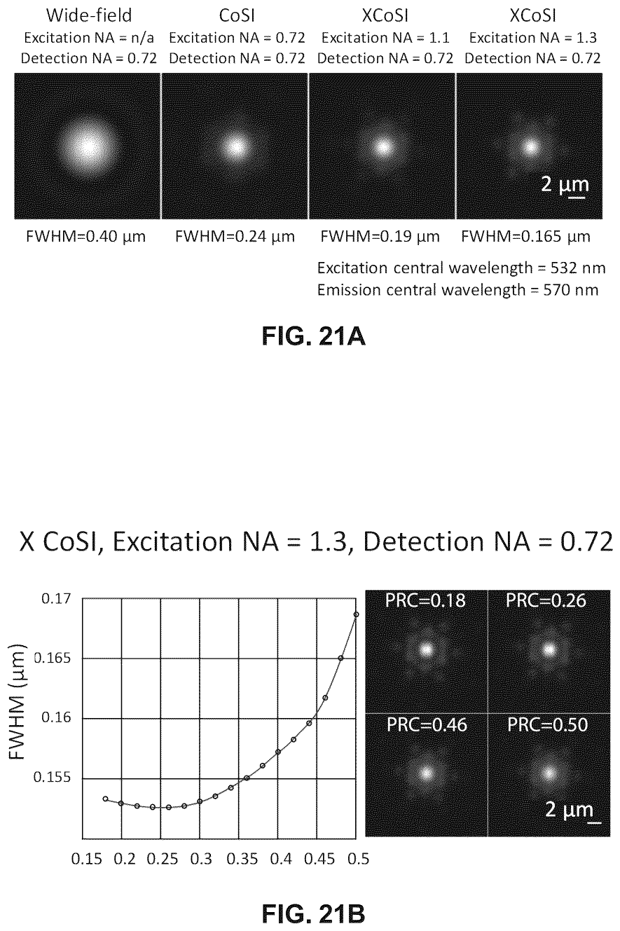

As illustrated in FIG. 21A, there is a clear decrease in the observed FWHM of an imaged object (i.e., a fluorescent bead set to 50 nm in diameter in the simulation) between a widefield imaging system and a comparable CoSI imaging system and between the CoSI imaging system and comparable xCoSI systems. The widefield microscopy has resolution FWHM=0.40 μm. CoSI improves the resolution by a factor of 1.67× (to FWHM=0.24 μm) by taking advantage of an excitation NA, where the excitation light passes through the same objective. External CoSI can further improve the resolution to FWHM=0.125 μm (2.4× compared to widefield) by employing the illumination external to the objective. FIG. 21B illustrates the impact of photon reassignment coefficient on resolution (e.g., FWHM) in an xCoSI system.

### ADDITIONAL EXAMPLE IMPLEMENTATIONS

(A1) In one aspect, an optical system includes an illumination module configured to provide illumination light, an optical component configured to direct the illumination light toward a portion of a first surface of a substrate, an objective lens (i) positioned adjacent to the first surface of the substrate and (ii) configured to receive emission light output from the portion of the first surface of the substrate, and one or more sensors configured for time delay integration imaging. The optical path of the illumination light does not pass through the objective lens. At least the surface of the optical component that is adjacent to the substrate is immersed in in a fluid that has an index of refraction that is substantially similar to the index of refraction of the substrate. The objective lens is configured to direct the emission light toward the one or more sensors.

(A2) The optical system of A1, where the surface of the optical component is positioned adjacent to and spaced apart from the first surface of the substrate, and at least a portion of the objective lens and the portion of the first surface of the substrate are immersed in the fluid.

(A3) The optical system of A1, where the substrate further includes a second surface that is substantially parallel to the first surface. The surface of the optical component is positioned adjacent to and spaced apart from the second surface of the substrate, and at least a portion of the second surface of the substrate is immersed in the fluid.

(A4) The optical system of A1 or A3, where the substrate further includes a plurality of beads disposed on the first surface. A first bead of the plurality of beads is positioned on the portion of the first surface of the substrate. The first bead has an index of refraction that is substantially similar to the index of refraction of the substrate. At least a portion of the illumination light is transmitted into the first bead, and the first bead is configured to output emission light in response to receiving the illumination light.

(A5) The optical system of any of A1-A4, where the optical component is a toroidal cylindrical lens that surrounds the objective lens in a radial direction perpendicular to an optical axis of the objective lens.

(A6) A method performed at any of the optical systems of A1-A5, including translating a substrate relative to the sensor. While translating the substrate relative to the sensor: (i) output illumination light from the illumination module, and (ii) direct, by the optical component, the illumination light toward a portion of the first surface of the substrate so that the optical path of the illumination light does not pass through the objective lens. The method further includes, while translating the substrate relative to the sensor: (iii) outputting emission light from the portion of the first surface of the substrate in response to receiving the illumination light at the portion of the first surface of the substrate, and (iv) receiving the emission light at the objective lens. The objective lens is positioned adjacent to the first surface of the substrate. The method further includes, while translating the substrate relative to the sensor: (v) directing, by the objective lens, the emission light toward the sensor; (vi) receiving the emission light at the sensor, (vii) and generating a scanned image of the portion of the first surface of the substrate based on the emission light received at the sensor.

(A7) The method of A6, where directing the illumination light toward a portion of the first surface of the substrate by the optical component includes outputting the illumination light from a surface of the optical component that is adjacent to and spaced apart from the first surface of the substrate. At least a portion of the objective lens, the surface of the optical component, and the portion of the first surface of the substrate are immersed in a fluid that has an index of refraction that is substantially similar to the index of refraction of the substrate.

(A8) The method of A6, where the substrate further includes a second surface that is substantially parallel to the first surface, and directing the illumination light toward a portion of the first surface of the substrate by the optical component includes outputting the illumination light from a surface of the optical component that is adjacent to and spaced apart from the second surface of the substrate. At least a portion of the surface of the optical component and at least a portion of the second surface of the substrate are immersed in a fluid that has an index of refraction that is substantially similar to the index of refraction of the substrate.

(A9) The method of A6 or A8, where the substrate further includes a plurality of beads disposed on the first surface. A first bead of the plurality of beads is positioned on the portion of the first surface of the substrate, and the first bead has an index of refraction that is substantially similar to the index of refraction of the substrate. Directing the illumination light toward the portion of the first surface of the substrate by the optical component includes transmitting at least a portion of the illumination light through the first surface of the substrate to the first bead, and outputting the emission light from the portion of the first surface of the substrate includes outputting the emission light from the first bead in response to receiving the illumination light at the first bead.

(A10) The method of any of A6-A8, where optical component is a toroidal cylindrical lens that surrounds the objective lens in a radial direction perpendicular to an optical axis of the objective lens.

(B1) In one aspect, an optical system includes an illumination module, a first objective lens, a second objective lens, and one or more sensors. The illumination module is configured to provide illumination light. The first objective lens is configured to direct the illumination light toward a portion of a first surface of a substrate. The substrate has a second surface that is substantially parallel to the first surface of the substrate. The second objective lens is configured to (i) receive emission light output from the portion of the first surface of the substrate and (ii) to direct the emission light toward the one or more sensors. The one or more sensors are configured for time delay integration imaging. The first objective lens is positioned adjacent to the second surface of the substrate, and the second objective lens is positioned adjacent to the first surface of the substrate. At least a portion of the first objective lens and at least a portion of the second surface of the substrate are immersed in a fluid that has an index of refraction greater than the index of refraction of the substrate.

(B2) A method performed at the optical system of B1, the method including translating a substrate relative to the sensor. The substrate has a first surface and a second surface that is substantially parallel to the first surface. The method further includes, while translating the substrate relative to the sensor: (i) outputting illumination light from the illumination module, and (ii) directing, by the first objective lens, the illumination light toward the second surface of the substrate. The first objective lens is positioned adjacent to the second surface of the substrate. The method further includes, while translating the substrate relative to the sensor: (iii) transmitting the illumination light through the second surface of the substrate and toward a portion of the first surface of the substrate, and (iv) outputting emission light from the portion of the first surface of the substrate in response to receiving the illumination light at the portion of the first surface of the substrate. The method further includes, while translating the substrate relative to the sensor: (v) receiving the emission light at the second objective lens and (vi) directing, by the second objective lens, the emission light toward the sensor. The second objective lens is positioned adjacent to the first surface of the substrate. The method further includes, while translating the substrate relative to the sensor: (vii) receiving the emission light at the sensor, and generating a scanned image of the portion of the first surface of the substrate based on emission light received at the sensor.

(B3) The method of B2, where at least a portion of the first objective lens and at least a portion of the second surface of the substrate are immersed in a fluid that has an index of refraction that is greater than the index of refraction of the substrate.

(C1) In one aspect, a substrate includes a surface, one or more emitters disposed on the surface, and a grating. The grating is configured to receive light and transmit the light toward a portion of the surface. The one or more emitters are configured to output emission light in response to being illuminated by the light received at the portion of the surface.

(C2) An optical system that includes the substrate of (C1), the optical system including an illumination module configured to provide illumination light, a substrate having a first surface and a grating, an objective lens positioned adjacent to the first surface of the substrate, and one or more sensors configured for time delay integration imaging. The substrate includes a grating. The grating is configured to (i) receive the illumination light from the illumination module and (ii) transmit at least a portion of the illumination light through the grating and toward a portion of the first surface of the substrate. The objective lens is configured to (i) receive emission light output from the portion of the first surface of the substrate that is illuminated by the illumination light and (ii) direct the emission light toward the one or more sensors.

(C3) The optical system of C2, where the substrate further includes a second surface that is substantially parallel to the first surface, and the grating is disposed on the second surface of the substrate.

(C4) A method performed at the optical system of C2 or C3, the method including translating a substrate relative to the sensor. The substrate has a first surface and a grating. The method further includes, while translating the substrate relative to the sensor: (i) outputting illumination light from the illumination module and (ii) receiving the illumination light at the grating. The method further includes, while translating the substrate relative to the sensor: (iii) transmitting, by the grating, the illumination light toward a portion of the first surface of the substrate, and (iv) outputting emission light from the portion of the first surface of the substrate in response to receiving the illumination light at the portion of the first surface of the substrate. The method further includes, while translating the substrate relative to the sensor: (v) directing, by the objective lens, the emission light toward the sensor; (vi) receiving the emission light at the sensor; and (vii) generating a scanned image of the portion of the first surface of the substrate based on the emission light received at the sensor.

(D1) In one aspect, a substrate includes a substantially planar surface, one or more emitters disposed on the surface, a waveguide layer that includes one or more waveguides, and a cladding layer that is positioned between the waveguide layer and the surface. The one or more waveguides are configured to (i) receive light, (ii) transmit light to at least a portion of the surface, and (iii) illuminate at least one of the one or more emitters.

(D2) The substrate of D1, where the one or more waveguides are single mode waveguides configured to allow propagation of only a fundamental optical mode of the light.

(D3) The substrate of D1, where the one or more waveguides are multi-mode waveguides configured to allow propagation of a plurality of optical modes of the light.

(D4) The substrate of any of D1-D3, where the one or more waveguides include a first waveguide configured to receive light and a second waveguide that is coupled to the first waveguide. The first waveguide includes a first plurality of spiral rounds. The second waveguide includes a second plurality of spiral rounds. The first waveguide is configured to transmit light toward the second waveguide, and the second waveguide is configured to receive light from the first waveguide.

(D5) The substrate of any of D1-D3, where the one or more waveguides include a first waveguide configured to receive light, a second waveguide, and a plurality of waveguides. The plurality of waveguides are configured to (i) receive light from the first waveguide and (ii) transmit the light from the first waveguide toward the second waveguide.

(D6) The substrate of any of D1-D5, where the substrate further includes a coupling layer positioned between the cladding layer and the surface. The one or more emitters are coupled to the coupling layer.

(D7) The substrate of any of D1-D6, where the substrate includes a first portion that is less than all of the substrate, the first portion includes the coupling layer and the one or more waveguides, and the one or more emitters are positioned on the surface of the substrate corresponding to the first portion.

(D8) The substrate of any of D1-D7, where the one or more waveguides include a first waveguide and a second waveguide that is adjacent to and spaced apart from the first waveguide by a predetermined distance so that light from the first waveguide is evanescently coupled into the second waveguide.

(D9) The substrate of any of D1-D8, further including a coupler. A waveguide of the one or more waveguides includes a first end and a second end. The first end of the waveguide is configured to receive light. The waveguide is configured to transmit the light from the first end of the waveguide to the second end of the waveguide, and the coupler is configured to couple light output from the second end of the waveguide back into the first end of the waveguide.

(D10) An optical system including any of the substrates of D1-D9, the optical system including: a substrate, an illumination module, an objective lens, and one or more sensors. The substrate includes a substantially planar surface and a waveguide layer that includes one or more waveguides. The illumination module is configured to provide illumination light to the one or more waveguides in the substrate. The one or more waveguides are configured to receive the illumination light and to transmit the illumination light to at least a portion of the surface of the substrate. The objective lens is positioned adjacent to the surface of the substrate. The one or more sensors are configured for time delay integration imaging. The objective lens is configured to: (i) receive emission light output from the portion of the surface of the substrate that is illuminated by the illumination light and (ii) transmit the emission light toward the one or more sensors.

(D11) A method performed at the optical system of D10, the method including translating a substrate relative to the sensor. The substrate has a substantially planar surface and a layer that includes one or more waveguides. The method further includes, while translating the substrate relative to the sensor: (i) outputting illumination light from the illumination module and (ii) receiving the illumination light at the one or more waveguides in the substrate. The method further includes, while translating the substrate relative to the sensor: (iii) transmitting, by the one or more waveguides in the substrate, the illumination light toward a portion of the surface of the substrate and (iv) outputting emission light from the portion of the surface of the substrate in response to receiving the illumination light at the portion of the surface of the substrate. The method further includes, while translating the substrate relative to the sensor: (v) directing, by the objective lens, the emission light toward the sensor; (vi) receiving the emission light at the sensor, and (vii) generating a scanned image of the portion of the first surface of the substrate based on the emission light received at the sensor.

While embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. An optical system comprising:
an objective lens configured to collect light emitted by a plurality of emitters disposed on a surface of a substrate;
a sensor;
a pinhole array; and
a microlens array comprising a plurality of microlenses each arranged to transmit to the sensor through a corresponding pinhole in the pinhole array a portion of light emitted by the emitters and collected by the objective lens, each pinhole blocking from the sensor another portion of light emitted by the emitters, collected by the objective lens, and directed to the pinhole array by the microlens array.

2. The optical system of claim 1, wherein the pinhole array is disposed on a surface of the sensor.

3. The optical system of claim 2, wherein each microlens is arranged to focus onto the surface of the sensor the portion of light it transmits through its corresponding pinhole.

4. The optical system of claim 1, wherein the pinhole array is positioned at a predetermined nonzero distance from a surface of the sensor between the microlens array and the surface of the sensor.

5. The optical system of claim 4, wherein each microlens is arranged to focus onto the surface of the sensor the portion of light it transmits through its corresponding pinhole.

6. The optical system of claim 4, wherein each microlens is arranged to focus at its corresponding pinhole the light it transmits through its corresponding pinhole to the sensor.

7. The optical system of claim 6, comprising a relay optic arranged between the pinhole array and the sensor to relay the portions of light transmitted through the pinholes to the sensor.

8. The optical system of claim 7, wherein the relay optic is or comprises another microlens array comprising a plurality of microlenses each arranged to receive the portion of light transmitted through a corresponding pinhole and relay it to the sensor.

9. The optical system of claim 1, wherein each microlens is arranged to transmit to the sensor through its corresponding pinhole a portion of the light emitted by the emitters and collected by the objective lens from emitters in a predefined focal plane of the objective lens, each pinhole blocking from the sensor another portion of light emitted by the emitters, collected by the objective lens from emitters not in the predefined focal plane of the objective lens, and directed to the pinhole array by the microlens array.

10. The optical system of claim 1, wherein the sensor is configured for time delay and integration imaging.

11. The optical system of claim 10, wherein the optical system is configured to enable relative motion of the substrate and the sensor.

12. The optical system of claim 1, comprising an illumination module configured to provide illumination to the plurality of emitters to cause the emitters to emit light.

13. The optical system of claim 12, wherein the illumination module is configured to provide the illumination as a diffraction pattern.

14. The optical system of claim 12, wherein the illumination module is configured to provide the illumination along an optical path not directed through the objective lens.

15. The optical system of claim 14, wherein the illumination module is configured to provide the illumination along an optical path through a toroidal cylindrical lens that surrounds the objective lens in a radial direction perpendicular to an optical axis of the objective lens.

16. The optical system of claim 14, wherein the illumination module is configured to provide the illumination at an oblique angle to the surface of the substrate.

17. The optical system of claim 14, wherein the illumination module is configured to provide the illumination through a second surface of the substrate opposite from the surface on which the emitters are disposed.

18. The optical system of claim 17 comprising a second objective lens positioned opposite from and facing the objective lens, wherein the illumination module is configured to provide the illumination through the second objective lens to and through the second surface of the substrate.

19. The optical system of claim 14, wherein the illumination module is configured to provide the illumination through a grating in or on the substrate.

20. The optical system of claim 14, wherein the illumination module is configured to provide the illumination through a waveguide in or on the substrate.
